(19) United States
(12) Patent Application Publication
(10) Pub. No.: US 2026/0323735 A1
(43) Pub. Date: Oct. 15, 2026

(54) METHOD AND APPARATUS FOR IMPLEMENTATION OF AI/ML IN A 5G NETWORK

(71) Applicant: Samsung Electronics Co., Ltd., Suwon-si, Gyeonggi-do (KR)

(72) Inventor: Donggun KIM, Suwon-si (KR)

(21) Appl. No.: 19/136,673

(22) PCT Filed: Oct. 20, 2023
(86) PCT No.: PCT/KR2023/016419

§ 371 Date: Jun. 6, 2025

(30) Foreign Application Priority Data
Dec. 8, 2022 (GB) 2218454.3
Sep. 8, 2023 (GB) 2313746.6

(51) Int. Cl. H04W 76/12; H04W 12/037; H04W 12/106; H04W 24/10

(52) U.S. Cl. CPC H04W 76/12; H04W 12/037; H04W 12/106; H04W 24/10

(57) ABSTRACT

The disclosure relates to a 5G or 6G communication system for supporting a higher data transmission rate. There is a method for supporting artificial intelligence/machine learning (AI/ML) functionality in a wireless communication system. The method comprises establishing a first radio resource control (RRC) connection between the UE and a base station (BS) by using a first signalling radio bearer (SRB); receiving, from the BS, via the first SRB, a configuration message comprising bearer configuration information; establishing a second radio resource control (RRC) connection between the UE and the BS, by using a second SRB; and receiving, from the BS, at least one RRC message including data related to the AI/ML functionality based on the second RRC connection, wherein the second SRB is configured based on the bearer configuration information.

### TECHNICAL FIELD

The present application relates to providing machine learning (ML) functionality within a 5G network, including configuration and reporting as well as signalling procedures.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architectureprotocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

Currently, there are needs to enhance implementation of AI/ML in a 5G network.

### Solution to Problem

In a first approach of the present techniques, there is provided a computer-implemented method for configuring user equipment to support artificial intelligencemachine learning (AI/ML) functionality in a wireless communication network. The method comprises establishing a radio resource control (RRC) connection from the user equipment to the network via a first signalling radio bearer (SRB); receiving, at the user equipment via the first signalling radio bearer, a configuration message, wherein the configuration message includes bearer configuration information for a second radio bearer to support the AI/ML functionality in the network by enabling transfer of data related to the AI/ML functionality via the second radio bearer; establishing a radio resource control (RRC) connection via the second radio bearer from the user equipment to the network to enable an RRC message including data related to AI/ML functionality to be transmitted from or received by the user equipment.

The user equipment may be any suitable device which is used by a user to connect to the network and is typically mobile, e.g. a mobile device or terminal. The wireless communication network may also be termed a mobile communication network or a radio communication network. Once the user equipment is connected to the network, the network may be considered to comprise the user equipment and other nodes as described below.

The AI/ML functionality in the network may comprise at least one AI/ML model which is located within the network and/or at the user equipment. For example, the AIML model may be used to perform network energy saving, load balancing or mobility optimisation within the network. The AI/ML functionality in the network may comprise AI/ML model training, AI/ML model inference and/or AI/model configuration. The AI/ML functionality in the network may also comprise transmission of AI/ML data around the network and/or between the network and the user equipment.

The network may comprise a plurality of nodes (also termed base stations or cells) and a central server (e.g. an operations, administration and management OAM server) and there may be an AI/ML model at one or more nodes and/or in the central server. The network may be a next-generation mobile communication system, hereinafter referred to as NR or 5G network. The data related to AI/ML functionality may comprise input and output data for the AI/ML model located within the network or at the user equipment. The input may include one or more of data for training an AI/ML model and data to be used at inference by a trained AI/ML model. The output data may comprise output data from an AI/ML model at inference and feedback data from an AI/ML model.

The method may comprise receiving, at the user equipment, measurement configuration information which comprises information on configuring the user equipment to collect and report measurement data needed for the AI/ML model and configuring the user equipment using the received measurement configuration information. The measurement configuration information may be received in the configuration message together with the bearer configuration information for the second radio bearer. In other words, the bearer configuration information and measurement configuration information may be received simultaneously. Alternatively, the measurement configuration information may be received in a second, separate reconfiguration message. The measurement configuration information may be received from the network, e.g. from a node comprising the AI/ML model or from elsewhere in the network.

Configuring the user equipment using the measurement configuration information may thus comprise configuring the user equipment to collect the required measurement data. The measurement data may comprise at least one measurement (e.g. radio measurements, intra-frequency measurements, inter-frequency measurement, Inter-RAT measurement, Channel State Information Reference Signal measurement, Synchronization Signal Block measurement, Synchronization Signal or Physical Broadcast Channel measurement). The measurement data may comprise location information for the user equipment, e.g. positioning, location measurement and/or mobility measurement. As examples, when the model is predicting the optimized network energy saving decisions, configuring the user equipment may include configuring radio measurements related to serving cell and neighbouring cells associated with the user equipment (e.g. RSRP, RSRQ and SINR) as well as cell level and beam level UE measurements. When the model is used for load balancing decision, configuring the user equipment may include radio measurements related to serving cell and neighbouring cells associated with the user equipment (e.g. RSRP, RSRQ and SINR) together with measurements which track mobility history for the user equipment. When the model is used for mobility optimization, configuring the user equipment may include configuring measurements which track mobility history for the user equipment and radio measurements related to serving cell and neighbouring cells associated with UE location information, e.g., RSRP, RSRQ, SINR.

The measurement configuration information may include some or all of the following parameters: measurement objects which define objects to be measured, reporting configurations, measurement identities which link each reporting configuration with a measurement object, quantity configurations which define any filtering to be applied and measurement gaps which define periods at which the user equipment reports. There may be one or more reporting configuration per measurement object. The reporting configuration may include a reporting criterion which is the criterion that triggers the user equipment to send a measurement report to the network, e.g. direct to the AI/ML model within the network or to a different location in the network as specified in the reporting configuration. The criterion may be periodical or conditional, e.g. in response to an event such as receipt of a message or in response to a condition being met by the user equipment. For example, a condition being met may be determined by comparing a measurement to a threshold and the compared measurements may relate to one or more of RSRP (Reference Signal Received Power) or RSRQ (Reference Signal Received Quality) or SINR (Signal-to-interference-plus-noise ratio). By including criterion to trigger reporting, the frequency of the messages being transmitted may be controlled.

Another way of controlling the frequency of messages being transmitted is to configure the message structure for reporting the input data. The measurement configuration information may also define a message structure for simultaneously reporting multiple pieces of data in a single message which is transmitted from the user equipment to the network, wherein the message structure includes sequence information for each piece of data in the message whereby a receiver is able to sort the pieces of data into a sequential order, e.g. a chronological order. Frequent reporting may be avoided by the user equipment including many pieces of AI/ML data information in this newly proposed message structure. The sequence information may be a sequence number or a timing information for each piece of AI/ML data. The number of pieces of AI/ML data which should be included in the reporting message can also be configured by an RRC message. Each piece of data may be for the same target (measurement object) or for the same AI/ML model.

The first signalling radio bearer may be SRB1 and may be used for the first messages (RRC and/or Non-Access Stratum (NAS) messages) between the user equipment and the network which are used to establish and support the connection of the user equipment to the network. The second signalling radio bearer may be a standard signalling radio bearer, for example SRB2, a newly configured signalling radio bearer, for example SBR5 or other appropriate SRB number, or may be a data radio bearer. By establishing connections using separate radio bearers, messages sent via the first signalling radio bearer may be prioritized over messages sent via the second signalling radio bearer. The or each signalling radio bearer may be termed a communication channel.

When using a newly configured signalling radio bearer SBR5 and/or a newly configured data radio bearer to send and/or receive messages for AI/ML related information, the network can configure the priority of these messages. The method may comprise receiving prioritization configuration information, at the user equipment from the network, defining a lower level of priority for messages which include data related to AI/ML functionality than to other messages transmitted between the user equipment to the network. The user equipment may be configured using the prioritization configuration information, i.e. the user equipment may be configured to implement the prioritization configuration information. The prioritization configuration information may include logical channel prioritization parameters (i.e. allocation of a priority and a prioritised bit rate (PBR)) to control the prioritization of data transmission. By prioritizing the other messages, particularly messages relating to establishing connections within a network, the transmission of potentially large volumes of AI/ML data can be controlled to avoid the impact on the network's control of the user equipment.

Data security between the network and the user equipment is important. The method may thus comprise activating access stratum security before establishing the RRC connection via the second radio bearer. Once AS security is activated, all RRC messages on standard signal radio bearers (e.g. SRB1, SRB2, SRB3 and SRB4) are typically both integrity protected and ciphered, e.g. by PDCP (Package Data Convergence Protocol). However, when the second radio bearer is a new signalling radio bearer, the method may comprise receiving security configuration information defining whether integrity protection and/or ciphering is to be applied by the user equipment to messages between the user equipment and the network and configuring the user equipment according to the security configuration information. The security configuration information defines whether the message is neither integrity protected nor ciphered, not integrity protected but ciphered, integrity protected but not ciphered or both integrity protected and ciphered. In other words, RRC integrity protection and ciphering can be activated and deactivated based on the received configuration information. Using one of the options which does not include both integrity protection and ciphering may to reduce the processing burden at the user equipment and avoid over-security protection in the network.

The configuration message received at the user device via the first signalling radio bearer may be any suitable RRC message, for example an RRCReconfiguration, RRCSetup, RRCResume, RRCRelease message or a newly defined RRC message. The configuration information, the measurement configuration information, the prioritization configuration information and the security configuration information may be simultaneously transmitted in the same configuration message. Alternatively separate messages may be used for some or each type of configuration information.

Each cell within the wireless communication network may broadcast system information which indicates whether the cell supports AI/ML functionality, for example which indicates whether the cell has an AI/ML which needs to be trained or which can be used for inference. When the user equipment acquires the system information, the user equipment can receive the configuration message and/or establish the RRC connection via the second radio bearer with the network via the cell which supports AI/ML functionality. When the user equipment has previously been connected to the network using a particular cell, the user equipment may select the cell which supports AI/ML functionality and establish a new connection to the network via the selected cell. The user equipment may be configured to send capability information to the network, e.g. to the selected cell, wherein the capability information including the user equipment's capability for AI/ML functionality support to the cell (network).

Once the user equipment is configured, e.g. using some or all of the configuration information, the measurement configuration information, the prioritization configuration information and the security configuration information, there is also provided a method of using the user equipment to support AI/ML functionality within the network, by transmitting data related to AI/ML functionality to the network, e.g. to a cell within the network having an AI/ML model. The user equipment may have been configured to measure the transmitted data before transmission as described above. The user equipment may also receive messages from the network to support the AI/ML functionality, e.g. to trigger measurement and reporting of AI/ML data and/or to reconfigure the AI/ML functionality at the user equipment.

The method above focuses on the steps carried out by the user equipment but it will be appreciated that corresponding steps are also carried out by the network, specifically by nodes within the network. Thus, according to another aspect of the present techniques there is described a method for configuring user equipment to support artificial intelligence/machine learning (AI/ML) functionality in a wireless communication network, the method comprising: establishing a first radio resource control (RRC) connection from the user equipment to the network using a first signalling radio bearer; transmitting from the network to the user equipment via the first signalling radio bearer, a configuration message, wherein the configuration message includes configuration information to configure the user equipment to support the AI/ML functionality in the network by configuring a second radio bearer for the transfer of data related to the AI/ML functionality between the user equipment and the network; and receiving confirmation, at the network from the user equipment, that the user equipment has been configured to enable at least one RRC message which includes data related to AI/ML functionality to be transmitted from or received by the user equipment using the second data bearer.

Once the user equipment is configured, according to another aspect of the present techniques there is described a method for applying AI/ML functionality within a network. For example, a node within the network having an AI/ML model may receive AI/ML data from the user equipment and may train the AI/ML model using the received AI/ML data. Alternatively, a node within the network having an AI/ML model may receive AI/ML data from the user equipment and may infer an output from the AI/ML model.

The or each AI/ML model in the system may be a pre-trained general ML model which may be obtained from a data store and/or may be a general model which has been trained to full precision by the central server on data which is accessible by the central server. The AI/ML model in the form of a neural network comprising a plurality of layers with each layer having a set of general weights. There may also be one or more local models within the system and each local model may be a similar model with each layer having a set of local weights. Each local model may be trained using a set of local data samples which may be stored in a database on the user equipment and/or measured by the user equipment.

In any of the arrangements, the collected or measured AI/ML data may comprise at least one of location information for the user equipment and one or more measurements from the user equipment and/or one or more nodes within the network. The one or more measurements may comprise one or more of radio measurements, intrafrequency measurements, inter-frequency measurement, Inter-RAT measurement, Channel State Information Reference Signal measurements, Synchronization Signal Block measurements. As described above, the location information may comprise at least one of position, location measurement, and mobility measurement. Similarly, in any of the arrangements, the at least one configuration message may further comprise prioritization configuration information for configuring the user equipment to define a lower level of priority for messages which include data related to AI/ML functionality than for other messages transmitted between the user equipment to the network, and/or security configuration information for configuring the user equipment to apply integrity protection and/or ciphering to messages between the user equipment and the network.

The user equipment has three states. In a first state, the user equipment is connected to the network and the connection is active (i.e. messages are being transferred between the user equipment and the network). Once the user equipment has been connected to the network, the user equipment can transition to a second state in which the connection is inactive. There is also a third state before the connection is established and in which the user equipment is idle. The states may be termed, RRC_Connected, RRC_INACTIVE and RRC_IDLE. Appropriate RRC messages from the network to the user equipment will cause the user equipment to transition between the states. For example a release message (e.g. RRC_release) which is received by the user equipment from the network will cause the user equipment to transition to the idle state (from either the connected or inactive state). When the user equipment is in the connected state, messages with AI/ML data to support AI/ML functionality within the network can be transmitted between the user equipment and the rest of the network as described above.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects. All of the methods described above may be considered to be computer-implemented methods.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including objectoriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the abovedescribed methods, for example on a general-purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The methods described above may be wholly or partly performed on an apparatus, i.e., a user equipment in the form of an electronic device.

According to another aspect of the present techniques, there is provided a user equipment comprising at least one receiver for receiving messages from a wireless communication network; at least one transmitter for transmitting messages to the wireless communication network; and a processor which is configured to establish a radio resource control (RRC) connection from the user equipment to the network via a first signalling radio bearer of the at least one receiver and the at least one transmitter; and configure the user equipment using configuration information which is received at the user device in a configuration message via the first signalling radio bearer. The configuration message includes configuration information for a second radio bearer to support the AI/ML functionality in the network by enabling transfer of data related to the AI/ML functionality via the second radio bearer; and configuring the user equipment includes establishing a radio resource control (RRC) connection via the second radio bearer from the user equipment to the network to enable an RRC message including data related to AI/ML functionality to be transmitted from or received by the user equipment.

The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

A learning algorithm is a method for training a predetermined target device (for example, a node) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF DRAWINGS

Implementations of the present techniques will now be described, by way of example only, with reference to the accompanying drawings, in which:

FIG. 1 is a schematic diagram of an LTE system according to the embodiments as disclosed herein;

FIG. 2 illustrates a radio protocol structure for the LTE system according to the embodiments as disclosed herein;

FIG. 3 is a schematic diagram of a wireless communication system according to the embodiments as disclosed herein;

FIG. 4 illustrates a radio protocol structure for the wireless communication system according to the embodiments as disclosed herein;

FIG. 5 is a schematic block diagram for a functional framework 500 for implementing Artificial Intelligence or Machine Learning in the radio access networks according to the embodiments as disclosed herein;

FIG. 6 illustrates a state diagram for a user equipment according to the embodiments as disclosed herein;

FIG. 7 illustrates one method a user equipment may acquire the system information from a network, according to the embodiments as disclosed herein;

FIG. 8 is a flowchart showing the procedure in which a UE switches from an RRC idle mode to an RRC connected mode, according to the embodiments as disclosed herein;

FIG. 9 is a flowchart showing an example use case in which AI/ML Model training is done at a central server and AI/ML Model inference is done at one or more of the nodes of the network, according to the embodiments as disclosed herein;

FIG. 10 is a flowchart showing another example use case in which AI/ML Model training is done at a node and AI/ML Model inference is done at one or more of the nodes of the network, according to the embodiments as disclosed herein;

FIG. 11 is a flowchart summarising the method of configuring user equipment to support AI/ML functionality, according to the embodiments as disclosed herein;

FIG. 12 is a block diagram of a system comprising a node in a network and a user equipment connected to the node, according to the embodiments as disclosed herein;

FIG. 13 is a block diagram illustrating a terminal (or a user equipment (UE)), according to the embodiments as disclosed herein; and

FIG. 14 is a block diagram illustrating a base station (BS), according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

To meet the 5G network requirements of key performance and the demands of the unprecedented growth of mobile subscribers, millions of base stations (BSs) are being deployed. Such rapid growth brings the issues of high energy consumption, CO2 emissions and operation expenditures (OPEX). Therefore, energy saving is an important use case which may involve different layers of the network, with mechanisms operating at different time scales.

Cell activation/deactivation is an energy saving scheme in the spatial domain that exploits traffic offloading in a layered structure to reduce the energy consumption of the whole radio access network (RAN). When the expected traffic volume is lower than a fixed threshold, the cells may be switched off, and the served UEs may be offloaded to a new target cell. Efficient energy consumption can also be achieved by other means such as reduction of load, coverage modification, or other RAN configuration adjustments. The optimal energy saving decision depends on many factors including the load situation at different RAN nodes, RAN nodes capabilities, KPIQoS (Quality of Service) requirements, number of active UEs and UE mobility, cell utilization, etc.

However, the identification of actions aimed at energy efficiency improvements is not a trivial task. Wrong switch-off of the cells may seriously deteriorate the network performance since the remaining active cells need to serve the additional traffic. Wrong traffic offload actions may lead to a deterioration of energy efficiency instead of an improvement. The current energy-saving schemes are vulnerable to potential issues.

An example issue is inaccurate cell load prediction because currently, energy-saving decisions rely on current traffic load without considering future traffic load. Another example is conflicting targets between system performance and energy efficiency. Maximizing the system's key performance indicator (KPI) is usually done at the expense of energy efficiency. Similarly, the most energy efficient solution may impact system performance. Thus, there is a need to balance and manage the trade-off between the two. Another example is conventional energy-saving related parameters adjustment. Energy-saving related parameters configuration is set by traditional operation, e.g., based on different thresholds of cell load for cell switch on/off which is somewhat a rigid mechanism since it is difficult to set a reasonable threshold. Another example is actions that may produce a local (e.g., limited to a single RAN node) improvement of energy efficiency, while producing an overall (e.g., involving multiple RAN nodes) deterioration of energy efficiency.

In addition to the need to save energy, the rapid traffic growth and multiple frequency bands utilized in a commercial network make it challenging to steer the traffic in a balanced distribution. To address the problem, load balancing had been proposed. The objective of load balancing is to distribute load evenly among cells and among areas of cells, or to transfer part of the traffic from congested cells or from congested areas of cells, or to offload users from one cell, cell area, carrier or RAT to improve network performance. This can be done by means of optimization of handover parameters and handover actions. The automation of such optimisation can provide high quality user experience, while simultaneously improving the system capacity and also to minimize human intervention in the network management and optimization tasks.

However, the optimization of the load balancing is not an easy task. Currently the load balancing decisions relying on the current/past-state cell load status are insufficient. The traffic load and resource status of the network changes rapidly, especially in the scenarios with high-mobility and large number of connections, which may lead to ping-pong handover between different cells, cell overload and degradation of user service quality. It is difficult to guarantee the overall network and service performance when performing load balancing. For the load balancing, the user equipments (UEs) in the congested cell may be offloaded to the target cell, by means of handover procedure or adapting handover configuration. For example, if the UEs with time-varying traffic load are offloaded to the target cell, the target cell may be overloaded with new-arrival heavy traffic. It is difficult to determine whether the service performance after the offloading action meets the desired targets.

In addition to the need to save energy and perform load balancing, mobility management is the scheme to guarantee the service-continuity during the mobility by minimizing the call drops, RLFs, unnecessary handovers, and ping-pong. For the future high-frequency network, as the coverage of a single node decreases, the frequency for UE to handover between nodes becomes high, especially for highmobility UE. In addition, for the applications characterized with the stringent Quality of Service (QoS) requirements such as reliability, latency etc., the QoE is sensitive to the handover performance, so that mobility management should avoid unsuccessful handover and reduce the latency during handover procedure. However, for the conventional method, it is challengeable for trial-and-error-based scheme to achieve nearly zero-failure handover. The unsuccessful handover cases are the main reason for packet dropping or extra delay during the mobility period, which is unexpected for the packetdrop-intolerant and low-latency applications. In addition, the effectiveness of adjustment based on feedback may be weak due to randomness and inconstancy of transmission environment. Besides the baseline case of mobility, areas of optimization for mobility include dual connectivity, CHO, and DAPS, which each has additional aspects to handle in the optimization of mobility.

There are various unintended events which are associated with mobility. One example is intra-system too late handover. In this unintended event, a radio link failure (RLF) occurs after the UE has stayed for a long period of time in the cell; the UE attempts to re-establish the radio link connection in a different cell. Another example is intra-system too early handover. In this unintended event, an RLF occurs shortly after a successful handover from a source cell to a target cell or a handover failure occurs during the handover procedure; the UE attempts to re-establish the radio link connection in the source cell. Another example is intra-system handover to wrong cell. In this unintended event, an RLF occurs shortly after a successful handover from a source cell to a target cell or a handover failure occurs during the handover procedure; the UE attempts to re-establish the radio link connection in a cell other than the source cell and the target cell. Another example is any underlying issues during an otherwise successful handover.

Therefore, the present applicant has recognised the need for improvements in 5G networks.

Broadly speaking, the present techniques generally relate to supporting AI/ML functionality in a 5G network. This includes AI/ML configuration/reporting, the signalling procedures, and the operations at the user equipment (UE). To reduce UE processing burden, a new security protection (integrity protection or ciphering) mechanism is proposed unlike the mandatory security protection for signal radio bearers (SRBs). To avoid the impact on the network's control for UEs, a new prioritization mechanism is introduced by defining a rule for SRBs or introducing a new SRB or allocating a separate data radio bearer (DRB). To avoid frequent reporting, a new message structure is designed to report multiple data in chronological sequence for the same target in one message. To support UE's mobility for AI/ML functionality, the radio resource control (RRC) procedures are proposed. To increase the reliability of AI/ML functionality, the retransmission mechanism is proposed.

### Definitions of Terms, Symbols and Abbreviations

### Acronyms

### Acronym Detail

(N) AS (Non) access stratum
AI/ML Artificial intelligence/Machine learning
BS Base Station
CCCH Common control channel
CHO Conditional Handover
CRS Cell specific reference signal
CSI Channel state info
CU Central Unit
DC Dual connectivity
DCCH Downlink control channel
DCI Downlink control info
DL Downlink
DRB Data radio bearer
eNB Evolved node b or base station in LTE
EN-DC EUTRA NR DC
EUTRA Evolved universal terrestrial radio access
LTE Long term evolution
MAC Medium access control
MCG Master cell group
MME Mobile management entity
MR-DC Multi RAT DC
NG EN-DC Next generation E UTRAN dual connectivity
NG-ran SA Next gen RAN-standalone mode
NR gNB Next generation node B-in NR/5G network
NR-CN Next gen core network
NR-DC Next generation dual connectivity
Pcell Primary cell in MCG/SCG-initiate initial access
PDCP Package data convergence protocol
PDU Protocol data unit
PScell Primary or secondary cell in Primary cell in MCG/SCG
PSS Primary synchronization sequence
PUCCH Physical uplink control channel
PUSCH Physical uplink shared channel
RAN Radio access network
RAT Radio Access Technology
RLC radio link control
RLF Radio link failure
RRC Radio resource control
Scell Secondary cell in MCG/SCG
SCG Secondary cell group
SDU Service data unit
SON Self organising network
SSB Synchronization Signal Block
SSS Secondary synchronization sequence
UE User equipment
UL Uplink

Data collection: Data collected from the network nodes, management entity or user equipment (UE), as a basis for AI/ML model training, data analytics and inference. Data Collection is a function that provides input data to Model training and Model inference functions. AI/ML algorithm specific data preparation (e.g. data preprocessing and cleaning, formatting, and transformation) is not carried out in the Data Collection function. Examples of input data may include measurements (or response or information or report) from UEs or different network entities, feedback from Actor, output from an AI/ML model.

Training Data: Data needed as input for the AI/ML Model Training function.

Inference Data: Data needed as input for the AI/ML Model Inference function.

AI/ML (Artificial Intelligence/Machine Learning) Model: A data driven algorithm by applying machine learning techniques that generates a set of outputs consisting of predicted information and/or decision parameters, based on a set of inputs. It also indicates AI/ML (Model) training or inference or training data or predicted information or decision parameters or a set of inputs. AI/ML data indicates AI/ML (model) training or inference or training data or predicted information or decision parameters or a set of inputs for AI/ML or AI/ML model. AI/ML configuration includes the type of AI/ML Model, Model Inference, Model training, Algorithms or how to construct a RRC (Radio Resource Control) message for response (or report) including AI/ML data (e.g. which information should be included) or how to send the RRC message from the transmitter (UE or gNB) to the receiver (gNB or UE) (e.g. periodicity, timer related information, etc). AI/ML data can indicate the measurement report (e.g. for beam or SSB (Synchronization Signal Block) or CSI (Channel State Information) or CRS (Cell specific Reference Signal)) and CSI report. AI/ML configuration can include the measurement configuration (e.g. for beam or SSB or CSI or CRS) and CSI measurement configuration (e.g. aperiodic CSI, periodic CSI, etc). AI/ML functionality means all these information (e.g. AI/ML data and AI/ML configuration), measurement configuration and reporting, the request/report for training data, as well as the training and inference procedure described below.

AI/ML Training: An online or offline process to train an AI/ML model by learning features and patterns that best present data and get the trained AI/ML model for inference. Model Training is a function that performs the AI/ML model training, validation, and testing which may generate model performance metrics as part of the model testing procedure. The Model Training function is also responsible for data preparation (e.g. data pre-processing and cleaning, formatting, and transformation) based on Training Data delivered by a Data Collection function, if required.

Model Deployment/Update: Used to initially deploy a trained, validated, and tested AI/ML model to the Model Inference function or to deliver an updated model to the Model Inference function.

AI/ML Inference: A process of using a trained AI/ML model to make a prediction or guide the decision based on collected data and AI/ML model. Model Inference is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required.

Output: The inference output of the AI/ML model produced by a Model Inference function. Details of inference output are use case specific.

Model Performance Feedback: It may be used for monitoring the performance of the AI/ML model, when available.

Actor: This is a function that receives the output from the Model Inference function and triggers or performs corresponding actions. The Actor may trigger actions directed to other entities or to itself.

Feedback: Information that may be needed to derive training data, inference data or to monitor the performance of the AI/ML Model and its impact to the network through updating of KPI (Key Performance Indicator)s and performance counters.

Federated learning (also known as collaborative learning) is a machine learning technique that trains an algorithm across multiple decentralized edge devices or servers holding local data samples, without exchanging them. This approach stands in contrast to traditional centralized machine learning techniques where all the local datasets are uploaded to one server, as well as to more classical decentralized approaches which often assume that local data samples are identically distributed. Federated learning enables multiple actors (or UEs) to build a common, robust machine learning model without sharing data, thus allowing to address critical issues such as data privacy, data security, data access rights and access to heterogeneous data. Its applications are spread over a number of industries including defence, telecommunications, IoT, and pharmaceutics.

Split learning is a new technique developed that allows for participating entities to train machine learning models without sharing any raw data. In principle, both federated learning and split learning has similar nature having benefits of data privacy effect.

Signalling Radio Bearers (SRBs) are defined as Radio Bearers (RBs) that are used only for the transmission of RRC (Radio Resource Control) and NAS (Non-Access Stratum) messages. More specifically, the following SRBs are defined:

SRB0 is for RRC messages using the CCCH (Common Control Channel) logical channel.

SRB1 is for the first RRC messages (which may include a piggybacked NAS message) as well as for NAS messages prior to the establishment of SRB2, all using DCCH logical channel. It can be for the second RRC messages which include AI/ML related information (e.g. AI/ML data, training data, update information, response, offset for AI/ML, etc) but the second RRC messages can have lower priority than the first RRC messages (e.g. a piggybacked NAS message, NAS messages prior to the establishment of SRB2, RRC messages for setting up (re-)connection and (re-)configuration, i.e. RRCSetupRequest, RRCSetup, RRCSetupComplete, RRCResumeRequest, RRCResume, RRCResumeComplete, RRCReconfiguration, RRCReconfigurationComplete, RRCReestablishment, RRCReestablishmentRequest, etc) because the first RRC messages are much more important than the second RRC messages to support UE's connection management and mobility support. When the first messages and the second messages are generated together or simultaneously (or co-exist in buffer), then the first message can be prioritized over the second RRC messages and can be submitted to lower layers (e.g. PDCP layer) and sent first.

SRB2 is for NAS messages and for RRC messages which include logged measurement information or AI/ML related information (e.g. AI/ML data, training data, update information, response, offset for AI/ML, etc), all using DCCH logical channel. SRB2 has a lower priority than SRB1 and may be configured by the network after AS (Access Stratum) security activation;

SRB3 is for specific RRC messages when UE is in (NG)EN-DC or NR-DC, all using DCCH logical channel, or RRC messages which include AI/ML related information (e.g. AI/ML data, training data, update information, response, offset for AIML, etc);

SRB4 is for RRC messages which include application layer measurement report information, all using DCCH logical channel or RRC messages which include AI/ML related information (e.g. AI/ML data, training data, update information, response, offset for AI/ML, etc). SRB4 can only be configured by the network after AS security activation.

SRBx (e.g. SRB5) is for RRC messages which include AI/ML related information (e.g. AI/ML data, training data, update information, response, offset for AI/ML, etc), all using DCCH logical channel. SRBx can be configured by the network after AS security activation. However, SRBx can be configured by the network before AS security activation in the case SRBx is not required to perform ciphering and integrity protection for the RRC messages. When SRBx is configured to send/receive RRC messages for AI/ML related information, the network can configure Logical channel prioritization parameters (i.e. allocation of a priority and a prioritised bit rate (PBR)) for LCP procedure performed in MAC entity (or layer) for SRBx to control the prioritization of data transmission. In this invention, SRBx is a new SRB configured for AIML functionality, which can be named SRB5.

DRB (Data Radio Bearer): This is for AI/ML related information (e.g. AI/ML data, training data, update information, response, offset for AI/ML, etc), all using DCCH logical channel. This DRB can be configured by the network after AS security activation. However, the DRB can be configured by the network before AS security activation in the case the DRB is not required to perform ciphering and integrity protection for the AI/ML data. When DRB is configured to send/receive AI/ML data, the network can configure Logical channel prioritization (LCP) parameters (i.e. allocation of a priority and a prioritised bit rate (PBR)) for LCP procedure performed in MAC entity (or layer) for the DRB to control the prioritization of data transmission.

NAS messages: In downlink, piggybacking of NAS messages is used only for one dependant (i.e. with joint success/failure) procedure: bearer establishment/modification/release. In uplink piggybacking of NAS message is used only for transferring the initial NAS message during connection setup and connection resume. The NAS messages transferred via SRB2 are also contained in RRC messages, which however do not include any RRC protocol control information.

AS (Access stratum) security: Once AS security is activated, all RRC messages on SRB1, SRB2, SRB3 and SRB4, including those containing NAS messages, are integrity protected and ciphered by PDCP (Package Data Convergence Protocol). NAS independently applies integrity protection and ciphering to the NAS messages as default. However, even if AS security is activated, some RRC messages (e.g. RRC messages for AI/ML data) can be not integrity protected or not ciphered by PDCP according to the configuration (configuration by RRC message) or according to predefined rule (e.g. no integrity protection (integrity verification) or no ciphering (deciphering) only for specific RRC message) or according to indication from RRC to PDCP whether to perform ciphering or integrity protecting. This can allow a RRC message not integrity protected and not ciphered, a RRC message not integrity protected but ciphered, and a RRC message integrity protected but not ciphered, in order to reduce UE's processing burden and avoid over-security protection in RAN.

For operation with shared spectrum channel access, SRB0, SRB1 and SRB3 are assigned with the highest priority Channel Access Priority Class (CAPC), (i.e. CAPC=1) while CAPC for SRB2 is configurable.

### System Architecture

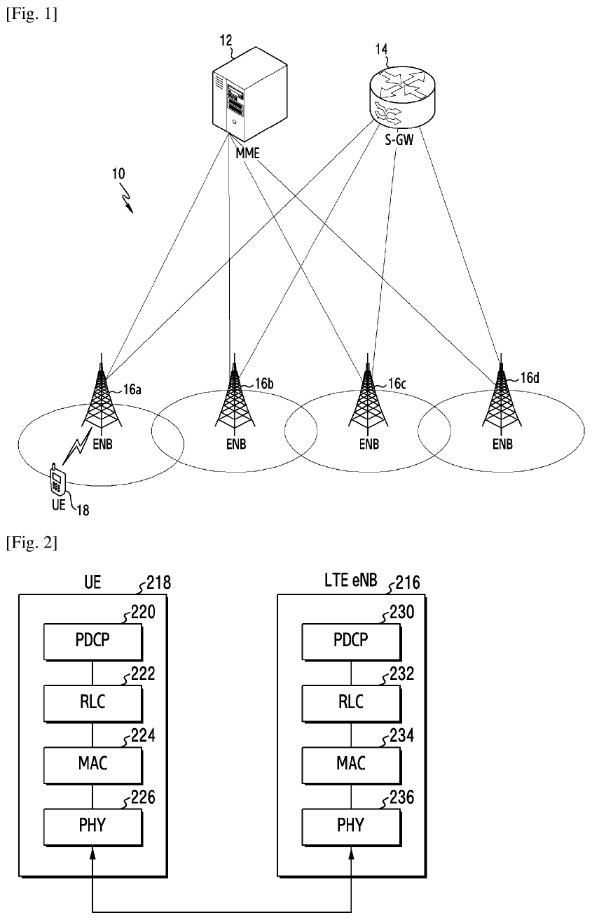

FIG. 1 shows a Long-Term Evolution (LTE) system to which the AI/ML techniques described below may be applied. Referring to FIG. 1, a radio access network of an LTE system 10 includes next-generation base stations, 16a, 16b, 16c, and 16d, a mobility management entity (MME) 12, and a serving gateway (S-GW) 14. A user equipment 18 (hereinafter UE or terminal) accesses an external network through the eNBs 16a, 16b, 16c, and 16d and S-GW 14. The next-generation base stations are also referred to as evolved node Bs or cells, hereinafter eNBs, node Bs, cells or base stations.

In FIG. 1, the eNBs 16a, 16b, 16c, and 16d correspond to an existing node B of an UMTS (Universal Mobile Telecommunications System). The eNBs are connected to the UE 18 through a radio channel, and perform a more complicated role than the existing node B. In the LTE system 10, since all user traffic pertaining to real-time service, such as voice over IP (VoIP), via the Internet protocol, is serviced through a shared channel, a device that performs scheduling by collecting state information, such as buffer states, available transmit power states, and channel states of UEs, is required, and eNBs 16a, 16b, 16c, and 16d are in charge of this function of the device. In general, one eNB controls multiple cells. For example, in order to implement a transmission rate of 100 Mbps, the LTE system 10 uses orthogonal frequency division multiplexing (OFDM) as a radio access technology in the bandwidth of 20 MHz. In addition, the LTE system 10 adopts an adaptive modulation and coding scheme (hereinafter referred to as AMC) for determining a modulation scheme and a channel coding rate based on the channel state of the UE. The S-GW 14 is a device for providing a data bearer and generating or removing a data bearer under the control of the MME 12. The MME 12 is in charge of various control functions in addition to a mobility management function for the UE and is connected to multiple base stations.

FIG. 2 illustrates a radio protocol structure in an LTE system such as shown in FIG. 1. Referring to FIG. 2, the radio protocol of the LTE system includes packet data convergence protocols (PDCPs) 220 and 230, radio link controls (RLCs) 222 and 232, and medium access controls (MACs) 224 and 234, in a UE 218 and an eNB 216, respectively. The packet data convergence protocols (PDCPs) 226 and 236 are used to perform operations, such as IP header compression/restoration.

The main functions of PDCPs are summarized as follows: header compression and decompression for Robust Header Compression (ROHC) only; transfer of user data, insequence delivery of upper layer Protocol Data Units (PDUs) at PDCP reestablishment procedure for RLC acknowledged mode (AM); sequence reordering (for split bearers in DC (only support for RLC AM): PDCP PDU routing for transmission and PDCP PDU reordering for reception); duplicate detection of lower layer service data units (SDUs) in a PDCP re-establishment procedure for RLC AM; retransmission of PDCP SDUs at handover and, for split bearers in DC, of PDCP PDUs at PDCP datarecovery procedure, for RLC AM); ciphering and deciphering; and rimer-based SDU discard in uplink.

The radio link control (hereinafter referred to as RLC) 222 and 232 performs Automatic Repeat Request (ARQ) operation by reconfiguring a PDCP protocol data unit (PDU) or RLC service data unit (SDU) to an appropriate size. The main functions of RLC include transfer of upper layer PDUs and RLC re-establishment. For AM data transfer only, the main functions of RLC include ARQ function (Error correction through ARQ), re-segmentation of RLC data PDUs and Protocol error detection. For unacknowledged mode (UM) and AM data transfer only, the main functions of RLC include concatenation, segmentation and reassembly of RLC SDUs, reordering of RLC data PDUs, duplicate detection and RLC SDU discard.

The MACs 224, 234 are connected to multiple RLC layer devices configured in one UE 218. The MACs 224, 234 may perform an operation of multiplexing RLC PDUs to MAC PDUs and demultiplexing RLC PDUs from MAC PDUs. The main functions of the MACs are summarized as follows: mapping between logical channels and transport channels, multiplexing/de-multiplexing of MAC SDUs belonging to one or different logical channels into/from transport blocks (TB) transferred to/from the physical layer on transport channels, scheduling information reporting, error correction through hybrid automatic repeat request (HARQ), priority handling between logical channels of one UE, priority handling between UEs by means of dynamic scheduling, Multimedia Broadcast Service (MBMS) identification, transport format selection and padding.

Physical layers 226, 236 may perform operations of channel coding and modulating upper layer data, forming the upper layer data into an orthogonal frequency division multiplexing (OFDM) symbol, transmitting the OFDM symbol through a radio channel, or of demodulating an OFDM symbol received through a radio channel, channel-decoding the OFDM symbol, and transmitting the OFDM symbol to an upper layer.

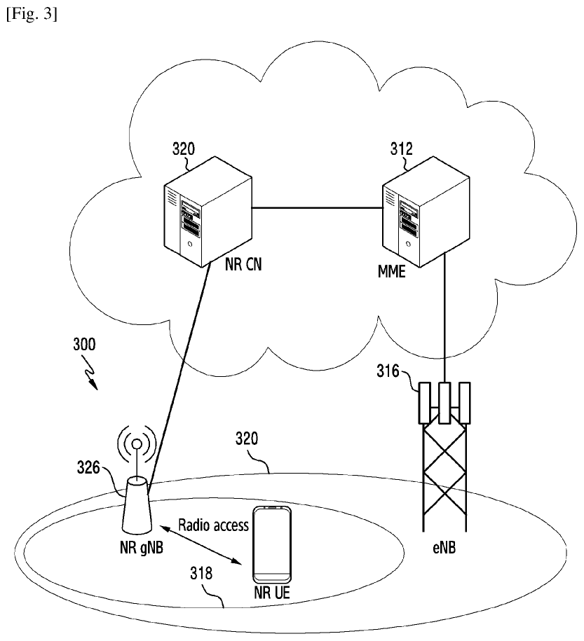

FIG. 3 illustrates the structure of a next-generation mobile communication system 300 to which the disclosure can be applied. Referring to FIG. 3, a radio access network of a next-generation mobile communication system (hereinafter referred to as NR or 5G) includes a new radio node 326 and a new radio core network 320 (NR CN). A user terminal 318 accesses an external network via an NR gNB 326 and an NR CN 320. The new radio node B is hereinafter referred to as an NR gNB, or NR base station and the user terminal may be a new radio user equipment and is hereinafter referred to as NR UE or a UE.

In FIG. 3, the NR gNB 326 corresponds to an evolved node B (eNB) of the existing LTE system (e.g. as shown in FIG. 1). The NR gNB 326 is connected to the NR UE 312 via a radio channel, and may provide an excellent service as compared to the existing node B. In the next-generation mobile communication system, since all types of user traffics are serviced through a shared channel, there is a need for a device for performing scheduling by collecting state information, such as buffer states, available transmission power states, and channel states of UEs. Further, the NR gNB 326 is in charge of this function of the device. In general, one NR gNB 326 typically controls multiple cells. In order to implement ultra-high speed data transmission as compared to the existing LTE, the NR gNB 326 may have the existing maximum bandwidth or more and may additionally employ beamforming technology using orthogonal frequency division multiplexing (hereinafter referred to as OFDM) as a radio access technology. In addition, the NR gNB 326 adopts an adaptive modulation and coding (AMC) scheme that determines a modulation scheme and a channel coding rate based on the channel state of a UE.

The NR CN 320 performs functions, such as mobility support, bearer configuration, QoS configuration, and the like. The NR CN 320 is a device that is in charge of various control functions in addition to a mobility management function for a UE 318 and is connected to multiple base stations. In addition, the next-generation mobile communication system may also operate in conjunction with the existing LTE system 330, and the NR CN 320 may be connected to an MME 312 via a network interface. The MME 312 is connected to an eNB 316, that is, to the existing base station.

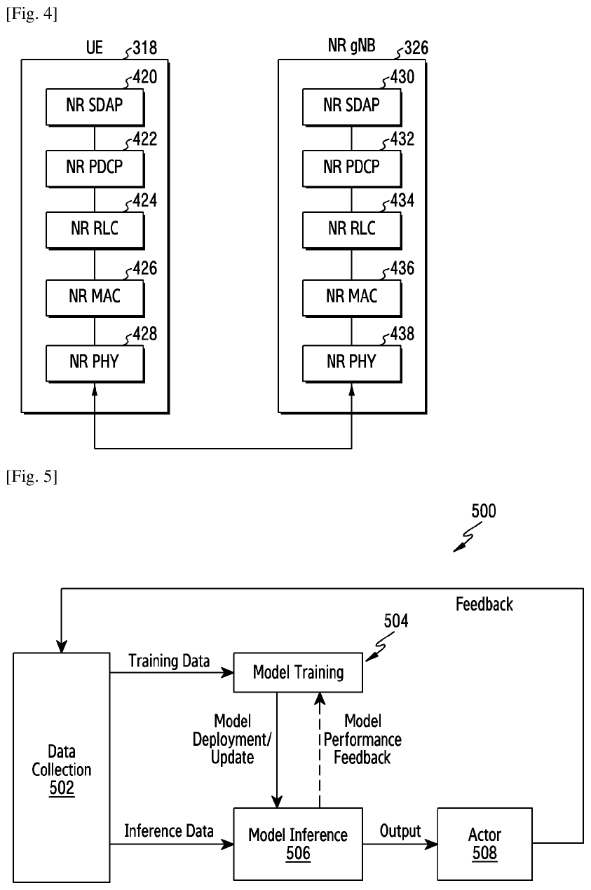

FIG. 4 illustrates a radio protocol structure of a next-generation mobile communication system such as that shown in FIG. 3. Referring to FIG. 4, the radio protocol of the next-generation mobile communication system includes NR SDAPs 420 and 430, NR PDCPs 422 and 432, NR RLCs 424 and 434, and NR MACs 426 and 436, respectively, in a UE 318 and an NR base station 326.

The main functions of the NR SDAPs 420 and 430 may include some of the following functions: transfer of user plane data; mapping between a QoS flow and a data bearer (DRB) for both downlink (DL) and uplink (UL); marking QoS flow ID in both DL and UL packets; and mapping reflective QoS flow to DRB for the UL SDAP PDUs. For the SDAP layer device, the UE 318 may be configured as to whether or not use the header of the SDAP layer device (or new layer device) or the function of the SDAP layer device (or new layer device) for each PDCP layer device, for each bearer, and for each logical channel through an RRC message. When the SDAP header is configured, an NAS reflective QoS reflective configuration 1-bit indicator (NAS reflective QoS) and an AS QoS reflective configuration 1-bit indicator (AS reflective QoS) of the SDAP header are used to instruct the UE to enable updating or reconfiguration of the mapping information relating to the QoS flow of uplink and downlink and data bearer. The SDAP header may include QoS flow ID information indicating QoS. The QoS information may be used as data processing priority, scheduling information, etc., in order to support a smooth service.

The main functions of the NR PDCPs 422 and 432 may include some of the following functions: header compression and decompression (ROHC only), transfer of user data; in-sequence delivery of upper layer PDUs; out-of-sequence delivery of upper layer PDUs; PDCP PDU reordering for reception; duplicate detection of lower layer SDUs; retransmission of PDCP SDUs; ciphering and deciphering and timerbased SDU discard in uplink. The reordering function of the NR PDCP device refers to a function of sequentially reordering PDCP PDUs, received from a lower layer, based on a PDCP sequence number (SN). The reordering function may include a function of transmitting data to an upper layer in the reordered sequence, a function of directly transmitting data to an upper layer without taking the sequence into consideration, a function of reordering the sequence and recording missing PDCP PDUs, a function of providing a state report on the missing PDCP PDUs to a transmission side, and a function of requesting retransmission of the missing PDCP PDUs.

The main functions of the NR RLCs 424 and 434 may include some of the following functions: transfer of upper layer PDUs; in-sequence delivery of upper layer PDUs; out-of-sequence delivery of upper layer PDUs; error Correction through ARQ; concatenation, segmentation and reassembly of RLC SDUs; re-segmentation of RLC data PDUs; reordering of RLC data PDUs; duplicate detection; protocol error detection; RLC SDU discard and RLC re-establishment.

The in-sequence delivery function of the NR RLC device refers to a function of transmitting RLC SDUs, received from a lower layer, to an upper layer in a sequence of reception. The in-sequence delivery function may include, if one RLC SDU is originally segmented into multiple RLC SDUs and received, a function of reassembling and transmitting the multiple RLC SDUs. The in-sequence delivery function may include a function of reordering the received RLC PDUs based on an RLC SN or PDCP SN, reordering the sequence and recording missing RLC PDUs, providing a state report on the missing RLC PDUs to a transmission side, and requesting retransmission of the missing RLC PDUs. Alternatively, the in-sequence delivery function of the NR RLC device may include a function of sequentially transmitting only RLC SDUs prior to the missing RLC SDU to an upper layer if an RLC SDU is missing, or sequentially transmitting all the RLC SDUs received before a timer starts to an upper layer if the timer expires even if there is a missing RLC SDU, or sequentially transmitting all RLC SDUs received so far to an upper layer if a predetermined timer expires even if there is a missing RLC SDU. In addition, the RLC PDUs may be processed in the sequence in which the RLC PDUS are received (in a sequence of arrival regardless of the serial number or sequence number) and may be transmitted to a PDCP device in out-of-sequence delivery. The in-sequence delivery function may include a function of receiving segments stored in a buffer or segments to be received later, reconfiguring the segments in one complete RLC PDU, processing the RLC PDU, and transmitting the RLC PDU to the PDCP device. The NR RLC layer may not include a concatenation function, and the concatenation function may be performed by the NR MAC layer, or may be replaced by a multiplexing function of the NR MAC layer.

The out-of-sequence delivery function of the NR RLC device refers to a function of directly transmitting the RLC SDUs, received from the lower layer, to an upper layer regardless of the order thereof. The out-of-sequence delivery function may include, if one RLC SDU has been originally segmented into multiple RLC SDUs and received, a function of reassembling the multiple RLC SDUs and transmitting the same, and a function of storing the RLC SNs or PDCP SNs of the received RLC PDUs, reordering the sequence, and recording the missing RLC PDUs.

The NR MACs 426 and 436 may be connected to multiple NR RLC layer devices configured in one UE 318. The main function of the NR MAC may include some of the following functions: mapping between logical channels and transport channels; multiplexing/de-multiplexing of MAC SDUs; scheduling information reporting; error correction through HARQ; priority handling between logical channels of one UE; priority handling between UEs by means of dynamic scheduling; MBMS service identification; transport format selection; and padding.

The NR PHY layers 428 and 438 may perform operations of channel-coding and modulating upper layer data, forming the upper layer data into an OFDM symbol, transmitting the OFDM symbols via a radio channel or demodulating and channel decoding of the OFDM symbols received via the radio channel, and transferring the OFDM symbol to an upper layer.

### Principles for Security Protection

As described above, in both example networks, there is security protection from ciphering or integrity protection. Ciphering means not only the ciphering operation but also the deciphering operation because the deciphering should be applied to the data at the receiver if a data is ciphered at the transmitter. Likewise, integrity protection means the integrity verification operation as well as the integrity protection operation because the integrity verification should be applied to the data at the receiver if a data is integrity protected at the transmitter.

The following high-level principles can be applied when implementing the present techniques. The AS security comprises the integrity protection and ciphering of RRC signalling (SRBs) and user data (DRBs). RRC handles the configuration of the AS security parameters which are part of the AS configuration: the integrity protection algorithm and the ciphering algorithm. If integrity protection and/or ciphering is enabled for a DRB and two parameters, namely the keySetChangeIndicator and the nextHopChainingCount, which are used by the UE to determine the AS security keys upon reconfiguration with sync (with key change), connection re-establishment and/or connection resume.

The integrity protection algorithm is common for SRB1, SRB2, SRB3 (if configured), SRB4 (if configured), SRBx (if configured) and DRBs configured with integrity protection, with the same keyToUse value. The ciphering algorithm is common for SRB1, SRB2, SRB3 (if configured), SRB4 (if configured), SRBx (if configured) and DRBs configured with the same keyToUse value. Neither integrity protection nor ciphering applies for SRB0. It is noted that all DRBs related to the same PDU session have the same enable/disable setting for ciphering and the same enabledisable setting for integrity protection.

RRC integrity protection and ciphering are always activated together, i.e. in one message/procedure. RRC integrity protection and ciphering for SRBs are never deactivated. However, it is possible to switch to a ‘NULL’ ciphering algorithm (nea0). For SRBx (if configured), RRC integrity protection and ciphering can be activated and deactivated based on configuration or indication by RRC messages (or MAC CE (Control Element) or PDCP control PDU (Protocol Data Unit)), in order to reduce the UE processing burden. For SRBx (if configured), it is also possible to switch to a ‘NULL’ ciphering algorithm (nea0) and the ‘NULL’ integrity protection algorithm (nia0) can be used.

The ‘NULL’ integrity protection algorithm (nia0) is used only for SRBs and for the UE in limited service mode and when used for SRBs, integrity protection is disabled for DRBs. In case the ‘NULL’integrity protection algorithm is used, ‘NULL’ ciphering algorithm is also used. It is noted that lower layers discard RRC messages for which the integrity protection check has failed and indicate the integrity protection verification check failure to RRC.

The AS applies four different security keys: one for the integrity protection of RRC signalling (K_{RRCint}), one for the ciphering of RRC signalling (K_{RRCenc}), one for integrity protection of user data (K_{UPint}) and one for the ciphering of user data (K_{UPenc}). All four AS keys are derived from the K_{gNB} key. The K_{gNB} key is based on the KAMF key, which is handled by upper layers. The integrity protection and ciphering algorithms can only be changed with reconfiguration with sync. The AS keys (K_{gNB}, K_{RRCint}, K_{RRCene}, K_{UPint} and K_{UPenc}) change upon reconfiguration with sync (if masterKeyUpdate is included), and upon connection re-establishment and connection resume.

For each radio bearer an independent counter (COUNT used in PDCP layer) is maintained for each direction. For each radio bearer, the COUNT is used as input for ciphering and integrity protection. It is not allowed to use the same COUNT value more than once for a given security key. The network is responsible for avoiding reuse of the COUNT with the same RB identity and with the same key, e.g. due to the transfer of large volumes of data, release and establishment of new RBs, and multiple termination point changes for RLC-UM bearers and multiple termination point changes for RLC-AM bearer with SN terminated PDCP re-establishment (COUNT reset) due to SN only full configuration whilst the key stream inputs (i.e. bearer ID, security key) at MN have not been updated. In order to avoid such re-use, the network may e.g. use different RB identities for RB establishments, change the AS security key, or an RRC_CONNECTED to RRC_IDLE/RRC_INACTIVE and then to RRC_CONNECTED transition.

In order to limit the signalling overhead, individual messages/packets include a short sequence number (PDCP SN (Sequence Number)). In addition, an overflow counter mechanism is used: the hyper frame number (HFN used in PDCP layer). The HFN needs to be synchronized between the UE and the network.

For each SRB, the value provided by RRC to lower layers to derive the 5-bit BEARER parameter used as input for ciphering and for integrity protection is the value of the corresponding srb-Identity with the MSBs padded with zeroes.

For a UE provided with an sk-counter, keyToUse indicates whether the UE uses the master key (K_{gNB}) or the secondary key (S-K_{eNB} or S-K_{gNB}) for a particular DRB. The secondary key is derived from the master key and sk-Counter. Whenever there is a need to refresh the secondary key, e.g. upon change of MN with K_{gNB} change or to avoid COUNT reuse, the security key update is used. When the UE is in NR-DC, the network may provide a UE configured with an SCG with an sk-Counter even when no DRB is setup using the secondary key (S-K_{gNB}) in order to allow the configuration of SRB3. The network can also provide the UE with an sk-Counter, even if no SCG is configured, when using SN terminated MCG bearers.

### General AI/ML Framework

FIG. 5 is a schematic block diagram for a functional framework 500 for implementing Artificial Intelligence or Machine Learning in the radio access networks (such as those shown in FIG. 1 or FIG. 3). Such a functional framework may be termed an AI-enabled radio access network intelligence. FIG. 5 comprises a data collection module 502 which provides training data to a model training module 504 and inference data to a model inference module 506. As illustrated by the flow of information, after the model has been trained in the model training module 504, an update of the model is deployed to the model inference module 506. Optionally, as indicated by the dotted line, the model inference module 506 may provide model performance feedback to the model training module 504 which may be used to further update the model.

FIG. 5 also shows an actor module 508. The actor module 508 receives an output from the model inference module 506 and is used to provide feedback to the data collection module 502. As described in the definitions above, the output from the model inference module 506 is the inference output of the AI/ML model. The feedback may include information needed to derive training data, inference data or to monitor the performance of the AI/ML model.

The detailed AI/ML algorithms and models for use cases are implementation specific. For example, considering the issues identified in the background section, ML techniques could be utilized to optimize the energy saving decisions by leveraging on the data collected in the RAN network. ML algorithms may predict the energy efficiency and load state of the next period, which can be used to make better decisions on cell activation/deactivation for energy saving. Based on the predicted load, the system may dynamically configure the energy-saving strategy (e.g., the switch-off timing and granularity, offloading actions) to keep a balance between system performance and energy efficiency and to reduce the energy consumption. Additionally or alternatively, solutions based on AI/ML model could be introduced to improve the load balancing performance. Based on collection of various measurements and feedbacks from UEs and network nodes, historical data, etc. AI/ML model-based solutions and predicted load could improve load balancing performance, in order to provide higher quality user experience and to improve the system capacity.

Considering further uses, mobility aspects of self-organising networks (SON) that can be enhanced by the use of AI/ML include reduction of the probability of unintended events, UE Location/Mobility/Performance prediction and traffic steering. Predicting UE's location is a key part for mobility optimisation, as many RRM actions related to mobility (e.g., selecting handover target cells) can benefit from the predicted UE location/trajectory. UE mobility prediction is also one key factor in the optimization of early data forwarding particularly for CHO. UE Performance prediction when the UE is served by certain cells is a key factor in determining which is the best mobility target for maximisation of efficiency and performance. RAN Intelligence could observe multiple handover events with associated parameters, use this information to train its ML model and try to identify sets of parameters that lead to successful handover s and sets of parameters that lead to unintended events.

Regarding traffic steering, efficient resource handling can be achieved adjusting handover trigger points and selecting optimal combination of Pcell/PSCell/Scells to serve a user. Existing traffic steering can also be improved by providing a RAN node with information related to mobility. For example, before initiating a handover, the source gNB could use feedbacks on UE performance collected for successful handovers occurred in the past and received from neighbouring gNBs. In the two reported examples, the source RAN node of a mobility event, or the RAN node acting as Master Node (an eNB for EN-DC, a gNB for NR-DC) can use feedbacks received from the other RAN node, as input to an AI/ML function supporting traffic related decisions (e.g., selection of target cell in case of mobility, selection of a PSCell Scell(s) in the other case), so that future decisions can be optimized.

Where the AI/ML functionality resides within the current RAN architecture depends on deployment and on the specific use cases. For example, one solution which can be considered for supporting AI/ML-based network energy saving include AI/ML Model Training being located in the operations, administration and management (OAM) system and AI/ML Model Inference is located in the gNB. In this example, the gNB is also allowed to continue model training based on AI/ML model trained in the OAM. Alternatively, AI/ML Model Training and AI/ML Model Inference are both located in the gNB.

The detailed AI/ML algorithms and models (both training and inference) can be configured to UE or gNB or a network entity together with other related parameters and configuration information by the RRC (Radio Resource Control) message or newly defined network message (e.g. X2 message, inter-node messages for interface between network entities). Configuration with messages allows for various arrangements. For example, AI/ML Model Training may be located in the UE and AI/ML Model Inference may be located in the gNB or OAM. Alternatively, AI/ML Model Training may be is located in the gNB or OAM and AI/ML Model Inference may be located in the UE. Alternatively, AI/ML Model Training and AI/ML Model Inference are both located in the UE. Training at the UE may enable federated learning or split learning as defined above.

The architecture may comprise a split of central units (CUs) and data units (DUs) (in other words, there may be a split CU/DU architecture as one of the gNB implementations). In this example, one solution is AI/ML Model Training is located in the OAM and AI/ML Model Inference is located in the gNB-CU. Another solution is AI/ML Model Training and Model Inference are both located in the gNB-CU. Configuration with messages (e.g. for federated or split learning) allows for further solutions. For example, one solution is AI/ML Model Training is located in UE and AI/ML Model Inference is located in the gNB-CU or OAM. Another solution is that the AI/ML Model Training is located in the gNB-CU or OAM and AI/ML Model Inference is located in the UE. Another solution is that the AI/ML Model Training and AI/ML Model Inference are both located in the UE.

In all the various arrangement, the general principle is that the Model Training and Model Inference functions should be able to request, if needed, specific information to be used to train or execute the AI/ML algorithm and to avoid reception of unnecessary information for UE or gNB or a network entity by using signalling (i.e. sending a request message). The nature of such information depends on the use case and on the AI/ML algorithm. The Model Inference function should signal the outputs of the model only to nodes that have explicitly requested them (e.g., via subscription or via configuration), or nodes that take actions based on the output from Model Inference, e.g. by sending a message (e.g. RRC message or inter-node message or a newly-defined message). An AI/ML model used in a Model Inference function has to be initially trained, validated and tested by the Model Training function before deployment to guarantee the performance and avoid a lot of signalings and save radio resource. It can be also trained after deployment in some cases. User data privacy and anonymisation can be respected during AI/ML operation.

As described in detail below, the proposed mechanism can work in NG-RAN SA (Next Generation-RAN StandAlone operation mode) and thus in the network arrangement of FIG. 3. A skilled person will readily appreciate that the proposed mechanism can be extended to other suitable networks, such as EN-DC (Evolved-Universal Terrestrial Radio Access (E-UTRA)-New Radio Dual Connectivity with E-UTRA connected to EPC (Evolved Packet Core network)) and MR-DC (Multi-Radio Access Technology (RAT) Dual Connectivity).

### User Equipment States and Transitions

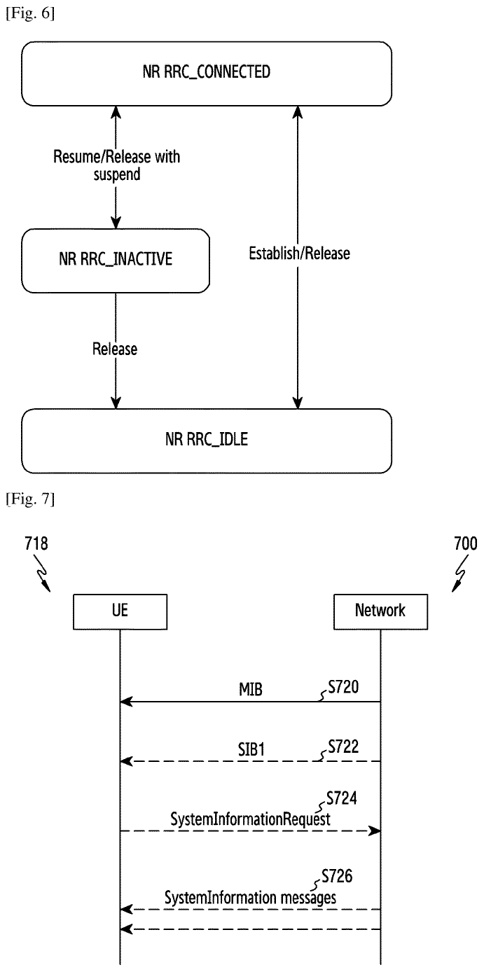

As noted above, the AI/ML configuration information can be sent in RRC messages or other messages. Before considering examples of implementations in detail, we first consider the procedures for RRC which are proposed to handle AI/ML functionality. FIG. 6 illustrates an overview of UE RRC state machine and state transitions in NR. A UE has only one RRC state in NR at one time. As shown in FIG. 6, a UE is either in RRC_CONNECTED state or in RRC_INACTIVE state when an RRC connection has been established. If this is not the case, i.e. no RRC connection is established, the UE is in RRC_IDLE state.

The RRC_IDLE state can be characterised by various features. For example, a UE specific DRX may be configured by upper layers and at lower layers, the UE may be configured with a Discontinuous Reception (DRX) for Point-to-Multipoint (PTM) transmission of Multicast and Broadcast Service (MBS) broadcast. There may also be UE controlled mobility based on network configuration. The UE may monitor Short Messages transmitted with Paging-Radio Network Temporary Identifier (P-RNTI) over Data Center Interconnect (DCI) and may monitor a Paging channel for Core Network (CN) paging using 5G-S-TMSI, except if the UE is acting as a Level 2 U2N Remote UE. When the UE is configured by upper layers for MBS multicast reception, the UE may monitor a Paging channel for CN paging using TMGI. The UE may perform neighbouring cell measurements and cell (re-)selection; acquire system information (SI) and can send SI request (if configured); and performs logging of available measurements together with location and time for logged measurement configured UEs. The UE may further perform idle/inactive measurements for idle/inactive measurement configured UEs and performs AI/ML functionality (e.g. collection of AI/ML data or measurements for AI/ML data or reporting AI/ML data) for suitably configured UEs. When the UE is configured by upper layers for MBS broadcast reception, the UE may acquire MCCH change notification and MBS broadcast control information and data.

Similarly, the RRC_INACTIVE state can be characterised by various features. For example, a UE specific DRX may be configured by upper layers or by RRC layer and at lower layers, the UE may be configured with a DRX for PTM transmission of MBS broadcast. There may be UE controlled mobility based on network configuration and the UE may store the UE Inactive AS context. A RAN-based notification area may be configured by RRC layer and transfer of unicast data and/or signalling to/from UE over radio bearers may be configured for Small Data Transmission (SDT). The UE may monitor Short Messages transmitted with P-RNTI over DCI. During SDT procedure, the UE may monitor control channels associated with the shared data channel to determine if data is scheduled for it and while SDT procedure is not ongoing, the UE may monitor a Paging channel for CN paging using 5G-S-TMSI and RAN paging using full-RNTI, except if the UE is acting as a L2 U2N Remote UE. If the UE is configured by upper layers for MBS multicast reception, while SDT procedure is not ongoing, the UE may monitor a Paging channel for paging using TMGI. The UE may perform neighbouring cell measurements and cell (re-)selection; and perform RAN-based notification area updates periodically and when moving outside the configured RAN-based notification area. The UE may acquire system information, while SDT procedure is not ongoing, and can send SI request (if configured). While SDT procedure is not ongoing, the UE may perform logging of available measurements together with location and time for logged measurement configured UEs; perform idle/inactive measurements for idle/inactive measurement configured UEs; and/or perform AI/ML functionality (e.g. collection of AI/ML data or measurements for AI/ML data or reporting AI/ML data) configured UEs. If the UE is configured by upper layers for MBS broadcast reception, the UE acquires MCCH change notification and MBS broadcast control information and data. The UE may also transmit SRS for Positioning.

Similarly, the RRC_CONNECTED state can be characterised by various features. For example, the UE stores the AS context. There is transfer of unicast data to/from UE and transfer of MBS multicast data to UE. At lower layers, the UE may be configured with a UE specific DRX or with a DRX for PTM transmission of MBS broadcast and/or a DRX for MBS multicast. For UEs supporting Carrier Aggregation (CA), there may be use of one or more SCells, aggregated with the SPCell, for increased bandwidth. For UEs supporting DC, there may be use of one SCG, aggregated with the MCG, for increased bandwidth. There may be network controlled mobility within NR, to/from E-UTRA, and to UTRA-FDD. There may be network controlled mobility (path switch) between a serving cell and a L2 U2N Relay UE, or vice versa. The UE may monitor Short Messages transmitted with P-RNTI over DCI, if configured. The UE may monitor control channels associated with the shared data channel to determine if data is scheduled for it. The UE may provide channel quality and feedback information. The UE may perform neighbouring cell measurements and measurement reporting and AI/ML functionality (e.g. collection of AI/ML data or measurements for AI/ML data or reporting AI/ML data) for configured UEs. The UE may acquire system information. The UE may perform immediate Minimization of Drive Test (MDT) measurement together with available location reporting. If the US is configured by upper layers for MBS broadcast reception, the UE acquire MCCH change notification and MBS broadcast control information and data.

### Principles for RRC Control for AI/ML

The RRC protocol includes the following main functions: broadcast of system information, RRC connection control, and recovery from radio link failure. The broadcast of system information comprising different types of information including some or all of NAS common information; information applicable for UEs in RRC_IDLE and RRC_INACTIVE (e.g. cell (re-)selection parameters, neighbouring cell information) and information (also) applicable for UEs in RRC_CONNECTED (e.g. common channel configuration information); Earthquake and Tsunami Warning System (ETWS) notification, Commercial Mobile Alert Service (CMAS) notification; positioning assistance data and an indication whether the cell supports AI/ML functionality or not. The system information can broadcast the indication. When UE acquires the system information, UE can perform the cell (re-)selection based on this and send UE Capability information including UE's capability for AI/ML functionality support to the cell (or gNB or network) if the system information broadcast the indication supporting AI/ML functionality.

RRC connection control may include the establishment, modification, suspension, resumption and/or release of an RRC connection, including e.g. assignment/modification of UE identity (C-RNTI, full I-RNTI, etc.). RRC connection control may include the establishment, modification, suspension, resumption and/or release of SRBs (except for SRB0). RRC connection control may include the establishment, modification, suspension, resumption and/or release of RBs carrying user data (DRBs/MRBs);
RRC connection control may include access barring; The access barring mechanism can allow UE with the purpose of AI/ML functionality to access the cell based on the newly-defined indication in system information. The access barring mechanism also cannot allow UE with the purpose of AI/ML functionality to access the cell based on the newly-defined indication in system information. RRC connection control may include initial AS security activation, i.e. initial configuration of AS integrity protection (SRBs, DRBs) and AS ciphering (SRBs, DRBs). RRC connection mobility may include e.g. intra-frequency and inter-frequency handover, path switch from a PCell to a target L2 U2N Relay UE or from a L2 U2N Relay UE to a target PCell, associated AS security handling, i.e. key/algorithm change, and specification of RRC context information transferred between network nodes;
RRC connection control may comprise radio configuration control including e.g. assignment and/or modification of ARQ configuration, HARQ configuration and DRX configuration. In the case of DC, cell management may include e.g. addition, modification and/or release of SCG cell(s) or change of PSCell. In the case of CA, cell management may include e.g. addition, modification and/or release of SCell(s). RRC connection control may comprise QoS control including assignment or modification of semi-persistent scheduling (SPS) configuration and configured grant configuration for downlink (DL) and uplink (UL) respectively, and assignment or modification of parameters for UL rate control in the UE, i.e. allocation of a priority and a prioritised bit rate (PBR) for each RB of UE and logical channel of IAB-MT.

RRC connection control may comprise AI/ML functionality control including assignment or modification of semi-persistent scheduling (SPS) configuration and configured grant configuration for DL and UL respectively, assignment/modification of parameters for UL rate control in the UE, i.e. allocation of a priority and a prioritised bit rate (PBR) for each RB of UE and logical channel of Integrated Access and Backhaul Mobile Termination (IAB-MT).

Recovery from radio link failure may include inter-RAT mobility including e.g. AS security activation, transfer of RRC context information. Recovery from radio link failure may include measurement configuration and reporting. For example, the configuration and reporting may include establishment, modification, or release of measurement configuration (e.g. intra-frequency, inter-frequency and inter-RAT measurements, measurements for AI/ML functionality; setup and release of measurement gaps and measurement reporting. Recovery from radio link failure may include AI/ML configuration and reporting for AI/ML functionality and measurement. This may include establishment, modification, or release of AI/ML configuration including measurement configuration (e.g. intra-frequency, inter-frequency and inter-RAT measurements, time information (measurement duration or timing for measurement) or sequence number for reordering or cell identity (or Physical cell Identity)) and including the measurement configuration (e.g. for beam or Single Sideband (SSB) or Channel State Information (CSI) or Cell Reference Signals (CRS)). The AI/ML configuration and reporting for AI/ML functionality may comprise setup and release of AI/ML configuration including measurement configuration; and AI/ML reporting including measurement reporting (e.g. for frequency or beam or SSB or CSI or CRS or cell identity (or Physical cell Identity)).

Recovery from radio link failure may include configuration of BAP entity and BH RLC channels for the support of IAB-node. Recovery from radio link failure may include other functions including e.g. generic protocol error handling, transfer of dedicated NAS information, transfer of UE radio access capability information. Recovery from radio link failure may include support of self-configuration and self-optimisation, support of measurement logging and reporting for network performance optimisation support of transfer of application layer measurement configuration and reporting; and support of AI/ML configuration and reporting.

RRC connection establishment involves the establishment of SRB1. The network completes RRC connection establishment prior to completing the establishment of the NG connection, i.e. prior to receiving the UE context information from the 5GC. Con-sequently, AS security is not activated during the initial phase of the RRC connection. During this initial phase of the RRC connection, the network may configure the UE to perform measurement reporting or collect AI/ML data, but the UE only sends the corresponding measurement reports or AI/ML data after successful AS security activation. However, the UE only accepts a re-configuration with sync message when AS security has been activated.

The AI/ML data indicates AI/ML (model) training or inference or training data or predicted information or decision parameters or a set of inputs for AI/ML or AI/ML model. For example, the AI/ML data can indicate the measurement report (e.g. for beam or SSB (Synchronization Signal Block) or CSI or CRS (Cell specific Reference Signal)) and CSI (Channel State Information) report or positioning information for a UE.

Upon receiving the UE context from the 5GC, the RAN activates AS security (both ciphering and integrity protection) using the initial AS security activation procedure. The RRC messages to activate AS security (command and successful response) are integrity protected, while ciphering is started only after completion of the procedure. That is, the response to the message used to activate AS security is not ciphered, while the subsequent RRC messages (e.g. used to establish SRB2, DRBs and multicast MRBs or a new RB (e.g. SRBx or SRB4 or DRB) for supporting AI/ML functionality or used to transmit/receive AI/ML data (or AI/ML configuration)), e.g. RRCSetup or RRCResume or RRCReconfiguration messages are both integrity protected and ciphered. In another embodiment, a RRC message transmitted via the RB used to transmit/receive AI/ML data (or AI/ML configuration) may not be integrity protected or ciphered or neither based on security configuration. After having initiated the initial AS security activation procedure or establishment of SRB1, the network may initiate the establishment of SRB2 and DRBs and/or multicast MRBs or a new RB (e.g. SRBx or SRB4 or DRB) for supporting AI/ML functionality, i.e. the network may do this prior to receiving the confirmation of the initial AS security activation from the UE. In any case, the network will apply both ciphering and integrity protection for the RRC reconfiguration messages used to establish SRB2, DRBs and/or multicast MRBs, or a new RB (e.g. SRBx or SRB4 or DRB) for supporting AI/ML functionality.

The network initiates the security mode command procedure to a UE in RRC_CONNECTED. Moreover, the network applies the procedure when only SRB1 is established, i.e. prior to establishment of SRB2, multicast MRBs and/or DRBs or a new RB (e.g. SRBx or SRB4 or DRB) for supporting AI/ML functionality. The Network can initiate the RRC reconfiguration procedure to a UE in RRC_CONNECTED to establish RBs (other than SRB1, that is established during RRC connection establishment), e.g. SRB2, DRBs and/or multicast MRBs, or a new RB (e.g. SRBx or SRB4 or DRB) for supporting AI/ML functionality, is performed only when AS security has been activated.

The network should release the RRC connection if the initial AS security activation and/or the radio bearer establishment fails. A configuration with SRB2 without DRB or multicast MRB or a new RB (e.g. SRBx or SRB4 or DRB) for supporting AI/ML functionality, or with DRB or multicast MRB without SRB2 is not supported (i.e., SRB2 and at least one DRB or multicast MRB or a new RB (e.g. SRBx or SRB4 or DRB) for supporting AI/ML functionality, must be configured in the same RRC Re-configuration message, and it is not allowed to release all the DRBs and multicast MRBs and a new RB (e.g. SRBx or SRB4 or DRB) for supporting AI/ML functionality, without releasing the RRC Connection). For IAB-MT, a configuration with SRB2 without any DRB/MRB/or a new RB (e.g. SRBx or SRB4 or DRB) for supporting AI/ML functionality is supported.

For establishment of a new RB (e.g. SRBx or SRB4 or DRB) for supporting AI/ML functionality, the RRC message transmitted via SRB1 (e.g. RRCReconfiguration message) includes the AI/ML configuration and the configuration for the new SRB.

The AI/ML configuration includes the type of AI/ML Model (e.g. Identifier for Model or Model functionality), Model Inference, Model training, Algorithms or how to construct a RRC message for response (or report) including AI/ML data (e.g. which information should be included) or how to send the RRC message from the transmitter (UE or gNB) to the receiver (gNB or UE) (e.g. periodicity, timer related information, etc). The AI/ML configuration can include the measurement configuration (e.g for beam or SSB (Synchronization Signal Block) or CSI or CRS(Cell specific Reference Signal)) and CSI measurement configuration (e.g aperiodic CSI, periodic CSI, etc) or positioning configuration for a UE.

When the AI/ML data or AI/ML configuration indicates the AI/ML model, it means AI/ML model transfer (or AI/ML model delivery) by RRC message via SRB1 or a new RB (e.g. SRBx or SRB4 or DRB) for supporting AI/ML functionality.

AI/ML model transfer (or AI/ML model delivery) may mean the delivery of an AI/ML model over the air interface, either parameters of a model structure known at the receiving end or a new model with parameters or identifies for model or function. The function may indicate the measurement (e.g. for beam or SSB (Synchronization Signal Block) or CSI or CRS(Cell specific Reference Signal)) and CSI measurement (e.g aperiodic CSI, periodic CSI, etc) or positioning for a UE. Delivery may contain a full model or a partial model. It may be a generic term referring to delivery of an AI/ML model from one entity to another entity in any manner. An entity could mean a network node/function (e.g., gNB, LMF (Life Management Function), etc.), UE, proprietary server, etc.

When a new RB (e.g. SRBx or SRB4 or DRB) for supporting AI/ML functionality is established, the UE (or the gNB) can send AI/ML data via the RB to the gNB (or the UE) and vice versa. If the RB is a SRB (e.g. SRBx or SRB4 or SRB5), a RRC message including AI/ML data can be transmitted and received in UE or gNB and the RRC message can be newly defined for AI/ML functionality.

When AI/ML data (or AI/ML configuration) is transmitted via SRB1 or the new RB, the RRC message (or AI/ML data) can be segmentation if the RRC message segmentation is enabled based on the field rrc-SegAllowed received in the received RRC message, and the encoded RRC message (or AI/ML data) is larger than the maximum supported size of a PDCP SDU (e.g. 9 Kbytes) for Uplink transmission or Downlink transmission. When the RRC message is segmented, each segment includes its own sequence number and the indicator (to indicate whether it is the last segment or not).

The AI/ML configuration may be configured and the AI/ML data may be transmitted and received as a part SON (Self-Organizing Network) procedure, MDT (Minimization of Drive Tests) procedure, UE assistance information, early idle/inactive measurements, RRM (Radio Resource Management) measurement reports, CSI (Channel Status Information) reporting framework, LPP (LTE Positioning Protocol) Provide location information.

Returning to FIG. 6, as shown, the UE transitions from the RRC_CONNECTED state to the RRC_IDLE state when the RRC connection is released. The release of the RRC connection normally is initiated by the network. The procedure may be used to re-direct the UE to an NR frequency or an E-UTRA carrier frequency. The suspension of the RRC connection is initiated by the network. When the RRC connection is suspended, the UE stores the UE Inactive AS context and any configuration received from the network, and transits to RRC_INACTIVE state. The RRC message to suspend the RRC connection is integrity protected and ciphered.

The resumption of a suspended RRC connection is initiated by upper layers when the UE needs to transit from RRC_INACTIVE state to RRC_CONNECTED state or by RRC layer to perform a RAN Notification Area (RNA) update or by RAN paging from NG-RAN or for SDT. When the RRC connection is resumed, network configures the UE according to the RRC connection resume procedure based on the stored UE Inactive AS context and any RRC configuration received from the network. The RRC connection resume procedure re-activates AS security and re-establishes SRB(s) and DRB(s) and/or multicast MRB(s) or a new Radio Bearer RB (e.g. SRBx or SRB4 or DRB) for supporting AI/ML functionality, if configured. When a new RB for supporting AI/ML functionality is a DRB, the DRB can be AM (Acknowledged Mode) DRB configured with AM RLC entities and using RLC AM mode to support lossless delivery and high reliability, wherein AM mode supports ARQ (Automatic Repeat Request) mechanism.

Upon initiating the resume procedure for SDT, AS security (both ciphering and integrity protection) is re-activated for SRB2 (if configured for SDT) and for SRB1. In addition, AS security is also re-activated (if security is configured) for all the DRBs configured for SDT. Further, the PDCP entities of SRB1 and PDCP entities of the radio bearers configured for SDT are re-established and resumed whilst the UE remains in RRC_INACTIVE state. Transmission and reception of data and/or signalling messages over radio bearers configured for SDT can happen whilst the UE is in RRC_INACTIVE state and SDT procedure is ongoing.

In response to a request to resume the RRC connection or in response to a resume procedure initiated for SDT, the network may resume the suspended RRC connection and send UE to RRC_CONNECTED, or reject the request to resume and send UE to RRC_INACTIVE (with a wait timer), or directly re-suspend the RRC connection and send UE to RRC_INACTIVE, or directly release the RRC connection and send UE to RRC_IDLE, or instruct the UE to initiate NAS level recovery (in this case the network sends an RRC setup message).

### System Information Acquisition

As mentioned above, the UE applies the system information (SI) acquisition procedure to acquire the AS, NAS- and positioning assistance data information. The procedure applies to UEs in RRC_IDLE, in RRC_INACTIVE and in RRC_CONNECTED. FIG. 7 illustrates one method a user equipment 718 can acquire the system information from a network 700.

In a first step S720, the UE 718 which is in RRC_IDLE or RRC_INACTIVE mode, receives from the network 700, information from the Management Information Base (MIB). This ensures the UE 718 has a valid version of the MIB. In a second step S722, the UE 718 receives from the network 700, the System Information Block Types which include at least SIB1 through SIB4. If the UE supports E-UTRA, SIB5 is also received. If the UE is configured for idle/inactive measurements SIB11 is also received. If the UE is capable of NR sidelink communication/discovery and is configured by upper layers to receive or transmit NR sidelink communication/discovery) SIB12 is also received. If the UE is capable of V2X sidelink communication and is configured by upper layers to receive or transmit V2X sidelink communication SIB13 and SIB14 are received. If the UE is configured by upper layers to report disaster roaming related information, SIB15 is received. If the UE is capable of slice-based cell reselection and the UE receives NSAG information for cell reselection from upper layer, SIB16 is received. If the UE is accessing NR via NTN access, SIB19 is received. Finally, if the US is capable of AI/ML functionality (e.g. AI/ML Model Training and Model Inference), a new System Information Block Type SIBxx (e.g. SIB22) is received. SIBxx can broadcast whether the cell supports AI/ML Model Training or Model Inference or AI/ML functionalities or the information about AI/ML Model Training or Model Inference. The UE capable of AI/ML functionality which is receiving or in-terested to receive AI/ML functionality via a SRB or DRB shall ensure having a valid version of SIBxx, regardless of the RRC state the UE is in.

Once the management information and system type block information has been shared, as shown at step S724, the UE 718 can send a message requesting system information (SystemInformationRequest). At the next step S726, the network 700 responds with one or more messages communicating the requested system information (SystemInformationMessages).

### Detailed Procedure for One Example State Transition

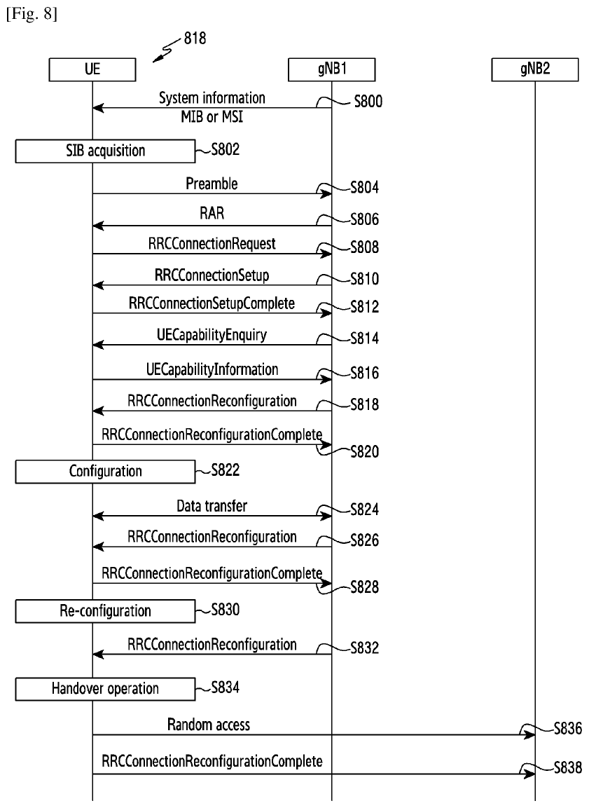

FIG. 8 is a flowchart showing the procedure in which a UE switches from an RRC idle mode to an RRC connected mode. The procedure may be carried out in a RRC connected mode in a next-generation mobile communication system such as the examples shown in FIG. 1 or FIG. 3. The procedure includes a method for configuring a protocol layer device or functions of the UE 818. As shown, there are communications between the UE 818 and a first node in the network gNB1 and between the UE 818 and a second node in the network gNB2. Two nodes are merely illustrative.

Each cell or node (e.g. gNB 1 or gNB 2) to which a base station provides service may serve a very wide frequency band. First, the UE 818 may search the entire frequency band provided by a service provider (PLMN) in units of predetermined resource blocks (for example, in units of 12 resource blocks (RBs)). That is, the UE 818 may start discovering a primary synchronization sequence (PSS) or a secondary synchronization sequence (SSS) in the entire system bandwidth in units of resource blocks. If the UE 818 discovers the PSS or SSS in the units of resource blocks and then detects the signals, the UE may read the signals, analyze (decode) the signals, and identify a boundary between a subframe and a radio transmission resource frame (radio frame). If the UE 818 completes synchronization, the UE may read system information of a cell on which the UE currently camps. That is, the UE may identify information on a control resource set (CORESET) by identifying a master system information block (MIB) or minimum system information (MSI) and identify initial access bandwidth part (BWP) information by reading system information in operations S800 and S802. In the above, CORESET information refers to the location of time/frequency transmission resources through which a control signal is transmitted from the base station, and may be, for example, the location of resources through which a PDCCH channel is transmitted. The system information and SIB acquisition may be as detailed in FIG. 7.

As described above, if the UE 818 completes synchronization of the downlink signal with the base station (gNB 1) and is able to receive a control signal, the next phase is to configure the RRC connection. For example, this may be done by performing a random-access procedure in the initial BWP including sending, at step S804, a preamble message from the UE to the base station. The base station may then send a random-access response which is received at the UE 818 at step S806. The UE 818 then sends a RRCConnectionRequest at step S808 to make a request for configuring an RRC connection and receives a RRCConnectionSetup message from the base station at step S810. The UE may configure one or more of bearer setup information, cell group setup information, cell setup information, AI/ML configuration, each layer device information (for example, SDAP layer device (or new layer device), PDCP layer device, RLC layer device, MAC layer device, or PHY layer device) through the RRCConnectionSetup message. Once the RRC connection is configured or established at the UE 818, a RRCConnectionSetupComplete message which confirms that the set up is complete is sent at step S812 from the UE to the base station. The RRCConnectionSetup message may include configuration information for a PCell, Pscell, or multiple cells, and may configure multiple partial bandwidths for each cell (PCell, Pscell, or Scell).

Steps S804 to S812 represent the procedure for establishing a basic RRC connection, e.g. using SRB1. Once this is completed, at step S814 the base station (gNB 1) may transmit to the UE an RRC message (UECapabilityEnquiry) in order to identify the UE capability. The base station transmits the RRC message to the UE to identify UE performance, for example, to identify how much of the frequency band the UE can read, or whether the UE supports functions or the area of frequency band that the UE can read.

When receiving the RRC message inquiring about the UE capability, the UE performs a UE capability report procedure and may transmit at step S816 to the base station the RRC message (UECapabilityInformation) including UE capability information relating to functions supported by the UE. The RRC message (e.g., non-access stratum (NAS) message or access stratum (AS) message) for reporting UE capability may include some or multiple pieces of information for AI/ML functionality. In addition, after identification of the UE performance, an appropriate partial bandwidth (BWP) or appropriate functions may be configured for the UE.

The base station may request the UE capability from the UE. In another method, the base station may ask the MME (mobile management entity) or the AMF (access & mobility management function) about the UE capability in order to identify the UE capability. This is because the MME or the AMF may have UE capability information if the UE previously accessed the MME or the AMF.

There may be a need to reconfigure the UE, for example as a result of the received capability information and thus the base station may send a reconfiguration message (e.g. RRCConnectionReconfiguration message) at step S818 to the UE. In response to the reconfiguration message, the UE may configure bearer setup information, cell group setup information, cell setup information, AI/ML configuration, each layer device information (for example, SDAP layer device (or new layer device), PDCP layer device, RLC layer device, MAC layer device, or PHY layer device). The RRC message may include configuration information for a PCell, Pscell, or multiple cells, and may configure multiple partial bandwidths for each cell (PCell, Pscell, or Scell). When receiving the RRCConnectionReconfiguration message in which the configuration information of the UE is received, the UE may apply the configuration information to the bearer or layer device of the UE. Once the reconfiguration is complete, the UE sends at step S820 a message to the base station confirming that the configuration is complete. The message may be a RRCConnectionReconfigurationComplete message. As indicated at step S822, the configuration of the connection is thus complete.

At step S824, there is a two way arrow to indicate that data can be transferred from the UE to the base station and vice versa. Multiple data transfer steps may be carried out. As indicated at step S826, there may be a need to reconfigure the UE and thus the base station may send a RRCConnectionReconfiguration message at step S826 to the UE. In response to the reconfiguration message, the UE may apply the configuration information to the bearer or layer device of the UE. Once the reconfiguration is complete, the UE sends at step S828 a message to the base station confirming that the configuration is complete. As indicated at step S830, the reconfiguration of the connection is thus complete. The reconfiguration information may cover the same parameters as the configuration information sent at step S810 and the reconfiguration information sent at step S818.

In addition, when the base station (gNB 1) or network instructs the UE to handover to another cell or frequency, the base station (gNB 1) or network may configure a handover message including configuration information of a target base station (gNB 2) for handover. The handover message (RRCConnectionReconfiguration message) is transmitted to the UE at step S832. The UE may then perform a handover procedure (for example, or a synchronization procedure or a random access procedure as shown at step S836 to a target base station gNB 2) according to the handover setting. The UE may configure an RRCConnectionReconfigurationComplete message and transmit the same at step S834 to the target base station when the handover is successfully performed. The configuration information of the target base station gNB 2 may include bearer configuration information, cell group configuration information, cell configuration information, AI/ML configuration, each layer device information (e.g., SDAP layer device (or new layer device) or PDCP layer device, or RLC layer device, MAC layer device, or PHY layer device). The other configuration information mentioned above may also be included.

FIG. 6 shows that an RRC message which resumes a connection may be sent to move from the inactive to connected state. The resume message may comprise some or all of the configuration information which is described above for the initial configuration or the reconfiguration. Further detail, including the pseudo code for the RRC connection control is provided below.

### Example Use Cases

### AI/ML Model Training at Central Server and AI/ML Model Inference at a Node

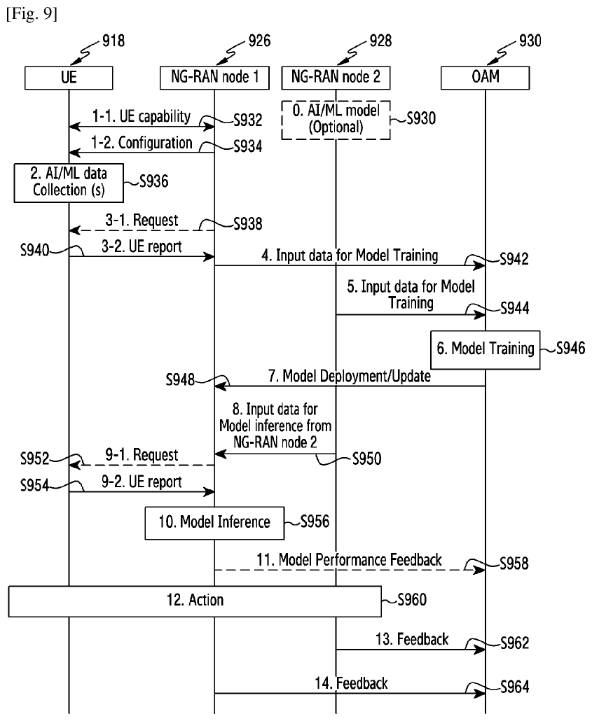

FIG. 9 is a flowchart showing communications between a UE 918 and a network comprising a central server 930 (e.g. an operations, administration and management (OAM) server) and a plurality of nodes, including a first node 926 and a second node 928. In this example, the AI/ML Model training is done at the OAM server 930 and AI/ML Model inference is done at one or more of the nodes. In this solution, the node(s) makes decisions using the AI/ML model for network energy saving, load balancing, mobility optimization and other purposes. For UE configuration, the network can send a RRC message (e.g RRCReconfiguration or RRCSetup or RRCResume or newly defined RRC message) to the UE in order to configure the type of AI/ML configuration, e.g. algorithms or models, the related timers, parameters for measurement (e.g. beam, CSI, SSB, frequency), conditions, or the type of reporting (or collection), and so on.

In a first optional step S930, the second node 928 (NG-RAN node 2) may be provided with (or assumed to have) an AI/ML model, which can provide the first node 926 (NG-RAN node 1) with input information. At step S932 (Step 1-1), the UE capability information can be transferred on request from the UE 918 to the network (specifically the first node 926). This may be done as described above in FIG. 8, for UEs in a CONNECTED state. For example, the network (or specifically the first node 926) broadcasts the system information including the indication of AI/ML functionality support and the UE can report the UE capability as described above. When the network requests UE to report UE capability information by sending UE Capabili-tyEnquiry message, the UE can send UEcapabilityInformation message including the capability of AI/ML functionality support.

Then at step S934 (Step 1-2), the configuration information is sent from the first node 926 to the UE 918, for example as described above. The NG-RAN node 1 configures the AI/ML configuration to the UE (e.g. based on the received capability information) and sends a configuration message (e.g. RRCReconfiguation, RRCSetup, RRCResume, RRCRelease message or a newly defined message) to UE to perform AI/ML functionality (e.g. measurement procedure and reporting). The NG-RAN node 1 can also configures the UE to provide AI/ML data (e.g. measurements and/or location information, RRM measurements, MDT measurements, velocity, position, time information for measurement, measurement duration, sequence number for reordering training data, or CSI (e.g. aperiodic CSI or periodic CSI) or measurement results for frequency (or cell identity or beam or SSB)).

The AI/ML configuration information can include configuring one of the Signal Radio Bearers (SRB, specifically SRB1, SRB2, SRB3, SRB4, or SRBx) to make the UE report the AI/ML data through the SRB to the network by sending an appropriate RRC message. In another embodiment, the AI/ML configuration information can include configuring one of the Data Radio Bearers (DRB), for example with a special logical channel identity or bearder identity, to make UE report the AI/ML data through the DRB to the network by sending an appropriate RRC message. The AI/ML configuration information can include configuring radio resource (e.g. time and frequency resources for PUCCH (Physical Uplink Control Channel) or PUSCH (Physical Uplink Shared Channel) to make the UE report the AI/ML data through the configured resources (e.g. UL grant or SPS (Semi Persistent Scheduling) grant (i.e. radio resource) or Configured grant).

The configuration information for the SRB or the DRB can include the AS security configuration, i.e. whether to perform ciphering (or integrity protection) or not. A lot of the AI/ML data may need to be reported to the network, i.e. frequent reporting may be needed. To reduce the UE's processing burden which results from ciphering or integrity protection, one or both of the ciphering function or integrity protection function may not be configured for the SRB or the DRB. In other words, either ciphering only or integrity protection only or no ciphering and no integrity protection can be configured. In another alternative, the RRC layer can indicate to the PDCP layer whether each RRC message (or piece of AI/ML data) needs to be integrity protected or not as well as whether each RRC message (or AI/ML data) needs to be ciphered or not by using indication. It can be applied to a configured SRB or DRB for AI/ML data. In another alternative, the configured AS security (ciphering or integrity protection) of the SRB (or DRB) for AI/ML data reporting can be activated or deactivated by an RRC message or MAC CE or PDCP control PDU or PDCCH DCI to control UE processing burden.

As an alternative solution to the need for reporting a lot of the AI/ML data, frequent reporting may be avoided by the UE including many pieces of AI/ML data information in a newly proposed message structure of one RRC message (e.g. a measurement reporting message or RRC message for reporting). In other words, the UE can report a lot of AI/ML data with a single message (e.g. RRC message or MAC CE). The proposed message can include a sequence number or a timing information for each piece of AI/ML data to let the receiver sort them in chronological order. The number of pieces of AI/ML data which should be included in the reporting message can be configured by an RRC message (e.g. in AI/ML configuration). The detailed message structure is discussed below.

The configuration information may additionally or alternatively include the prioritization information for AI/ML data. Given that it is very important to send/receive the general RRC messages with low latency and high reliability due to the UE's connection management and mobility support, the AI/ML data may not be urgent, i.e. not time-sensitive. Hence, the prioritization mechanism can be configured and used for prioritize other RRC messages over the reporting message for AI/ML data.

The nature of the SRB, namely SRB1 or SRB2 or SRB3 or SRB4, can be configured and used for the transmission/reception of RRC messages which include AI/ML data. These RRC messages can have lower priority than the first RRC messages because the first RRC messages support the UE's connection management and mobility support and are thus much more important than the RRC messages for AI/ML data. These first RRC messages may include a piggybacked NAS message, NAS messages prior to the establishment of SRB2, the RRC messages for setting up (re-)connection and (re-)configuration, including for example: RRCSetupRequest, RRCSetup, RRCSetupComplete, RRCResumeRequest, RRCResume, RRCResumeComplete, RRCReconfiguration, RRCReconfigurationComplete, RRCReestablishment RRCReestablishmentRequest, etc.) When the first RRC messages and the RRC messages for AI/ML data are generated together or simultaneously (or co-exist in buffer), then the first RRC messages can be prioritized over the RRC messages for AI/ML data and can be submitted to lower layers (e.g. PDCP layer) and sent first.

As an alternative, an SRBx or a DRB can be configured and used only for the transmission/reception of messages which include AI/ML data. As another alternative, for AI/ML data through the configured RB (SRB or DRB), the network can do assignment/modification of semi-persistent scheduling (SPS) configuration and configured grant configuration for DL and UL respectively, assignment/modification of parameters for UL rate control in the UE, i.e. allocation of a priority and a PBR (LCP parameters for LCP procedure in MAC layer) for each RB of UE and logical channel identifier, and assignment of separate SCell configuration or separate BWP (BandWidth Part) configuration, in order to control prioritization between messages including AI/ML data and other messages (or data).

The configuration information may include the configuration for the AI/ML data and the AI/ML configuration (e.g. the features CSI-MeasConfig or MeasConfig specified below).

The network can configure the conditions (e.g. the threshold, explicit indication, timer, etc.) when the UE starts to collect AI/ML data (or perform measurement) by an appropriate RRC message (e.g. RRCReconfiguration or RRCRelease) The conditions can be configured regardless of the state of the UE (RRC CONNECTED). The network can send a RRCReconfiguration message including the configuration conditions detailed below to the UE in RRC CONNECTED state.

As an example, the threshold values can be configured to let the UE know the condition when the UE starts to collect AI/ML data (or perform measurement). The UE starts to collect AI/ML data when the condition is met. For example, if one specific measure is larger (or smaller) than one threshold or/and if another specific measure (e.g.) is larger (or smaller) than another threshold, the UE can consider the condition as met. The specific measures can be RSRP (Reference Signal Received Power) or RSRQ (Reference Signal Received Quality) or SINR (Signal-to-interference-plus-noise ratio) or time, etc. The condition can be generated with one or more than one threshold values based on the configuration. The network can configure a periodicity in which the UE should collect AI/ML data (or perform measurement).

As another example, the network can configure the conditions or type or size to let the UE know which AI/ML data (or how much AI/ML data) should be collected by the RRC message. The network can send an explicit indication to the UE by an appropriate RRC message (e.g. RRCReconfiguration or RRCRelease message) or a MAC CE (Control Element) or a PDCCH (Physical Downlink Control Channel) or a DCI (Downlink Control Information) when to start (or activate) or stop (or deactivate) collecting AI/ML data (or perform measurement) or which measurement object should be measured (e.g. CSI or beam or SSB or frequency or cell identity) or to change the target AI/ML data. When the UE receives the indication by the RRC message, the UE can start or stop to collect AI/ML data meet the conditions configured by the network and store them.

As another example, the network can configure a timer (e.g. T3xx) to the UE by a RRC message (e.g. RRCReconfiguration or RRCRelease message). When the timer is configured, the UE can start the timer and can collect AI/ML data (or perform measurement) while the timer is running. After the expiry of the timer, the UE can stop collecting AI/ML data. An area information can be configured to make the UE collect AI/ML data (i.e. perform measurement) within the configured area. The configure area can be defined with cell identity (i.e. physical cell identity or TAI (Tracking area Information)). When the UE goes out of the area, the UE can stop to collect AI/ML data or can stop the timer.

The network can configure the conditions (e.g. the threshold, explicit indication, timer, etc.) when the UE (in RRC CONNECTED) reports AI/ML data (e.g. reports measurement results) as well as the radio resources (e.g. time/frequency resource) where the UE sends AI/ML data (or reports the measurement results), by an RRC message (e.g. RRCReconfiguration or RRCRelease), The network can send a RRCReconfiguration message including the following configuration to the UE in RRC CONNECTED state.

For example, the network can configure a periodicity in which the UE should report AI/ML data (or report measurement results). The UE can send (or report) AI/ML data to the network through an RRC message or MAC CE or configured grant (i.e. radio resources) for PUCCH or PUSCH, periodically. As another example, upon the reception of an explicit indication from the network, the UE can report AI/ML data (or report measurement results) through an RRC message or MAC CE or configured grant (i.e. time/frequency radio resources) for PUCCH or PUSCH. The network can send the explicit indication to the UE by an RRC message (e.g. RRCReconfiguration or RRCRelease message) or MAC CE (Control Element) or PDCCH (Physical Downlink Control CHannel) or DCI (Downlink Control Information) when or whether or where (e.g. radio resource for reporting) to report AI/ML data (or perform measurement) or which measurement object should be measured (e.g. CSI or beam or SSB or frequency or cell identity) or change of the target AI/ML data.

As another example, the network can configure a timer (e.g. T3xx) to the UE by a RRC message (e.g. RRCReconfiguration or RRCRelease message). When the timer is configured, the UE can start the timer. Whenever the timer expires, the UE can report AI/ML data (or report measurement results) through a RRC message or MAC CE or configured grant (i.e. time/frequency radio resources) for PUCCH or PUSCH. After reporting (or sending AI/ML data), the UE can restart the timer.

As another example, the threshold values can be configured to let the UE know the condition when the UE reports AI/ML data (or performs measurement). The UE reports AI/ML data when the condition is met. For example, if one specific measure is larger (or smaller) than one threshold or/and if another specific measure (e.g.) is larger (or smaller) than another threshold, the UE can consider the condition as met. The specific measures can be RSRP (Reference Signal Received Power) or RSRQ (Reference Signal Received Quality) or SINR (Signal-to-interference-plus-noise ratio) or time, etc. The condition can be generated with one or more than one threshold value based on configuration.

At step S926 (Step 2), as proposed above, the UE collects AI/ML data or the indicated measurement(s) based on the configured conditions or periodically (e.g. for configured radio resource) or upon the reception of an explicit indication or at the expiry of the timer. Examples of the UE measurements are related to RSRP, RSRQ, SINR of serving cell and neighbouring cells. As shown at step S938 (Step 3-1), there is an optional request from the first node to the UE to report the measurements. As proposed above, the UE sends AI/ML data or the measurement report message(s) to NG-RAN node 1 (at step S940-Step 3-2). The network may optionally send a RRC message including the indication for AI/ML data report (e.g. UEInformationRequest messages) and UE can report it by an RRC message (e.g. UEInformationResponse messages. Alternatively, the UE may send based on the configured conditions or periodically (e.g. for configured radio resource) or at the expiry of timer not just upon the reception of explicit indication. In this example, only one UE is shown but it will be appreciated that the first node (NG-RAN) can collect AI/ML data from more UEs or other nodes (NG-RANs).

At step S942 (Step 4), the first node (NG-RAN node 1) sends the AI/ML data or UE measurement reports together with other input data for Model Training to the OAM 930. The AI/ML data can be included in an inter-node message between the NG-RAN node and the OAM. At step S944 (Step 5), the second node (NG-RAN node 2 which is assumed to have an optional AI/ML model) also sends AI/ML data or input data for Model Training to the OAM 930. The NG-RAN node 2 sends AI/ML data or the input data for training to the OAM, where the input data for training includes the required input information from the NG-RAN node 2. If the NG-RAN node 2 executes the AI/ML model, the transmitted AI/ML data or the input data for training can include the corresponding inference result from the NG-RAN node 2. The AI/ML data can be included in an inter-node message between the second node (NG-RAN node 2) and the OAM. In each of steps S942 and S944, the inter-node message can also include in-dication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

At step S946 (Step 6), the Model is trained at the OAM 930. The AI/ML data or required measurements and input data from the other nodes may also be leveraged to train AI/ML models for network energy saving/load balancing/mobility optimization.

At step S948 (Step 7), the OAM 930 deploys or updates the AI/ML model into the NG-RAN node(s)—for simplicity only the deployment to the first node is shown. The or each NG-RAN node can also continue model training based on the received AI/ML model from OAM. The OAM 930 may send an AI/ML Model Deployment Message to deploy the trained/updated AI/ML model into the NG-RAN node(s). Alternatively, the AI/ML model or update parameters can be included in an inter-node message between the or each NG-RAN node and the OAM. The inter-node message can also include in-dication(s) to indicate whether this is for Model Deployment or Model Update. The inter-node message can be newly-defined for this purpose. In another embodiment, a legacy inter-node message can be used for this purpose by introducing a new container for the AI/ML model and the new indications/parameters in the message.

At step S950 (Step 8), the second node (NG-RAN node 2) sends AI/ML data or the required input data to the first node (NG-RAN node 1) for model inference. The NG-RAN node 1 receives from the neighbouring NG-RAN node 2 AI/ML data or the input information for model inference. The AI/ML data can be included in a inter-node message between NG-RAN nodes. The inter-node message can also include in-dication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

As shown at step S952 (Step 9-1), there is an optional request from the first node to the UE to report the measurements. As proposed above, the UE sends AI/ML data or the measurement report message(s) to NG-RAN node 1 (at step S954-Step 392). The same procedure can be followed as explained in relation to steps S938 and S940.

At step S956 (Step 10), NG-RAN node 1 generates model inference output(s) (e.g., energy saving strategy, load balancing, handover strategy, mobility optimization etc). The inference may be based on the AI/ML data and/or local inputs of the first node (NG-RAN node 1 as well as any received AI/ML data or inputs from the second node (NG-RAN node 2). The first node (NG-RAN node 1) performs model inference and generates predictions or decisions. The AI/ML data or required measurements are leveraged into the Model Inference to output the prediction, e.g., the UE trajectory prediction, target cell prediction, target NG-RAN node prediction, etc.

At step S958 (Step 11), there is an option step in which the first node (NG-RAN node 1) sends Model Performance Feedback to the OAM if applicable. The AI/ML data can be included in an inter-node message between the NG-RAN node and the OAM. The inter-node message can also include indication(s) as to whether the AI/ML data is for Model training or Model inference or Model performance feedback or Model Deployment or Update. The inter-node message can be newly-defined for this purpose. In another embodiment, a legacy inter-node message can be used for this purpose by introducing a new container for AI/ML data and new indications/parameters in the message.

At step S960 (Step 12) which although shown sequentially after the preceding step, may be simultaneous, the first node (NG-RAN node 1) executes any actions, e.g. Network energy saving actions or Load Balancing actions or Mobility Optimization and/or handover procedure according to the model inference output. If the output is handover strategy, NG-RAN node 1 may select the most appropriate target cell (e.g. another node) for each UE before it performs handover. NG-RAN node 1 may take Load Balancing actions, for example the UE may be moved from its current node (NG-RAN node 1) to a different node (e.g. NG-RAN node 2). According to the prediction, recommended actions or configuration, the NG-RAN node 1, the target NG-RAN node (represented by NG-RAN node 2 of this step in the flowchart), and the UE perform the Mobility Optimization and/or handover procedure to hand over the UE from NG-RAN node 1 to the target NG-RAN node. The AI/ML data (e.g. actions) can be included in an inter-node message between NG-RAN nodes (e.g. between NG-RAN node 1 and NG-RAN node 2). The inter-node message can also include indication(s) as to whether the AI/ML data is for transferring actions or decision. The inter-node message can be newly-defined for this purpose. In another embodiment, a legacy inter-node message can be used for this purpose by introducing a new container for AI/ML data and new indications/parameters in the message.

At step S962 (Step 13), the target node (e.g. NG-RAN node 2) can provide feedback to the OAM. Similarly, at step S964 (Step 14), the first node (NG-RAN node 1) can provide feedback to the OAM. In both cases, the AI/ML data (e.g. feedback) can be included in an inter-node message between NG-RAN nodes (e.g. between NG-RAN node 1 and NG-RAN node 2). The inter-node message can also include indication(s) whether the AI/ML data is for Model training or Model inference or Model performance feedback or Model Deployment or Update. The inter-node message can be newly-defined for this purpose. In another embodiment, a legacy inter-node message can be used for this purpose by introducing a new container for the AI/ML data and the new indications/parameters in the message.

AI/ML Model Training at First Node and AI/ML Model inference at Same or Different Node

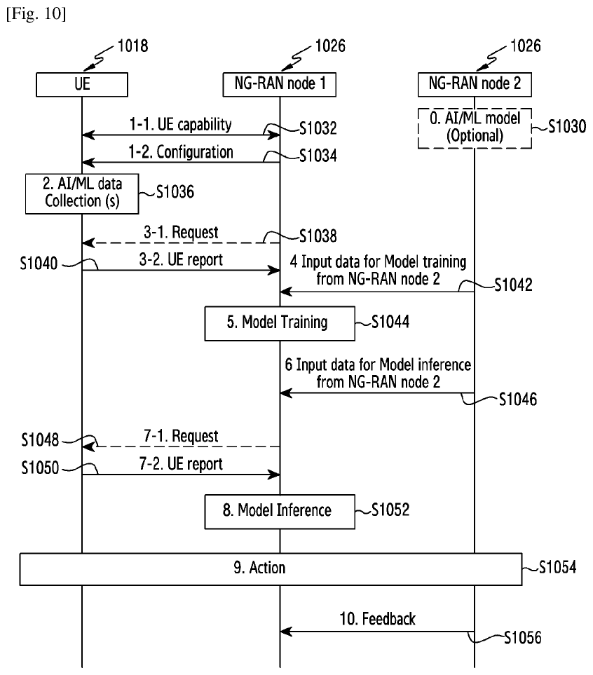

FIG. 10 is a flowchart showing communications between a UE 1018 and a plurality of nodes, including a first node 1026 and a second node 1028. In this example, the AI/ML Model training is done at the first node 1026 and AI/ML Model inference is done at one or more of the nodes. In this solution, the node(s) makes decisions using the AI/ML model for network energy saving, load balancing, mobility optimization and other purposes. For UE configuration, the network can send a RRC message (e.g RRCReconfiguration or RRCSetup or RRCResume or newly defined RRC message) to the UE in order to configure the type of AI/ML configuration, e.g. algorithms or models, the related timers, parameters for measurement (e.g. beam, CSI, SSB, frequency), conditions, or the type of reporting (or collection), and so on.

In a first optional step S1030, the second node 1028 (NG-RAN node 2) may be provided with (or assumed to have) an AI/ML model, which can provide the first node 1026 (NG-RAN node 1) with input information. At step S1032 (Step 1-1), the UE capability information can be transferred on request from the UE 1018 to the network (specifically the first node 1026). This may be done as described above in FIG. 8, for UEs in a CONNECTED state. For example, the network (or specifically the first node 1026) broadcasts the system information including the indication of AI/ML functionality support and the UE can report the UE capability as described above. When the network requests UE to report UE capability information by sending UE Capabili-tyEnquiry message, the UE can send UEcapabilityInformation message including the capability of AI/ML functionality support.

Then at step S1034 (Step 1-2), the configuration information is sent from the first node 1026 to the UE 1018, for example as described above. The NG-RAN node 1 configures the AI/ML configuration to the UE (e.g. based on the received capability information) and sends a configuration message (e.g. RRCReconfiguation, RRCSetup, RRCResume, RRCRelease message or a newly defined message) to UE to perform AI/ML functionality (e.g. measurement procedure and reporting). The NG-RAN node 1 can also configure the UE to provide AI/ML data (e.g. measurements and/or location information, RRM measurements, MDT measurements, velocity, position, time information for measurement, measurement duration, sequence number for reordering training data, or CSI (e.g. aperiodic CSI or periodic CSI) or measurement results for frequency (or cell identity or beam or SSB)). The details of the AI/ML configuration may be the same as described in relation to FIG. 9.

At step S1026 (Step 2), as proposed above, the UE collects AI/ML data or the indicated measurement(s) based on the configured conditions or periodically (e.g. for configured radio resource) or upon the reception of an explicit indication or at the expiry of the timer. Examples of the UE measurements are related to RSRP, RSRQ, SINR of serving cell and neighbouring cells. As shown at step S1038 (Step 3-1), there is an optional request from the first node to the UE to report the measurements. As proposed above, the UE sends AI/ML data or the measurement report message(s) to NG-RAN node 1 (at step S1040-Step 3-2). The network may optionally send a RRC message including the indication for AI/ML data report (e.g. UEInformationRequest messages) and UE can report it by an RRC message (e.g. UEInformationResponse messages. Alternatively, the UE may send based on the configured conditions or periodically (e.g. for configured radio resource) or at the expiry of timer not just upon the reception of explicit indication. In this example, only one UE is shown but it will be appreciated that the first node (NG-RAN) can collect AI/ML data from more UEs or other nodes (NG-RANs). When the UE stays in RRC CONNECTED state, the UE can perform AI/ML data collection and reporting based on the configuration or specific request.

At step S1042 (Step 4), the second node (NG-RAN node 2) sends the AI/ML data or UE measurement reports together with other input data for Model Training to the first node (NG-RAN node 1). If the NG-RAN node 2 executes the AI/ML model, the transmitted AI/ML data or the input data for training can include the corresponding inference result from the NG-RAN node 2. The AI/ML data can be included in an inter-node message between the nodes. The inter-node message can also include in-dication(s) whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

At step S1044 (Step 5), the Model is trained at the first node (NG-RAN node 1) for the configured purpose based on the collected data. The AI/ML data or required measurements and input data from the other nodes may also be leveraged to train AI/ML models for network energy saving/load balancing/mobility optimization.

At step S1046 (Step 6), the second node (NG-RAN node 2) sends AI/ML data (e.g. the required input data) to the first node (NG-RAN node 1) for model inference. The NG-RAN node 1 receives, from the neighbouring NG-RAN node 2, AI/ML data (e.g. the UE measurements and/or location information) for model inference. The AI/ML data can be included in an inter-node message between NG-RAN nodes. The inter-node message can also include indication(s) as to whether the AI/ML data is for Model training or Model inference or Model performance feedback or Model Deployment or Update. The inter-node message can be newly-defined for this purpose. In another embodiment, the legacy inter-node message can be used for this purpose by introducing a new container for AI/ML data and new indications/parameters in the message.

As shown at step S1048 (Step 7), there is an optional request from the first node to the UE to report the measurements. As proposed above, the UE sends AI/ML data or the measurement report message(s) to NG-RAN node 1 (at step S1050-Step 7-2). The same procedure can be followed as explained in relation to steps S1038 and S1040.

At step S1052 (Step 8), NG-RAN node 1 generates model inference output(s) (e.g., energy saving strategy, load balancing, handover strategy, mobility optimization etc). The inference may be based on the AI/ML data and/or local inputs of the first node (NG-RAN node 1 as well as any received AI/ML data or inputs from the second node (NG-RAN node 2). The first node (NG-RAN node 1) performs model inference and generates predictions or decisions. The AI/ML data or required measurements are leveraged into the Model Inference to output the prediction, e.g., the UE trajectory prediction, target cell prediction, target NG-RAN node prediction, etc.

At step S1054 (Step 9), the first node (NG-RAN node 1) executes any actions, e.g. Network energy saving actions or Load Balancing actions or Mobility Optimization and/or handover procedure according to the model inference output. If the output is handover strategy, NG-RAN node 1 may select the most appropriate target cell (e.g. another node) for each UE before it performs handover. NG-RAN node 1 may take Load Balancing actions, for example the UE may be moved from its current node (NG-RAN node 1) to a different node (e.g. NG-RAN node 2). According to the prediction, recommended actions or configuration, the NG-RAN node 1, the target NG-RAN node (represented by NG-RAN node 2 of this step in the flowchart), and the UE perform the Mobility Optimization and/or handover procedure to hand over the UE from NG-RAN node 1 to the target NG-RAN node. The AI/ML data (e.g. actions) can be included in an inter-node message between NG-RAN nodes (e.g. between NG-RAN node 1 and NG-RAN node 2). The inter-node message can also include indication(s) as to whether the AI/ML data is for transferring actions or decision. The inter-node message can be newly-defined for this purpose. In another embodiment, a legacy inter-node message can be used for this purpose by introducing a new container for AI/ML data and new indications/parameters in the message.

At step S1056 (Step 10), the target node (e.g. NG-RAN node 2) can provide feedback to the first node (NG-RAN node 1). The AI/ML data (e.g. feedback) can be included in an inter-node message between NG-RAN nodes (e.g. between NG-RAN node 1 and NG-RAN node 2). The inter-node message can also include indication(s) whether the AI/ML data is for Model training or Model inference or Model performance feedback or Model Deployment or Update. The inter-node message can be newly-defined for this purpose. In another embodiment, a legacy inter-node message can be used for this purpose by introducing a new container for the AI/ML data and the new indications/parameters in the message.

### Other Examples

In the arrangement of FIG. 9, model training takes place in the central server 930 and model inference takes place in a node 926. In the arrangement of FIG. 10, model training and model inference both takes place in a node 1026. It will be appreciated that other arrangements are also possible. For example, model training and model inference may both take place in the UE. In this scenario, the UE is configured with the AI/ML model (or AI/ML model functions (e.g. training and inference) by appropriate RRC message or newly defined messages. Such an arrangement may be used for federated learning or split-learning. As another example, model training takes place in the UE and model inference takes place either in a node or at the central server. As another example, model training takes place either in a node or at the central server and model inference takes place in the UE.

In any of the arrangements, the UE is configured as needed to collect the AI/ML data and/or or receive the AI/ML data from the network (e.g. from a node (NG-RAN) or the central server (OAM)). Based on the received/collected AI/ML data, the UE can train (or update) AI/ML Model and/or generate model inference outputs or take actions. The UE can also send the trained AI/ML model or inference outputs or updated parameters to the network (e.g. a node (NG-RAN) or the central server (OAM)). For this delivery, the AI/ML model or update parameters or the AI/ML data can be included in an RRC message (or NAS message) between the NG-RAN node (or OAM) and the UE. The inter-node message can also include indication(s) as to whether this is for Model training or Model inference (or inference outputs) or Model performance feedback or Model Deployment or Update. The RRC message (or NAS (Non-Access Startum) message) can be newly-defined for this purpose. In another embodiment, a legacy RRC message (or NAS message) can be used for this purpose by introducing a new container for AI/ML model and new indications/parameters in the message. In other words, the inter-node message can indicate Xn messages (i.e. messages via an Xn interface between gNBs) or NAS messages or RRC messages.

### Inputs, Outputs and Feedback

As mentioned in the examples above, there are various inputs which are needed at the inference stage by the UE, the node and/or the central server which has the updated model. Similarly, there may be more than one output from the inference stage. The inputs and outputs will depend on the nature of the model, for example whether the model is for network energy saving, load balancing or mobility optimisation. The examples also mention that feedback may be provided by different parts of the network and details of the type of feedback are provided below.

For example, when the model is predicting the optimized network energy saving decisions, the node (NG-RAN), central server or the UE which holds the model may need the following information as input data for AI/ML-based network energy saving. The model may use inputs from the local node (namely, any node within the network which is associated with the UE and is not the central server) and these inputs may include some or all of: the UE mobility/trajectory prediction, the current and/or predicted energy efficiency and/or the current and/or predicted resource status. The model may use inputs from the UE and these inputs may include the UE location information (e.g., coordinates, serving cell ID, moving velocity) and a UE measurement report (e.g., UE RSRP, RSRQ, SINR measurement, etc). The UE location information may be interpreted by the gNB implementation when available. The UE measurement report may include cell level and beam level UE measurements. The model may use inputs from neighbouring nodes and these inputs may include the current and/or predicted energy efficiency, the current and/or predicted resource status and/or the current energy state (e.g. active, high, low, inactive). If existing UE measurements are needed by a model (e.g. at the gNB) for AI/ML-based network energy saving, RAN3 shall reuse the existing framework (including MDT and RRM measurements).

The outputs generated from the AI/ML-based network energy saving model can include: an energy saving strategy, such as recommended cell activation/deactivation, a handover strategy, including recommended candidate cells for taking over the traffic, predicted energy efficiency, predicted energy state (e.g., active, high, low, inactive) and/or a model output validity time. To optimize the performance of the AI/ML-based network energy saving model, feedback can be collected from the NG-RAN nodes, including the resource status of the neighbouring NG-RAN nodes, energy efficiency, the UE performance affected by the energy saving action (e.g., handed-over UEs), including bitrate, packet loss, latency and system KPIs (e.g., throughput, delay, RLF of current and neighbouring NG-RAN node).

As another example, when the model is used for load balancing decisions, the node (NG-RAN), central server or the UE which holds the model may need the following information as input data for AI/ML-based network energy saving. The model may use inputs from the local node and these inputs may include the UE mobility/trajectory prediction and the current and/or predicted resource status as in the previous example. The model may also use the current and predicted UE traffic and the predicted resource status information of neighbouring NG-RAN node(s) from the local node. The model may use inputs from the UE and these inputs may include the UE location information (e.g., coordinates, serving cell ID, moving velocity) and a UE measurement report (e.g., UE RSRP, RSRQ, SINR measurement, etc) as in the previous example. The model may also use the following inputs from the UE: the UE mobility history Information. The model may use inputs from neighbouring nodes and these inputs may include the current and/or predicted resource status as in the previous example. The model may also use a UE performance measurement at the traffic offloaded neighbouring cell.

The outputs generated from the AI/ML-based load balancing model can include some or all of: selection of target cell for load balancing, predicted own resource status information, predicted resource status information of neighbouring NG-RAN node(s), model output validity time and the predicted UE(s) selected to be handed over to target NG-RAN node (will be used by RAN node internally). To optimize the performance of the AI/ML-based load balancing model, feedback can be collected from the NG-RAN nodes, including some or all of the UE performance information from the target NG-RAN (for those UEs handed over from the source NG-RAN node), resource status information updates from the target NG-RAN, and system KPIs (e.g., throughput, delay, RLF of current and neighbours).

As another example, when the model is used for mobility optimization, the node (NG-RAN), central server or the UE which holds the model may need the following information as input data for AI/ML-based network energy saving. The model may use inputs from the local node and these inputs may include the UE mobility/trajectory prediction, the current and/or predicted resource status and predicted UE traffic as in the previous example. The model may use inputs from the UE and these inputs may include the UE location information (e.g., coordinates, serving cell ID, moving velocity) and the UE mobility history Information as in the previous example. The model may also use the following inputs from the UE: radio measurements related to serving cell and neighbouring cells associated with UE location information, e.g., RSRP, RSRQ, SINR. The model may use inputs from neighbouring nodes and these inputs may include the current and/or predicted resource status as in the previous example. The model may also use the UE's history information from neighbour, position, QoS parameters and the performance information of historical UEs which have been handed over (e.g., loss rate, delay, etc.), and UE handovers in the past that were successful and unsuccessful, including too-early, too-late, or handover to wrong (sub-optimal) cell, based on existing SON/RLF report mechanism.

The outputs generated from the AI/ML-based mobility optimization model can include some or all of: UE trajectory prediction (Latitude, longitude, altitude, cell ID of UE over a future period of time), estimated arrival probability in CHO and relevant confidence interval, predicted handover target node, candidate cells in CHO, priority, handover execution timing, predicted resource reservation time window for CHO, UE traffic prediction and model output validity time. The predicted handover target node may be output together with the confidence of the predication. It is also noted that whether the UE trajectory prediction is an external output to the node hosting the Model Inference function should be discussed during the normative work phase. The UE traffic prediction will be used by the RAN node internally and the details are left to normative work phase. To optimize the performance of the AI/ML-based mobility optimization model, feedback can be collected from the NG-RAN nodes, including some or all of QoS parameters such as throughput, packet delay of the handed-over UE, etc.; resource status information updates from target NG-RAN; and performance information from target NG-RAN.

### Measurements

The measurements include (or indicate) the collection of AI/ML data, the measurement configuration includes (or indicates) AI/ML configuration, the measurement results include (or indicate) AI/ML data, the events for measurement triggering include (or indicate) the events for AI/ML collection, and the measurement reporting includes (or indicates) AI/ML data reporting.

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signalling i.e. using the appropriate RRC message, e.g a RRCReconfiguration or RRCResume message.

The network may configure the UE to perform some or all of the following types of measurements: NR measurements; Inter-RAT measurements of E-UTRA frequencies; Inter-RAT measurements of UTRA-FDD frequencies; and NR sidelink measurements of L2 U2N Relay UEs.

The network may configure the UE to report some or all of the following measurement information based on SS/PBCH block(s): Measurement results per SS/PBCH block; Measurement results per cell based on SS/PBCH block(s); and SS/PBCH block(s) indexes. The network may configure the UE to report some or all of the following measurement information based on CSI-RS resources: Measurement results per CSI-RS resource; Measurement results per cell based on CSI-RS resource(s); and CSI-RS resource measurement identifiers.

The network may configure the UE to perform the following types of measurements for NR sidelink and V2X sidelink: CBR measurements. The network may configure the UE to report the following CLI measurement information based on SRS resources: Measurement results per SRS resource; and SRS resource(s) indexes. The network may configure the UE to report the following CLI measurement information based on CLI-RSSI resources: Measurement results per CLI-RSSI resource; and CLI-RSSI resource(s) indexes. The network may configure the UE to report the following Rx-Tx time difference measurement information based on CSI-RS for tracking or PRS: UE Rx-Tx time difference measurement result.

The measurement configuration includes some or all of the following parameters: measurement objects, reporting configurations, measurement identities, quantity configurations and measurement gaps which are described in more detail below.

The measurement objects (MOs) are a list of objects on which the UE shall perform the measurements. For intra-frequency and inter-frequency measurements, a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting. The measObjectId of the measurement object which corresponds to each serving cell is indicated by servingCellMO within the serving cell configuration.

For inter-RAT E-UTRA measurements, a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting. For inter-RAT UTRA-FDD measurements, a measurement object is a set of cells on a single UTRA-FDD carrier frequency. For NR sidelink measurements of L2 U2N Relay UEs, a measurement object is a single NR sidelink frequency to be measured. For CBR measurement of NR sidelink communication, a measurement object is a set of transmission resource pool(s) on a single carrier frequency for NR sidelink communication. For CBR measurement of NR sidelink discovery, a measurement object is a set of discovery dedicated resource pool(s) or transmission resource pool(s) also used for NR sidelink discovery on a single carrier frequency for NR sidelink discovery. For CLI measurements a measurement object indicates the frequency/time location of SRS resources and/or CLI-RSSI resources, and subcarrier spacing of SRS resources to be measured.

The reporting configurations is a list of reporting configurations where there can be one or multiple reporting configurations per measurement object. Each measurement reporting configuration includes some or all of the following information. The configuration may include a reporting criterion which is the criterion that triggers the UE to send a measurement report. This can either be periodical or a single event description. The configuration may include an RS type to indicate the RS that the UE uses for beam and cell measurement results (SS/PBCH block or CSI-RS). The configuration may include a reporting format, e.g. the quantities per cell and per beam that the UE includes in the measurement report (e.g. RSRP) and other associated information such as the maximum number of cells and the maximum number beams per cell to report.

In case of conditional reconfiguration, includes some or all of the following information. The configuration may include an execution criteria which is the criteria the UE uses for conditional reconfiguration execution. The configuration may include an RS type to indicate the RS that the UE uses for obtaining beam and cell measurement results (SS/PBCH block-based or CSI-RS-based), used for evaluating conditional re-configuration execution condition.

For measurement reporting, there may be a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. Up to two measurement identities can be linked to one conditional reconfiguration execution condition.

The quantity configuration defines the measurement filtering configuration used for all event evaluation and related reporting, and for periodical reporting of that measurement. For NR measurements, the network may configure up to two quantity configurations with a reference in the NR measurement object to the configuration that is to be used. In each configuration, different filter coefficients can be configured for different measurement quantities, for different RS types, and for measurements per cell and per beam.

The measurement gaps are the periods that the UE may use to perform measurements.

A UE in an RRC_CONNECTED state maintains a measurement object list, a reporting configuration list, and a measurement identities list according to signalling and procedures in this specification. The measurement object list possibly includes NR measurement object(s), CLI measurement object(s), inter-RAT objects, and L2 U2N Relay objects. Similarly, the reporting configuration list includes NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells: The NR serving cell(s), the listed cells and the detected cells. The NR serving cell(s) are the SpCell and one or more SCells. The listed cells are cells listed within the measurement object(s). The detected cells are cells that are not listed within the measurement object(s) but are detected by the UE on the SSB frequency(ies) and subcarrier spacing(s) indicated by the measurement object(s).

For NR measurement object(s), the UE measures and reports on the serving cell(s)/serving Relay UE (for L2 U2N Remote UE), listed cells and/or detected cells. For inter-RAT measurements object(s) of E-UTRA, the UE measures and reports on listed cells and detected cells and, for RSSI and channel occupancy measurements, the UE measures and reports on the configured resources on the indicated frequency. For inter-RAT measurements object(s) of UTRA-FDD, the UE measures and reports on listed cells. For CLI measurement object(s), the UE measures and reports on configured measurement resources (i.e. SRS resources and/or CLI-RSSI resources). For L2 U2N Relay object(s), the UE measures and reports on the serving NR cell(s), as well as the discovered L2 U2N Relay UEs.

### RRC Message Structure

As described above, there is a lot of AI/ML data which needs to be reported to the network. One solution mentioned above to avoid frequent reporting is to create a messaging structure which allows the UE to include many pieces of AI/ML data information in one RRC message (e.g. a measurement reporting message or an RRC message for reporting). The proposed message can include a sequence number or a timing information for each piece of AI/ML data to let the receiver sort them in chronological order. The number of pieces of AI/ML data which should be included in the reporting message can be configured by the RRC message (e.g. in AI/ML configuration). The detailed message structure is described below.

An RRC message may contain one or more of the following information elements: MeasConfig, ReportConfigNR, MeasResults, CSI-MeasConfig, CSI-ReportConfig, and MeasurementReport. These provide the configuration information for measurement. For the AI/ML implementation, the message structure and the parameters can be extended to configure AI/ML configuration: MeasConfigAIML, ReportConfigNRAIML, MeasResultsAIML, CSI-MeasConfigAIML, CSI-ReportConfigAIML, MeasurementReportAIML. For example, hereafter, MeasConfig, ReportConfigNR, MeasResults, CSI-MeasConfig, CSI-ReportConfig and MeasurementReport can be regarded as MeasConfigAIML, ReportConfigNRAIML, MeasResultsAIML, CSI-MeasConfigAIML, CSI-ReportConfigAIML and MeasurementReportAIML when the network configures AI/ML configuration to UE (or the network entity).

Whenever the proposed procedure refers to a field it concerns a field included in the VarMeasConfig unless explicitly stated otherwise i.e. only the measurement configuration procedure covers the direct UE action related to the received measConfig.

Taking some of these key information elements in turn: the message structure may include a measurement configuration information element (MeasConfig) which specifies measurements to be performed by the UE. This information element may include fields which cover intra-frequency, inter-frequency and inter-RAT mobility as well as configuration of measurement gaps. For example, when the field “interFrequencyConfig-NoGap-r16” is set to true, the UE may be configured to perform SSB based inter-frequency measurement without measurement gaps when the inter-frequency SSB is completely contained within the active DL BWP of the UE. There may also be fields within the information element which are lists of measurement identities to remove, add and/or modify (e.g. MeasIdToAddModList and MeasIdToRemoveList). There may also be fields within the information element which are lists of measurement objects to remove, add and/or modify (e.g. MeasOb-jectToAddModList and MeasObjectToRemoveList). There may also be fields within the information element which are lists of measurement reporting configurations to remove, add and/or modify (e.g. ReportConfigToAddModList and ReportConfigToRe-moveList). There may also be one or one thresholds, for example a threshold to control when the UE is required to perform measurements on non-serving cells. The fields may also be termed information elements.

The message structure may include a measurement configuration identity information element to identify a measurement configuration (Measld), i.e., linking of a measurement object and a reporting configuration. The MeasID in the MeasConfig information element indicates the type of measurement or an identifier for separate measurement. When the network configures AI/ML configuration to the UE (or the network entity), the measID in MeasConfigAIML can indicate the type of AI/ML data to be collected (e.g. can be used for AI/ML data identifier to configure AI/ML configuration for multiple type of AI/ML data) or the AI/ML model (e.g. can be used for AI/ML model identifier to configure AI/ML configuration for multiple AI/ML models) or the same information for measurement.

The MeasConfig information element includes fields which are lists of measurement objects to remove, add and/or modify The MeasObject information element in the MeasConfig information element includes the detailed information (e.g. time/frequency radio resource) for the target frequency. The MeasObjectID can be used to indicate each measurement object MeasObject. When the network configures AI/ML configuration to the UE (or the network entity), the measurement object information element measObject in the configuration information element MeasConfigAIML can indicate the AI/ML model (e.g. can be used for the AI/ML model identifier to configure AI/ML configuration for multiple AI/ML models) or the same information for measurement. Similarly, there may be an information element (MeasObjectIDAIML) which can be used to indicate each measure object in the AI/ML configuration (MeasObjectAIML). The MeasObject information element may also include fields to indicate the individual offsets applicable to a specific cell (celllndividualOffset) and a cell identity for a cell in the cell list (physCellld).

The MeasurementReport message can include the measured results (MeasResults) for an identified measurement configuration (measID). When AI/ML configuration is configured, the MeasurementReportAIML can includes the AI/ML data for a measIDAIML. The MeasurementReport message is used for the indication of measurement results. The signalling radio bearer may be SRB1 and/or SRB3 and the data radio bearer DRB may be used (if configured). The RLC-SAP may be AM, the logical channel may be DCCH and the direction of the message is from the UE to the Network.

The measured results information element (MeasResults) includes the detailed information to be reported (e.g. Physical Cell identity, cell list, frequency list, beam, beam list, RSRP, RSRQ, SINR, etc) for each identified measurement configuration (measID). The measured results information element (MeasResults) may cover measured results for intra-frequency, inter-frequency, inter-RAT mobility and measured results for NR sidelink communication/discovery. When the network configures AI/ML configuration to UE (or the network entity), the MeasResultsAIML includes the set of AI/ML data, the type of AI/ML data, the number of AI/ML data, time information, sequence number, and so on for each identified measurement configuration which includes AI/ML (measIDAIML). The MeasResultsAIML can include the same information for measurement as the measured results information element (MeasResults).

For AI/ML data, the sequence number or time information can be included to report multiple data for the same target (e.g. configured MeasObject as described above, AI/ML data or AI/ML model) in chronological sequence (i.e. time sequence). For example, Option 1 is to introduce a sequence number (or time information) for each measurement result and include it. Option 2 is to introduce a list with a sequence number (or time information), i.e. each measurement quantity of a measurement result can include the sequence number (or time information). Both these options are shown in the code in the detailed section below. In another embodiment, a rule can be defined, which does not need a sequence number (or time information) for each result (or quantity), e.g. the first result in the report message is the first one in time sequence and the second result is the second one. The rule can be also defined in the opposite way, i.e. the first result in the report message is the most recent one in time sequence and the second result is the second most recent one. The rule can be defined in various way to report multiple data for the same target.

The field descriptions for the measured results information element (MeasResults) includes some or all of the following fields: a field which indicates the coarse location information (coarseLocationInfo) which is reported by the UE, a field which indicates the ratio of packets which exceed the configured delay threshold (excessDelay), and a field for the measured results of measured cells with reference signals indicated in the serving cell measurements objects (measResultServingMOList). These measured results may include measurement results of SpCell, configured SCell(s) and best neighbouring cell within measured cells with reference signals indicated in on each serving cell measurement object. The measured results may include SFTD measurements (namely the timing difference between the PCell of the LTE network and the PSCell of the 5G NR network) such as measResultSFTD-EUTRA and measRe-sultSFTD-NR. There may also be sidelink measurements, e.g. measResultsSL, sl-MeasResultsCandRelay and sl-MeasResultsServingRelay.

The field descriptions for the measured results information element (MeasResults) includes some or all of the following fields which are dependent on the type of network: a measured result of an UTRA-FDD cell (measResultUTRA-FDD), a physical cell identity of the E-UTRA cell or UTRA-FDD cell for which reporting is being performed (measResultUTRA-FDD or physcellID). There may also be field descriptions for the measured results relating to the NR (new radio) network.

Measurements may also be performed in the states RRC_IDLE and RRC_INACTIVE. These measurements may be described by the information element (MeasResultIdleNR) which in this case covers the NR (new radio) network. The field descriptions may include a field to indicate the NR carrier frequency (carrierFreq), idle/inactive measurement results for an NR cell (measIdleResultNR), measured results of the serving cell (measResultServingCell), a list of idle/inactive measured results for the maximum number of reported best cells for a given NR carrier (measResultsPerCellListIdleNR) and/or beam level measurements (resultsSSB-Indexes).

There is also an information element (ReportConfigNR) which includes the detailed information for reporting (e.g. which type of results should be reported or periodicity or time/frequency resources or when to trigger a reporting, i.e. events, etc). There is an identifying information element (ReportConfigID) which can be used to indicate each reporting information element ReportConfigNR. When the network configures AI/ML configuration to UE (or the network entity), the reporting information element may be labelled ReportConfigNRAIML and may include the detailed information for reporting (e.g. which type of results should be reported or periodicity or time/frequency resources or when to trigger a reporting, i.e. events, etc). There is also an identifying information element ReportConfigIDAIML which can be used to indicate each AIL/ML reporting configuration ReportConfigNRATML.

The reporting information element ReportConfigNR specifies criteria for triggering one or more of an NR measurement reporting event, a CHO (conditional handover), Conditional PSCell Addition (CPA) or, Conditional PSCell Change (CPC) event or an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS. The table below gives some examples of events which can trigger reporting:

| Event | Description |
|---|---|
| Event A1 | Serving becomes better than absolute threshold |
| Event A2 | Serving becomes worse than absolute threshold |
| Event A3 | Neighbour becomes amount of offset better than PCell/PSCell |
| Event A4 | Neighbour becomes better than absolute threshold |
| Event A5 | PCell/PSCell becomes worse than absolute threshold1 AND Neighbour/SCell |
| | becomes better than another absolute threshold2 |
| Event A6 | Neighbour becomes amount of offset better than SCell |
| Event D1 | Distance between UE and a reference location referenceLocation1 becomes |
| | larger than configured threshold distanceThreshFromReference1 and |
| | distance between UE and a reference location referenceLocation2 becomes |
| | shorter than configured threshold distanceThreshFromReference2 |
| CondEvent | Conditional reconfiguration candidate becomes amount of offset better than |
| A3 | PCell/PSCell |
| CondEvent | Conditional reconfiguration candidate becomes better than absolute |
| A4 | threshold |
| CondEvent | PCell/PSCell becomes worse than absolute threshold1 AND Conditional |
| A5 | reconfiguration candidate becomes better than another absolute threshold2 |
| CondEvent | Distance between UE and a reference location referenceLocation1 becomes |
| D1 | larger than configured threshold distanceThreshFromReference1 and |
| | distance between UE and a reference location referenceLocation2 of |
| | conditional reconfiguration candidate becomes shorter than configured |
| | threshold distanceThreshFromReference2 |
| CondEvent | Time measured at UE becomes more than configured threshold t1- |
| T1 | Threshold but is less than t1-Threshold + duration |
| Event X1 | Serving L2 U2N Relay UE becomes worse than absolute threshold1 AND |
| | NR Cell becomes better than another absolute threshold2 |
| Event X2 | Serving L2 U2N Relay UE becomes worse than absolute threshold |
| Event I1 | Interference becomes higher than absolute threshold (measurement |
| | reporting event is based on CLI measurement results, which can either be |
| | derived based on SRS-RSRP or CLI-RSSI) |

The reporting may thus be conditional and there may be field descriptions for offset or threshold values, including for example an offset value (a3-offset) to be used to trigger event A3, and or a threshold value associated to the selected trigger quantity per RS type for triggering event A4 or A5 (a4-Threshold and a5-Threshold).

The message structure may also include an information element which concerns a list of reporting configurations to add or modify (ReportConfigToAddModList). The message structure may also include an information element which is used to configure (add or modify) the UE with a serving cell (ServingCellConfig). The serving cell may be the SpCell or an SCell of an MCG or SCG. The parameters herein are mostly UE specific but partly also cell specific (e.g. in additionally configured bandwidth parts). Reconfiguration between a PUCCH and PUCCHless SCell is only supported using an SCell release and add.

The message structure may also include an information element (CSI-MeasConfig) which is used to configure CSI-RS (channel state information reference signals) belonging to the serving cell in which CSI-MeasConfig is included. On the serving cell in which this information element (CSI-MeasConfig) is included, the information element may also be used to configure channel state information reports to be transmitted on PUCCH and channel state information reports on PUSCH which are triggered by DCI received on the serving cell. There are various field descriptions for this information element including a list of trigger states for dynamically selecting one or more aperiodic and semi-persistent reporting configurations (aperiodicTriggerStateList). There are also various lists to add or modify elements, including CSI-IM-Resources, CSI reporting settings, CSI resource settings, CSI-SSB resources and CSI-RS-Resources.

The message structure may also include an information element (CSI-ReportConfig) which is used to configure a periodic or semi-persistent report sent on PUCCH on the cell in which the information element CSI-ReportConfig is included. Alternatively, the information element may be used to configure a semi-persistent or aperiodic report sent on PUSCH triggered by DCI received on the cell in which the CSI-ReportConfig is included. In this case, the cell on which the report is sent is determined by the received DCI.

The identifier for the measurement configuration (measID), the identifier for the measurement objects (measObjectID), and the identifier for the reporting configuration (ReportConfigID) may be mapped in the identifier for the measurement configurations to be added or modified (MeasIdToAddMod). In this way, the measurement target, how to perform measurement for the target, how to report the results, which results should be reported and so on can be defined. Similarly, the identifier for the AI/ML measurement configuration (measIDAIML), the identifier for the AI/ML measurement objects (measObjectIDAIML), and the identifier for the AI/ML reporting configuration (ReportConfigIDAIML) may be mapped in the identifier for the AI/ML measurement configurations to be added or modified (MeasTdToAddModATML). By mapping for measIDAIML, measObjectIDAIML, and ReportConfigIDAIML in MeasIdToAddMod, the target data to be collected, how to perform measurement for the target (or collect it), how to report the results, which results should be reported and so on can be defined.

### Split SRB Handling

SRB4 is for RRC messages which include application layer measurement report information, all using DCCH logical channel. SRB4 can only be configured by the network after AS security activation. The main purpose of SRB4 is for QoE (Quality of Experience) measurement. QoE is related to but differs from Quality of Service (QoS), which embodies the notion that hardware and software characteristics can be measured, improved and perhaps guaranteed. For SRB4, split SRB can be useful to enhance the reliability.

As explained in earlier examples, there may be an RB which is specifically configured for AI/ML functionality, e.g. SRBx. This RB is for RRC messages which include AI/ML functionality or configuration related information, all using DCCH logical channel. The SRBx can only be configured by the network after AS security activation. The main purpose of SRBx is for AI/ML functionality. For SRBx, split SRB can be useful to enhance the reliability. The benefit of spilt SRB is to reduce the latency and increase the reliability of data transmission at the cost of UE implementation complexity. For SRBx, it can be more preferable to reduce UE implementation complexity rather than the benefit of split SRB given that SRBx is mainly for AI/ML functionality. Hence, it would be better to limit network configuration, i.e. the network is not allowed to configure SRBx with split SRB to UE. When the network configures SRBx to UE with split SRB, the UE considers it as an error case or declares an error (e.g. configuration error or configuration failure).

### General Method

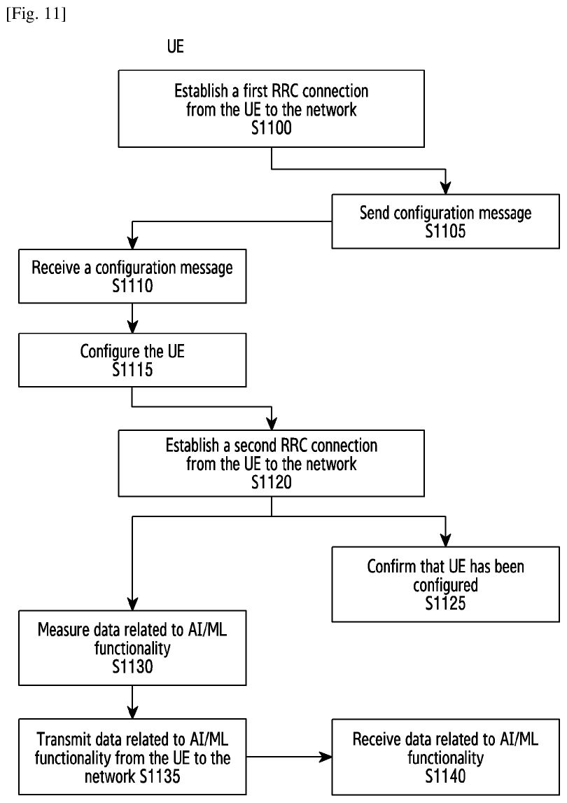

FIG. 11 is a flowchart showing a summary of the steps of the method described in detail above. The method configures user equipment (UE) to support artificial in-telligence/machine learning (AI/ML) functionality in a wireless communication network. In a first step S1100 a first radio resource control (RRC) connection is established from the user equipment to the network. The connection may be established via a first signalling radio bearer (e.g. SRB1) as described above. At least one configuration message is then sent from the network to the user equipment at step S1105. At step S1110, the configuration message(s) is received at the user equipment via the first signalling radio bearer. The configuration message includes bearer configuration information for a second signalling radio bearer to support the AI/ML functionality in the network. Transfer of data related to the AI/ML functionality may be done via the second radio bearer. In a next step S1115, the information in the configuration message(s) may be used to configure the user equipment. Although it is shown as a separate step S1120, establishing a second radio resource control (RRC) connection via the second signalling radio bearer from the user equipment to the network is part of the configuration of the user equipment. The second signalling radio bearer may be a standard signalling radio bearer, for example SRB2, a newly configured signalling radio bearer, for example SBR5 or other appropriate SRB number, or may be a data radio bearer.

Additional configuration information may be received in the same configuration message or separate messages. As described above, the user equipment can be further configured using some or all of the configuration information, the measurement configuration information, the prioritization configuration information and the security configuration information. After the user equipment is configured, the network confirms that the configuration has taken place at step S1125, e.g. by receiving a confirmation message from the user equipment. The network and user equipment can then be used together to apply AI/ML functionality within a network. For example, a node within the network having an AI/ML model may receive AI/ML data from the user equipment and may train the AI/ML model using the received AI/ML data. As another example, a node within the network having an AI/ML model may receive AI/ML data from the user equipment and may infer an output from the AI/ML model.

The user equipment may have been configured to measure the transmitted data before transmission as described above. Thus as shown in FIG. 11, at step S1130, the user equipment measures data related to AI/ML functionality. The second RRC connection enables an RRC message including data related to AI/ML functionality to be transmitted from the user equipment as shown at step S1135. This data is received at the network as shown at step S1140. Data can also be sent from the network to the user equipment over the second RRC connection.

### General System

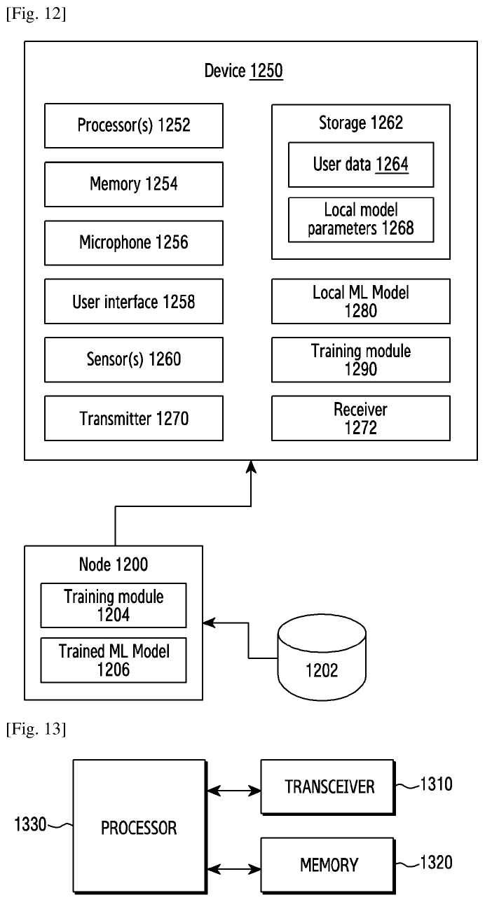

FIG. 12 is a block diagram of a system comprising a node 1200 in a network and a user device 1250 connected to the node 1200. It will be appreciated that the system may comprise multiple local devices which may also be termed client devices or user devices or user equipment and the system may comprise multiple nodes or cells and also an OAM as described above.

The user device 1250 may be any one of: a smartphone, tablet, laptop, computer or computing device, virtual assistant device, a vehicle, a drone, an autonomous vehicle, a robot or robotic device, a robotic assistant, image capture system or device, an augmented reality system or device, a virtual reality system or device, a gaming system, an Internet of Things device, or a smart consumer device (such as a smart fridge). It will be understood that this is a non-exhaustive and non-limiting list of example devices. The device 1250 comprises the standard components, for example at least one processor 1252 coupled to memory 1254. There may also be a microphone 1256 for capturing speech and a user interface 1258 to capture other user input. There may be other sensor(s) 1260 to capture other data, including the AI/ML data described above. There may also be at least one transmitter 1270 and at least one receiver 1272. It will be appreciated that there may be other standard components which are not shown for simplicity. The device 1250 may comprise one or more modules for collecting user data 1264 which is stored in storage 1262 and such storage may be an encrypted storage. Merely as examples, the modules may include the microphone 1256, the user interface 1258 and the sensor(s) 1260.

The at least one processor 1252 may comprise one or more of: a microprocessor, a microcontroller, and an integrated circuit. The memory 1254 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

There may be a training module 1290 on the user device which trains an ML model 1206 to generate a local ML model 1280 which is stored on the user device. The local model parameters 1268 of the local ML model may be stored in the storage 1262. As an alternative, the user device 1250 may not train the ML model but only use the stored local ML model 1280 for inference.

The system may incorporate federated learning and thus the node 1200 (or OAM) is arranged to perform any pre-training steps which are required to generate an initial trained ML model 1206. For example, the node 1200 receives reference training data (inputs x and outputs/labels y) from a database 1202. The node 1200 comprises a training module 1204 which receives as input the reference data from the database 1202 and outputs the basic or full precision model parameters (i.e. the set of weights or parameters which have been learnt during the training process). As an alternative to federated learning in which the training module 1290 is on the user device, when using the training module 1204 on the node, local data may be received from the user device 1250 to train a local ML model for the user device 1250 in a similar manner to that described in relation to the training on the user device. The personalised ML model which is generated on the node is then sent to the user device to be stored as the local ML model 1280. This may be termed distributed learning.

It will be appreciated that there are other components within the node 1200 which are not shown for ease of reference. The node 1200 may also use the trained ML model 1206 for inference, e.g. to infer outputs based on inputs received from the device 1250, e.g. inputs such as measurements from the sensor(s).

FIG. 13 is a block diagram illustrating a terminal (or a user equipment (UE)), according to the embodiments as disclosed herein.

As shown in FIG. 13, a terminal according to an embodiment may include a transceiver 1310, a memory 1320, and a processor (or a controller) 1330. The transceiver 1310, the memory 1320, and the processor (or controller) 1330 of the terminal may operate according to a communication method of the terminal described above. However, the components of the terminal are not limited thereto. For example, the terminal may include more or fewer components than those described in FIG. 13. In addition, the processor (or controller) 1330, the transceiver 1310, and the memory 1320 may be implemented as a single chip. Also, the processor (or controller) 1330 may include at least one processor. Furthermore, the UE of FIG. 13 corresponds to the UE 18, UE 218, NR UE, UE 318, UE 718, UE 818, UE 918, UE 1018, UE 1118, or Device 1350 of FIGS. 1-12.

The transceiver 1310 collectively refers to a terminal station receiver and a terminal transmitter, and may transmit/receive a signal to/from a base station or another terminal. The signal transmitted or received to or from the terminal may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor (or controller) 1330, a signal through a wireless channel, and transmit a signal output from the processor (or controller) 1330 through the wireless channel.

The memory 1320 may store a program and data required for operations of the terminal. Also, the memory 1320 may store control information or data included in a signal obtained by the terminal. The memory 1320 may be a storage medium, such as read-only memory (ROM), random access memory (RAM), a hard disk, a CD-ROM, and a DVD, or a combination of storage media.

The processor (or controller) 1330 may control a series of processes such that the terminal operates as described above. For example, the processor (or controller) 1330 may receive a data signal and/or a control signal, and the processor (or controller) 1330 may determine a result of receiving the signal transmitted by the base station and/or the other terminal.

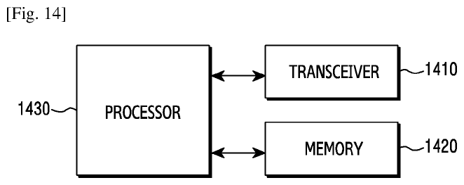

FIG. 14 is a block diagram illustrating a base station (BS), according to the embodiments as disclosed herein.

As shown in FIG. 14 is, the base station of the present disclosure may include a transceiver 1410, a memory 1420, and a processor (or, a controller) 1430. The transceiver 1410, the memory 1420, and the processor (or controller) 1430 of the base station may operate according to a communication method of the base station described above. However, the components of the base station are not limited thereto. For example, the base station may include more or fewer components than those described in FIG. 14. In addition, the processor (or controller) 1430, the transceiver 1410, and the memory 1420 may be implemented as a single chip. Also, the processor (or controller) 1430 may include at least one processor. Furthermore, the base station of FIG. 14 corresponds to the ENB 16a-16d, LTE eNB 216, eNB 316, NR gNB 326, gNB 1, NG-RAN node 1 (926), NG-RAN node 2 (928), NG-RAN node 1 (1026), NG-RAN node 2 (1026), MCG 1120, SCG 1122, or Node 1200 of FIGS. 1-12.

The transceiver 1410 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor (or controller) 1430, a signal through a wireless channel, and transmit a signal output from the processor (or controller) 1430 through the wireless channel.

The memory 1420 may store a program and data required for operations of the base station. Also, the memory 1420 may store control information or data included in a signal obtained by the base station. The memory 1420 may be a storage medium, such as ROM, RAM, a hard disk, a CD-ROM, and a DVD, or a combination of storage media.

The processor (or controller) 1430 may control a series of processes such that the base station operates as described above. For example, the processor (or controller) 1430 may receive a data signal and/or a control signal, and the processor (or controller) 1430 may determine a result of receiving the signal transmitted by the terminal and/or the core network function.

### Detailed Procedure for RRC Connection Control

### Reception of the RRCSetup by the UE

FIG. 8 outlines how an RRC connection can be set up. The pseudocode below gives the detail of the steps performed by the UE upon reception of the RRCSetup:
1>if the RRCSetup is received in response to an RRCReestablishmentRequest; or
1>if the RRCSetup is received in response to an RRCResumeRequest or RRCResumeRequest1:
   2>if sdt-MAC-PHY-CG-Config is configured:
      3>instruct the MAC entity to stop the cg-SDT-TimeAlignmentTimer, if it is running;
      3>instruct the MAC entity to start the timeAlignmentTimer associated with the PTAG, if it is not running;
   2>if srs-PosRRC-InactiveConfig is configured:
      3>instruct the MAC entity to stop the inactivePosSRS-TimeAlignmentTimer, if it is running;
   2>discard any stored UE Inactive AS context and suspendConfig;
   2>discard any current AS security context including the K_{RRCenc} key, the K_{RRCint} key, the K_{UPint} key and the K_{UPenc} key;
   2>release radio resources for all established RBs except SRB0 and broadcast MRBs, including release of the RLC entities, of the associated PDCP entities and of SDAP;
   2>release the RRC configuration except for the default L1 parameter values, default MAC Cell Group configuration, CCCH configuration and broadcast MRBs;
   2>indicate to upper layers fallback of the RRC connection;
   2>discard any application layer measurement reports which were not transmitted yet;
   2>inform upper layers about the release of all application layer measurement configurations;

### Reception of an RRCReconfiguration by the UE

FIG. 8 also outlines how an RRC reconfiguration can take place. The pseudocode below gives the detail of the steps performed by the UE upon reception of the RRCReconfiguration message. The steps can also be executed based on the conditional reconfiguration (CHO, CPA or CPC). As explained above, the UE can apply the AI/ML configuration when the RRC message (RRCReconfiguration or RRCResume) includes the configuration information. If the UE receives the AI/ML configuration in otherConfig in RRCReconfguration, the UE can include the AI/ML data in a subsequent RRC message to enable the network to utilize the information for network management. When UE receives a handover command message (i.e. RRCReconfiguration including reconfigurationWithSync) from the network (or gNB or the source gNB), the UE can send a handover complete message (i.e. RRCReconfigurationComplete) to the network (or gNB or the target gNB). The UE can include the indication of the availability of AI/ML data to report or the AI/ML data itself in the response message (RRCReconfigurationComplete) to inform it of the network. In addition to this, the UE can support retransmission of the RRC message including the AI/ML data, i.e. UE can retransmit it when its successful delivery has not been confirmed before (e.g. from the source gNB).
1>if the RRCReconfiguration (or RRCResume) message includes the AIMLConfig (i.e. AI/ML Configuration):
   2>perform the AI/ML configuration procedure;
1>if the received otherConfig includes the AI/ML configuration:
   2>if AI/ML configuration is set to setup, include available AI/ML data for any subsequent measurement report or any subsequent RLF report and SCGFailureInformation;
1> set the content of the RRCReconfigurationComplete message as follows:
   2>if the RRCReconfiguration includes the reconfigurationWithSync in spCellConfig of an MCG:
      3>if the UE has logged measurements available for NR and if the RPLMN is included in plmn-IdentityList stored in VarLogMeasReport:
         4>include the logMeasAvailable in the RRCReconfigurationComplete message;
         4>if Bluetooth measurement results are included in the logged measurements the UE has available for NR:
         5>include the logMeasAvailableBT in the RRCReconfigurationComplete message;
         4>if WLAN measurement results are included in the logged measurements the UE has available for NR:
         5>include the logMeasAvailableWLAN in the RRCReconfigurationComplete message;
   2>if the RRCReconfiguration includes the reconfigurationWithSync in spCellConfig of an MCG:
      3>if the UE has AI/ML data available for NR or if the RPLMN is included in plmn-IdentityList stored in VarLogMeasReport:
         4>include the AIMLDataAval/able (the indication of the availability of AI/ML data) or AI/ML data in the RRCReconfigurationComplete message;
1>if reconfigurationWithSync was included in spCellConfig of an MCG or SCG and when MAC of an NR cell group successfully completes a Random Access procedure triggered above; or,
   2>stop timer T304 for that cell group if running;
   2>stop timer T310 for source SpCell if running;
   2>apply the parts of the CSI reporting configuration, the scheduling request configuration and the sounding RS configuration that do not require the UE to know the SFN of the respective target SpCell, if any;
   2>apply the parts of the measurement and the radio resource configuration that require the UE to know the SFN of the respective target SpCell (e.g. measurement gaps, periodic CQI reporting, scheduling request configuration, sounding RS configuration), if any, upon acquiring the SFN of that target SpCell;
   2>if reconfigurationWithSync was included in masterCellGroup:
      3>if configured with application layer measurements and if application layer measurement report container has been received from upper layers for which the successful transmission of the message or at least one segment of the message has not been confirmed by lower layers:
         4>re-submit the MeasurementReportAppLayer message or all segments of the MeasurementReportAppLayer message to lower layers for transmission via SRB4;
      3>if configured with AI/ML functionality (e.g. AI/ML configuration) and if the RRC message including the report for AI/ML data has been generated (or transmitted) for which the successful transmission of the message or at least one segment of the message has not been confirmed by lower layers:
         4>re-submit the RRC message including the report for AI/ML data or all segments of the RRC message to lower layers for transmission via configured RB (SRB1 or SRB2 or SRBx or DRB);
   2>if reconfigurationWithSync was included in masterCellGroup and the target cell provides SIB21:
      3>if the UE initiated transmission of an MBSInterestIndication message during the last 1 second preceding reception of this RRCReconfiguration message; or
      3>if the RRCReconfiguration message is applied due to a conditional reconfiguration execution, and the UE has initiated transmission of an MBSInterestIndication message after having received this RRCReconfiguration message:
         4>initiate transmission of an MBSInterestIndication message;
   2>the procedure ends.

### AI/ML Configuration

FIGS. 9 and 10 are examples of how AI/ML data can be used in a network including a UE. The pseudocode below gives the detail of the steps performed by the UE when configuring the AI/ML configuration:
1>if measConfigToReleaseList (e.g. the list for configuration release) is included in AIMLConfig (i.e. AI/ML configuration) within RRCReconfiguration or RRCResume:
   2>for each measConfigId (e.g. target Identity for AI/ML data collection) value included in the measConfigToReleaseList:
      3>discard any AI/ML data for the measConfigId;
      3>consider itself not to be configured to send AI/ML data for the measConfigId.
1>if measConfigToAddModList (e.g. the list for configuration addition and modification) is included in AIMLConfig within RRCReconfiguration or RRCResume:
   2>for each measConfigId value included in the measConfigToAddModList:
      3>consider itself to be configured to send AI/ML data for the measConfigr/d;
      3>if pauseReporting (e.g, indication whether to stop (or deactivate) or start (or activate) AI/ML data reporting) is set to true:
         4>if at least one segment, but not all segments, of a segmented RRC message containing an AI/ML data associated with the measConfigId has been submitted to lower layers for transmission:
         5>submit the remaining segments of the RRC message to lower layers for transmission;
         4>suspend submitting RRC message including AI/ML data to lower layers for the AI/ML configuration associated with the measConfigId;
         4>store any previously or subsequently received AI/ML data containers associated with the measConfigId for which no segment, or full message, has been submitted to lower layers for transmission;
      3>else if pauseReporting is set to false and if transmission of AI/ML data report has previously been suspended for the AI/ML configuration associated with the measConfigId:
         4>submit the RRC message including the stored AI/ML data to lower layers, if any, for the AI/ML configuration associated with the measConfigId;
         4>resume submitting RRC message including AI/ML data to lower layers for the AI/ML configuration associated with the measConfigId;

### UE Actions Upon Going to RRC_IDLE

If AI/ML functionality is not supported for a UE in RRC IDLE state, the procedure to discard AI/ML data or release AI/ML configuration is needed when UE goes to RRC IDLE state from RRC CONNECTED (or RRC INACTIVE) mode. The pseudocode below gives the UE actions upon going to RRC_IDLE:
1>reset MAC;
1> set the variable pendingRNA-Update to false, if that is set to true;
1>if the UE is leaving RRC_INACTIVE:
   2>if going to RRC_IDLE was not triggered by reception of the RRCRelease message:
      3>if stored, discard the cell reselection priority information provided by the cellReselectionPriorities;
      3>stop the timer T320, if running;
1>stop all timers that are running except T302, T320, T325, T330, T331 and T400; 1>discard the UE Inactive AS context, if any;
1>release the suspendConfig, if configured;
1>remove all the entries within the MCG and the SCG VarConditionalReconfig, if any;
1>for each measid (e.g. target Identity for AI/ML data collection), if the associated reportConfig (e.g. configuration for AI/ML data reapot) has a reportType set to condTriggerConfig:
   2>for the associated reportConfigId:
      3>remove the entry with the matching reportConfigId from the reportConfigList within the VarMeasConfig;
   2>if the associated measObjectId is only associated to a reportConfig with reportType set to condTriggerConfig:
      3>remove the entry with the matching measObjectId from the measObjectList within the VarMeasConfig;
   2>remove the entry with the matching measId from the measIdList within the VarMeasConfig;
1>discard the K_{gNB} key, the S-K_{gNB} key, the S-K_{eNB} key, the K_{RRCenc} key, the K_{RRCint} key, the K_{UPint} key and the K_{UPenc} key, if any;
1>release all radio resources, including release of the RLC entity, the BAP entity, the MAC configuration and the associated PDCP entity and SDAP for all established RBs (except for broadcast MRBs), BH RLC channels, Uu Relay RLC channels, PC5 Relay RLC channels and SRAP entity;
1>indicate the release of the RRC connection to upper layers together with the release cause;
1>inform upper layers about the release of all application layer measurement configurations;
1>discard any application layer measurement reports which were not yet submitted to lower layers for transmission;
1>inform upper layers (e.g. application layer or NAS layer) about the release of AI/ML configuration or release AI/ML configuration;
1>discard any AI/ML data (e.g. report) which were not yet submitted to lower layers for transmission;
1>discard any segments of segmented RRC messages stored (e.g. the segment of AI/ML data);
1>except if going to RRC_IDLE was triggered by inter-RAT cell reselection while the UE is in RRC_INACTIVE or RRC_IDLE or when selecting an inter-RAT cell while T311 was running or when selecting an E-UTRA cell for EPS fallback for IMS voice:
   2>enter RRC_IDLE and perform cell selection;

### Quantity Configuration by the UE

The pseudocode below gives the UE actions for quantity configuration. The UE shall:
1>for each RAT for which the received quantityConfig includes parameter(s):
   2> set the corresponding parameter(s) in quantityConfig within VarMeasConfig to the value of the received quantityConfig parameter(s);
1>for each measId (or AIML identifier) included in the measIdList (or list of AIML identifiers) within VarMeasConfig:
   2>remove the measurement reporting entry for this measId (or AIML identifier) from the VarMeasReportList (or list of AIML reports), if included;
   2>stop the periodical reporting timer or timer T321 or timer T322, whichever one is running, and reset the associated information (e.g. timeToTrigger) for this measId (or AIML identifier).

### Details for Various Information Elements

As described above, there are various information elements in the RRC message structure. The code is provided below for these elements:

MeasConfig information element

-- ASN1START
-- TAG-MEASCONFIG-START

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
  ...,
  [[
```

| | |
|---|---|
| interFrequencyConfig-NoGap-r16 | ENUMERATED {true} |

OPTIONAL -- Need R
]]
}

| | |
|---|---|
| MeasObjectToRemoveList ::= | SEQUENCE (SIZE |

(1..maxNrofObjectId)) OF MeasObjectId

| | |
|---|---|
| MeasIdToRemoveList ::= | SEQUENCE (SIZE |

(1..maxNrofMeasId) OF MeasId

| | |
|---|---|
| ReportConfigToRemoveList ::= | SEQUENCE (SIZE |

(1..maxReportConfigId)) OF ReportConfigId
-- TAG-MEASCONFIG-STOP
-- ASN1STOP

MeasConfig field descriptions

interFrequencyConfig-NoGap-r16
If the field is set to true, UE is configured to perform SSB based inter-frequency
measurement without measurement gaps when the inter-frequency SSB is completely
contained in the active DL BWP of the UE. Otherwise, the SSB based inter-frequency
measurement is performed within measurement gaps. In NR-DC, the field can only be
configured in the measConfig associated with MCG, and when configured, it applies to all
the inter-frequency measurements configured by MN and SN.
measGapConfig
Used to setup and release measurement gaps in NR.
measIdToAddModList
List of measurement identities to add and/or modify.
measIdToRemoveList
List of measurement identities to remove.
measObjectToAddModList
List of measurement objects to add and/or modify.
measObjectToRemoveList
List of measurement objects to remove.
reportConfigToAddModList
List of measurement reporting configurations to add and/or modify.
reportConfigToRemoveList
List of measurement reporting configurations to remove.
s-MeasureConfig
Threshold for NR SpCell RSRP measurement controlling when the UE is required to
perform measurements on non-serving cells. Choice of ssb-RSRP corresponds to cell
RSRP based on SS/PBCH block and choice of csi-RSRP corresponds to cell RSRP of
CSI-RS.
measGapSharingConfig
Specifies the measurement gap sharing scheme and controls setup/release of
measurement gap sharing.

MeasId information element

| -- ASN1START | |
|---|---|
| -- TAG-MEASID-START | |
| MeasId ::= | INTEGER (1..maxNrofMeasId) |

-- TAG-MEASID-STOP
-- ASN1STOP

MeasIdToAddModList information element

-- ASN1START
-- TAG-MEASIDTOADDMODLIST-START

| | |
|---|---|
| MeasIdToAddModList ::= | SEQUENCE (SIZE (1..maxNrofMeasId)) |

OF MeasIdToAddMod

| | |
|---|---|
| MeasIdToAddMod ::= | SEQUENCE { |
| measId | MeasId, |
| measObjectId | MeasObjectId, |
| reportConfigId | ReportConfigId |

}
-- TAG-MEASIDTOADDMODLIST-STOP
-- ASN1STOP

MeasObjectNR information element

-- ASN1START
-- TAG-MEASOBJECTNR-START

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS- |
| BlocksToAverage) | OPTIONAL, -- Need R |
| nrofCSI-RS-ResourcesToAverage | INTEGER (2..maxNrofCSI-RS- |
| ResourcesToAverage) | OPTIONAL, -- Need R |
| quantityConfigIndex | INTEGER (1..maxNrofQuantityConfig), |
| offsetMO | Q-OffsetRangeList, |
| cellsToRemoveList | PCI-List |

OPTIONAL, -- Need N

| | |
|---|---|
| cellsToAddModList | CellsToAddModList |

OPTIONAL, -- Need N

| | |
|---|---|
| excludedCellsToRemoveList | PCI-RangeIndexList |

OPTIONAL, -- Need N

| | |
|---|---|
| excludedCellsToAddModList | SEQUENCE (SIZE (1..maxNrofPCI- |
| Ranges)) OF PCI-RangeElement | OPTIONAL, -- Need N |
| allowedCellsToRemoveList | PCI-RangeIndexList |

OPTIONAL, -- Need N

| | |
|---|---|
| allowedCellsToAddModList | SEQUENCE (SIZE (1..maxNrofPCI- |
| Ranges)) OF PCI-RangeElement | OPTIONAL, -- Need N |

```
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, |

```
sf512, sf640, sf1024, sf1280} OPTIONAL -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

```
OPTIONAL -- Need M
  ]],
  [[
```

| | |
|---|---|
| associatedMeasGapSSB-r17 | MeasGapId-r17 |

OPTIONAL, -- Need R

| | |
|---|---|
| associatedMeasGapCSIRS-r17 | MeasGapId-r17 |

OPTIONAL, -- Need R

| | |
|---|---|
| smtc4list-r17 | SSB-MTC4List-r17 |

OPTIONAL, -- Need R

| | |
|---|---|
| measCyclePSCell-r17 | ENUMERATED {ms160, ms256, ms320, |

ms512, ms640, ms1024, ms1280, spare1}
OPTIONAL, -- Cond SCG

| | |
|---|---|
| cellsToAddModListExt-v1710 | CellsToAddModListExt-v1710 |

```
OPTIONAL -- Need N
  ]],
  [[
```

| | |
|---|---|
| associatedMeasGapSSB2-v1720 | MeasGapId-r17 |

OPTIONAL, -- Cond AssociatedGapSSB

| | |
|---|---|
| associatedMeasGapCSIRS2-v1720 | MeasGapId-r17 |

OPTIONAL -- Cond AssociatedGapCSIRS
]]
}

| | |
|---|---|
| SSB-MTC3List-r16::= | SEQUENCE (SIZE (1..4)) OF SSB-MTC3-r16 |
| SSB-MTC4List-r17::= | SEQUENCE (SIZE (1..3)) OF SSB-MTC4-r17 |
| T312-r16 ::= | ENUMERATED { ms0, ms50, ms100, ms200, |

ms300, ms400, ms500, ms1000}

| | |
|---|---|
| ReferenceSignalConfig::= | SEQUENCE { |
| ssb-ConfigMobility | SSB-ConfigMobility |

OPTIONAL, -- Need M

| | |
|---|---|
| csi-rs-ResourceConfigMobility | SetupRelease { CSI-RS- |
| ResourceConfigMobility } | OPTIONAL -- Need M |

}

| | |
|---|---|
| SSB-ConfigMobility::= | SEQUENCE { |
| ssb-ToMeasure | SetupRelease { SSB-ToMeasure } |

OPTIONAL, -- Need M

| | |
|---|---|
| deriveSSB-IndexFromCell | BOOLEAN, |
| ss-RSSI-Measurement | SS-RSSI-Measurement |

```
OPTIONAL, -- Need M
  ...,
  [[
```

| | |
|---|---|
| ssb-PositionQCL-Common-r16 | SSB-PositionQCL-Relation-r16 |

OPTIONAL, -- Cond SharedSpectrum
ssb-PositionQCL-CellsToAddModList-r16 SSB-PositionQCL-

| | |
|---|---|
| CellsToAddModList-r16 | OPTIONAL, -- Need N |

```
  ssb-PositionQCL-CellsToRemoveList-r16 PCI-List
OPTIONAL -- Need N
  ]],
  [[
```

| | |
|---|---|
| deriveSSB-IndexFromCellInter-r17 | ServCellIndex |

OPTIONAL, -- Need R

| | |
|---|---|
| ssb-PositionQCL-Common-r17 | SSB-PositionQCL-Relation-r17 |

OPTIONAL, -- Cond SharedSpectrum2

| | |
|---|---|
| ssb-PositionQCL-Cells-r17 | SetupRelease { SSB-PositionQCL- |
| CellList-r17} | OPTIONAL -- Need M |

]]
}

| | |
|---|---|
| Q-OffsetRangeList ::= | SEQUENCE { |
| rsrpOffsetSSB | Q-OffsetRange DEFAULT |

dB0,

| | |
|---|---|
| rsrqOffsetSSB | Q-OffsetRange DEFAULT |

dB0,

| | |
|---|---|
| sinrOffsetSSB | Q-OffsetRange DEFAULT |

dB0,

| | |
|---|---|
| rsrpOffsetCSI-RS | Q-OffsetRange DEFAULT |

dB0,

| | |
|---|---|
| rsrqOffsetCSI-RS | Q-OffsetRange DEFAULT |

dB0,

| | |
|---|---|
| sinrOffsetCSI-RS | Q-OffsetRange DEFAULT |

dB0
}

| | |
|---|---|
| ThresholdNR ::= | SEQUENCE { |
| thresholdRSRP | RSRP-Range |

OPTIONAL, -- Need R

| | |
|---|---|
| thresholdRSRQ | RSRQ-Range |

OPTIONAL, -- Need R

| | |
|---|---|
| thresholdSINR | SINR-Range |

OPTIONAL -- Need R
}

| | |
|---|---|
| CellsToAddModList ::= | SEQUENCE (SIZE (1..maxNrofCellMeas)) OF |

CellsToAddMod

| | |
|---|---|
| CellsToAddModListExt-v1710 ::= | SEQUENCE (SIZE (1..maxNrofCellMeas)) OF |

CellsToAddModExt-v1710

| | |
|---|---|
| CellsToAddMod ::= | SEQUENCE { |
| physCellId | PhysCellId, |
| cellIndividualOffset | Q-OffsetRangeList |

}

| | |
|---|---|
| CellsToAddModExt-v1710 ::= | SEQUENCE { |
| ntn-PolarizationDL-r17 | ENUMERATED { rhcp, lhcp, linear} |

OPTIONAL, -- Need R

| | |
|---|---|
| ntn-PolarizationUL-r17 | ENUMERATED { rhcp, lhcp, linear} |

OPTIONAL -- Need R
}

| | |
|---|---|
| RMTC-Config-r16 ::= | SEQUENCE { |
| rmtc-Periodicity-r16 | ENUMERATED {ms40, ms80, ms160, |

ms320, ms640},

| | |
|---|---|
| rmtc-SubframeOffset-r16 | INTEGER (0..639) |

OPTIONAL, -- Need M

| | |
|---|---|
| measDurationSymbols-r16 | ENUMERATED { syml, sym14or12, |

sym28or24, sym42or36, sym70or60},

| | |
|---|---|
| rmtc-Frequency-r16 | ARFCN-ValueNR, |
| ref-SCS-CP-r16 | ENUMERATED { kHz15, kHz30, kHz60- |

```
NCP, kHz60-ECP},
  ...,
  [[
```

| | |
|---|---|
| rmtc-Bandwidth-r17 | ENUMERATED {mhz100, mhz400, mhz800, |

mhz1600, mhz2000} OPTIONAL, -- Need R

| | |
|---|---|
| measDurationSymbols-v1700 | ENUMERATED { sym140, sym560, |
| sym1120} | OPTIONAL, -- Need R |
| ref-SCS-CP-v1700 | ENUMERATED { kHz120, kHz480, kHz960} |

OPTIONAL, -- Need R

| | |
|---|---|
| tci-StateInfo-r17 | SEQUENCE { |
| tci-StateId-r17 | TCI-StateId, |
| ref-ServCellId-r17 | ServCellIndex |

```
OPTIONAL -- Need R
  } OPTIONAL  -- Need R
  ]],
  [[
```

| | |
|---|---|
| ref-BWPId-r17 | BWP-Id |

OPTIONAL -- Need R
]]
}
SSB-PositionQCL-CellsToAddModList-r16 ::= SEQUENCE (SIZE
(1..maxNrofCellMeas)) OF SSB-PositionQCL-CellsToAddMod-r16
SSB-PositionQCL-CellsToAddMod-r16 ::= SEQUENCE {

| | |
|---|---|
| physCellId-r16 | PhysCellId, |
| ssb-PositionQCL-r16 | SSB-PositionQCL-Relation-r16 |

}

| | |
|---|---|
| SSB-PositionQCL-CellList-r17 ::= | SEQUENCE (SIZE (1..maxNrofCellMeas)) OF |

SSB-PositionQCL-Cell-r17

| | |
|---|---|
| SSB-PositionQCL-Cell-r17 | ::= SEQUENCE { |
| physCellId-r17 | PhysCellId, |
| ssb-PositionQCL-r17 | SSB-PositionQCL-Relation-r17 |

}
-- TAG-MEASOBJECTNR-STOP
-- ASN1STOP

CellsToAddMod field descriptions

cellIndividualOffset
Cell individual offsets applicable to a specific cell.
physCellId
Physical cell identity of a cell in the cell list.

MeasObjectToAddModList information element

-- ASN1START
-- TAG-MEASOBJECTTOADDMODLIST-START

| | |
|---|---|
| MeasObjectToAddModList ::= | SEQUENCE (SIZE |

(1..maxNrofObjectId)) OF MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16 |

}
}
-- TAG-MEASOBJECTTOADDMODLIST-STOP
-- ASN1STOP

MeasurementReport message

| -- ASN1START | |
|---|---|
| -- TAG-MEASUREMENTREPORT-START | |
| MeasurementReport ::= | SEQUENCE { |
| criticalExtensions | CHOICE { |
| measurementReport | MeasurementReport-IEs, |
| criticalExtensionsFuture | SEQUENCE { } |
| } | |
| } | |
| MeasurementReport-IEs ::= | SEQUENCE { |
| measResults | MeasResults, |
| lateNonCriticalExtension | OCTET STRING |
| OPTIONAL, | |
| nonCriticalExtension | SEQUENCE { } |

OPTIONAL
}
-- TAG-MEASUREMENTREPORT-STOP
-- ASN1STOP

MeasResults information element

-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | OCTET STRING -- |

Contains PC5 SL-MeasResultListRelay-r17

| | |
|---|---|
| measResultListAIML | measResultListAIML |

```
  }
OPTIONAL,
  ...,
  [[
```

| | |
|---|---|
| measResultServFreqListEUTRA-SCG | MeasResultServFreqListEUTRA-SCG |

OPTIONAL,

| | |
|---|---|
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
    ]],
    [[
```

| | |
|---|---|
| measResultCellListSFTD-NR | MeasResultCellListSFTD-NR |

```
OPTIONAL
  ]],
  [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList- |

r16
OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
  ]],
  [[
```

| | |
|---|---|
| measResultRxTxTimeDiff-r17 | MeasResultRxTxTimeDiff-r17 |

OPTIONAL,

| | |
|---|---|
| sl-MeasResultServingRelay-r17 | OCTET STRING |

OPTIONAL,
-- Contains PC5 SL-MeasResultRelay-r17

| | |
|---|---|
| ul-PDCP-ExcessDelayResultList-r17 | UL-PDCP-ExcessDelayResultList- |
| r17 | OPTIONAL, |
| coarseLocationInfo-r17 | OCTET STRING |

OPTIONAL
]]
}

| | |
|---|---|
| MeasResultServMOList ::= | SEQUENCE (SIZE |

(1..maxNrofServingCells)) OF MeasResultServMO

| | |
|---|---|
| MeasResultServMO ::= | SEQUENCE { |
| servCellId | ServCellIndex, |
| measResultServingCell | MeasResultNR, |
| measResultBestNeighCell | MeasResultNR |

OPTIONAL,
...
}

| | |
|---|---|
| MeasResultListNR ::= | SEQUENCE (SIZE (1..maxCellReport)) |

OF MeasResultNR

| | |
|---|---|
| MeasResultNR ::= | SEQUENCE { |
| physCellId | PhysCellId |

OPTIONAL,

| | |
|---|---|
| measResult | SEQUENCE { |
| cellResults | SEQUENCE{ |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS- |
| IndexList | OPTIONAL |

```
    }
OPTIONAL
    },
----------------------------------------------------------------------
-------------------------
Option 1: Introduce TimeInfo or Sequence Number
```

| | |
|---|---|
| MeasResultListAIML ::= | SEQUENCE (SIZE |

(1..maxCellReport)) OF MeasResultAIML

| | |
|---|---|
| MeasResultAIML::= | SEQUENCE { |
| physCellId | PhysCellId |

Sequence number (or Time information)
OPTIONAL,

| | |
|---|---|
| measResult | SEQUENCE { |
| cellResults | SEQUENCE{ |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS- |
| IndexList | OPTIONAL |

```
    }
OPTIONAL
  },
----------------------------------------------------------------------
-------------------------
Option 2: Introduce a list with sequence number or without it(based on
rule, e.g. FIFO (First In First Out) or FILO (First In Last Out) )
```

| | |
|---|---|
| MeasResultListAIML ::= | SEQUENCE (SIZE |

(1..maxCellReport)) OF MeasResultAIML

| | |
|---|---|
| MeasResultAIML::= | SEQUENCE { |
| physCellId | PhysCellId |
| measResult | SEQUENCE { |
| cellResults | SEQUENCE{ |
| resultsSSB-Cell | MeasQuantityResultsAIML |
| | OPTIONAL, |
| resultsCSI-RS-Cell | MeasQuantityResultsAIML |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS- |
| IndexList | OPTIONAL |

```
    }
OPTIONAL
  },
```

| | |
|---|---|
| MeasQuantityResultsAIML ::= | SEQUENCE { |
| rsrp-list | ResultsRSRP-list |

OPTIONAL,

| | |
|---|---|
| rsrq-list | ResultsRSRQ-list |

OPTIONAL,

| | |
|---|---|
| Sinr-list | ResultsSINR-list |

OPTIONAL
}
ResultsRSRP-List::= SEQUENCE (SIZE
(1..maxNrofIndexesToReport3)) OF ResultsRSRP
ResultsRSRP::= SEQUENCE {
Sequnce number (or Time Info.) Sequence number,

| | |
|---|---|
| rsrp | RSRP-Range |

OPTIONAL
}
ResultsRSRQ-List::= SEQUENCE (SIZE
(1..maxNrofIndexesToReport4)) OF ResultsRSRQ
ResultsRSRQ::= SEQUENCE {
Sequnce number (or Time Info.) Sequence number,

| | |
|---|---|
| rsrq | RSRQ-Range |

OPTIONAL
}
ResultsSINR-List::= SEQUENCE (SIZE
(1..maxNrofIndexesToReport5)) OF ResultsSINR
ResultsSINR::= SEQUENCE {
Sequence number (or Time Info.) Sequence number,

| | |
|---|---|
| sinr | SINR-Range |

OPTIONAL
}

| | |
|---|---|
| MeasQuantityResults ::= | SEQUENCE { |
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| | |
|---|---|
| ResultsPerSSB-IndexList::= | SEQUENCE (SIZE |

(1..maxNrofIndexesToReport2)) OF ResultsPerSSB-Index

| | |
|---|---|
| ResultsPerSSB-Index ::= | SEQUENCE { |
| ssb-Index | SSB-Index, |
| ssb-Results | MeasQuantityResults |

```
OPTIONAL
}
----------------------------------------------------------------------
-------------------------
  ...,
  [[
```

| | |
|---|---|
| cgi-Info | CGI-InfoNR |

```
OPTIONAL
  ]] ,
  [[
```

| | |
|---|---|
| choCandidate-r17 | ENUMERATED {true} |

OPTIONAL,

| | |
|---|---|
| choConfig-r17 | SEQUENCE (SIZE (1..2)) OF |
| CondTriggeredConfig-r16 | OPTIONAL, |
| triggeredEvent-r17 | SEQUENCE { |
| timeBetweenEvents-r17 | TimeBetweenEvent-r17 |

OPTIONAL,

| | |
|---|---|
| firstTriggeredEvent | ENUMERATED {condFirstEvent, |
| condSecondEvent} | OPTIONAL |

```
    }
OPTIONAL
  ]]
}
```

| | |
|---|---|
| MeasResultListEUTRA ::= | SEQUENCE (SIZE (1..maxCellReport)) |

OF MeasResultEUTRA

| | |
|---|---|
| MeasResultEUTRA ::= | SEQUENCE { |
| eutra-PhysCellId | PhysCellId, |
| measResult | MeasQuentityResultsEUTRA, |
| cgi-Info | CGI-InfoEUTRA |

OPTIONAL,
...
}

| | |
|---|---|
| MultiBandInfoListEUTRA ::= | SEQUENCE (SIZE (1..maxMultiBands)) |

OF FreqBandIndicatorEUTRA

| | |
|---|---|
| MeasQuantityResults ::= | SEQUENCE { |
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| | |
|---|---|
| MeasQuantityResultsEUTRA ::= | SEQUENCE { |
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE |

(1..maxNrofIndexesToReport2)) OF ResultsPerSSB-Index

| | |
|---|---|
| ResultsPerSSB-Index ::= | SEQUENCE { |
| ssb-Index | SSB-Index, |
| ssb-Results | MeasQuantityResults |

OPTIONAL
}

| | |
|---|---|
| ResultsPerCSI-RS-IndexList::= | SEQUENCE (SIZE |

(1..maxNrofIndexesToReport2)) OF ResultsPerCSI-RS-Index

| | |
|---|---|
| ResultsPerCSI-RS-Index ::= | SEQUENCE { |
| csi-RS-Index | CSI-RS-Index, |
| csi-RS-Results | MeasQuantityResults |

OPTIONAL
}
MeasResultServFreqListEUTRA-SCG ::= SEQUENCE (SIZE
(1..maxNrofServingCellsEUTRA)) OF MeasResult2EUTRA
MeasResultServFreqListNR-SCG ::= SEQUENCE (SIZE (1..maxNrofServingCells))
OF MeasResult2NR

| | |
|---|---|
| MeasResultListUTRA-FDD-r16 ::= | SEQUENCE (SIZE (1..maxCellReport)) |

OF MeasResultUTRA-FDD-r16

| | |
|---|---|
| MeasResultUTRA-FDD-r16 ::= | SEQUENCE { |
| physCellId-r16 | PhysCellIdUTRA-FDD-r16, |
| measResult-r16 | SEQUENCE { |
| utra-FDD-RSCP-r16 | INTEGER (−5..91) |

OPTIONAL,

| | |
|---|---|
| utra-FDD-EcN0-r16 | INTEGER (0..49) |

OPTIONAL
}
}
MeasResultForRSSI-r16 ::= SEQUENCE {

| | |
|---|---|
| rssi-Result-r16 | RSSI-Range-r16, |
| channelOccupancy-r16 | INTEGER (0..100) |

}
MeasResultCLI-r16 ::= SEQUENCE {

| | |
|---|---|
| measResultListSRS-RSRP-r16 | MeasResultListSRS-RSRP-r16 |

OPTIONAL,

| | |
|---|---|
| measResultListCLI-RSSI-r16 | MeasResultListCLI-RSSI-r16 |

OPTIONAL
}
MeasResultListSRS-RSRP-r16 ::= SEQUENCE (SIZE (1.. maxCLI-Report-r16)) OF
MeasResultSRS-RSRP-r16
MeasResultSRS-RSRP-r16 ::= SEQUENCE {

| | |
|---|---|
| srs-ResourceId-r16 | SRS-ResourceId, |
| srs-RSRP-Result-r16 | SRS-RSRP-Range-r16 |

}
MeasResultListCLI-RSSI-r16 ::= SEQUENCE (SIZE (1.. maxCLI-Report-r16)) OF
MeasResultCLI-RSSI-r16
MeasResultCLI-RSSI-r16 ::= SEQUENCE {

| | |
|---|---|
| rssi-ResourceId-r16 | RSSI-ResourceId-r16, |
| cli-RSSI-Result-r16 | CLI-RSSI-Range-r16 |

}
UL-PDCP-DelayValueResultList-r16 ::= SEQUENCE (SIZE (1..maxDRB)) OF UL-
PDCP-DelayValueResult-r16
UL-PDCP-DelayValueResult-r16 ::= SEQUENCE {

| | |
|---|---|
| drb-Id-r16 | DRB-Identity, |
| averageDelay-r16 | INTEGER (0..10000), |

...
}
UL-PDCP-ExcessDelayResultList-r17 ::= SEQUENCE (SIZE (1..maxDRB)) OF UL-
PDCP-ExcessDelayResult-r17
UL-PDCP-ExcessDelayResult-r17 ::= SEQUENCE {

| | |
|---|---|
| drb-Id-r17 | DRB-Identity, |
| excessDelay-r17 | INTEGER (0..31), |

...
}
TimeBetweenEvent-r17 ::= INTEGER (0..1023)
-- TAG-MEASRESULTS-STOP
-- ASN1STOP

MeasResults field descriptions

coarseLocationInfo
This field indicates the coarse location information reported by the UE. This field is coded
as the Ellipsoid-Point defined in TS 37.355. The first/leftmost bit of the first octet contains
the most significant bit. The least significant bits of degreesLatitude and degreesLongitude
are set to 0 to meet the accuracy requirement corresponds to a granularity of
approximately 2 km.
It is up to UE implementation how many LSBs are set to 0 to meet the accuracy
requirement
excessDelay
Indicates the ratio of packets in UL per DRB exceeding the configured delay threshold
among the UL PDCP SDUs, according to the UL PDCP Excess Packet Delay per DRB
mapping table.
measId
Identifies the measurement identity for which the reporting is being performed.
measQuantityResults
The value sinr is not included when it is used for LogMeasReport-r16.
measResultCellListSFTD-NR
SFTD measurement results between the PCell and the NR neighbour cell(s) in NR
standalone.
measResultCLI
CLI measurement results.
measResultEUTRA
Measured results of an E-UTRA cell.
measResultForRSSI
Includes measured RSSI result in dBm (see TS 38.215) and channelOccupancy which is
the percentage of samples when the RSSI was above the configured
channelOccupancyThreshold for the associated reportConfig.
measResultListEUTRA
List of measured results for the maximum number of reported best cells for an E-UTRA
measurement identity.
measResultListNR
List of measured results for the maximum number of reported best cells for an NR
measurement identity.
measResultListUTRA-FDD
List of measured results for the maximum number of reported best cells for a UTRA-FDD
measurement identity.
measResultNR
Measured results of an NR cell.
measResultServFreqListEUTRA-SCG
Measured results of the E-UTRA SCG serving frequencies: the measurement result of
PSCell and each SCell, if any, and of the best neighbouring cell on each E-UTRA SCG
serving frequency.
measResultServFreqListNR-SCG
Measured results of the NR SCG serving frequencies: the measurement result of PSCell
and each SCell, if any, and of the best neighbouring cell on each NR SCG serving
frequency.
measResultServingMOList
Measured results of measured cells with reference signals indicated in the serving cell
measurement objects including measurement results of SpCell, configured SCell(s) and
best neighbouring cell within measured cells with reference signals indicated in on each
serving cell measurement object. If the sending of the MeasurementReport message is
triggered by a measurement configured by the field sl-ConfigDedicatedForNR received
within an E-UTRA RRCConnectionReconfiguration message (i.e. CBR measurements),
this field is not applicable and its contents is ignored by the network.
measResultSFTD-EUTRA
SFTD measurement results between the PCell and the E-UTRA PScell in NE-DC.
measResultSFTD-NR
SFTD measurement results between the PCell and the NR PScell in NR-DC.
measResultsSL
CBR measurements results for NR sidelink communication/discovery.
measResultUTRA-FDD
Measured result of a UTRA-FDD cell.
sl-MeasResultsCandRelay
Measurement result(s) of candiate L2 U2N relay UE(s).
sl-MeasResultsServingRelay
Measurement result of serving L2 U2N relay UE.

MeasResultEUTRA field descriptions

eutra-PhysCellId
Identifies the physical cell identity of the E-UTRA cell for which the reporting is being
performed. The UE reports a value in the range 0 . . . 503, other values are reserved.

MeasResultUTRA-FDD field descriptions

physCellId
The physical cell identity of the UTRA-FDD cell for which the reporting is being performed.
utra-FDD-EcN0
According to CPICH_Ec/No for FDD.
utra-FDD-RSCP
According to CPICH_RSCP for FDD.

MeasResultNR field descriptions

averageDelay
Indicates average delay for the packets during the reporting period. Value 0 corresponds
to 0 millisecond, value 1 corresponds to 0.1 millisecond, value 2 corresponds to 0.2
millisecond, and so on.
cellResults
Cell level measurement results.
choCandidate
This field indicates whether the associated cell is a candidate target cell for conditional
handover. This field may be included only in the SuccessHO-Report within
UEInformationResponse message.
choConfig
If the associated cell is a candidate target cell for conditional handover, this field indicates
the conditional handover execution condition for each measId within condTriggerConfig
associated to the cell. This field may be included only in the rlf-report within
UEInformationResponse message.
drb-Id
Indicates DRB value for which uplink PDCP delay ratio or value is provided.
firstTriggeredEvent
This field is set to condFirstEvent if the execution condition associated to the first entry of
choConfig was fulfilled first in time. This field is set to condSecondEvent if the execution
condition associated to the second entry of choConfig was fulfilled first in time. This field
may be included only in rif-report within UEInformationResponse message.
locationInfo
Positioning related information and measurements.
physCellId
The physical cell identity of the NR cell for which the reporting is being performed.
resultsSSB-Cell
Cell level measurement results based on SS/PBCH related measurements.
resultsSSB-Indexes
Beam level measurement results based on SS/PBCH related measurements.
resultsCSI-RS-Cell
Cell level measurement results based on CSI-RS related measurements.
resultsCSI-RS-Indexes
Beam level measurement results based on CSI-RS related measurements.
rsindexResults
Beam level measurement results.
timeBetweenEvents
Indicates the time elapsed between fulfilling the conditional execution conditions included
in choConfig. Value in milliseconds. The maximum value 1023 means 1023 ms or longer.
This field may be included only in the reports associated to UEInformationResponse
message, e.g., rlf-Report.

MeasResultIdleNR information element

-- ASN1START
-- TAG-MEASRESULTIDLENR-START

| MeasResultIdleNR-r16 ::= | SEQUENCE { | | |
|---|---|---|---|
| measResultServingCell-r16 | | SEQUENCE { | |
| rsrp-Result-r16 | | | RSRP-Range |

OPTIONAL,

| | |
|---|---|
| rsrq-Result-r16 | RSRQ-Range |

| OPTIONAL, | |
|---|---|
| resultsSSB-Indexes-r16 | ResultsPerSSB-IndexList-r16 |
| OPTIONAL | |
| }, | |

measResultsPerCarrierListIdleNR-r16 SEQUENCE (SIZE (1..maxFreqIdle-

| r16)) OF MeasResultsPerCarrierIdleNR-r16 | | OPTIONAL, |
|---|---|---|
| ... | | |
| } | | |
| MeasResultsPerCarrierIdleNR-r16 ::= | SEQUENCE { | |
| carrierFreq-r16 | | ARFCN-ValueNR, |
| measResultsPerCellListIdleNR-r16 | | SEQUENCE (SIZE |

(1..maxCellMeasIdle-r16) ) OF MeasResultsPerCellIdleNR-r16,

| ... | | | |
|---|---|---|---|
| } | | | |
| MeasResultsPerCellIdleNR-r16 ::= | SEQUENCE { | | |
| physCellId-r16 | | PhysCellId, | |
| measIdleResultNR-r16 | | SEQUENCE { | |
| rsrp-Result-r16 | | | RSRP-Range |
| OPTIONAL, | | | |
| rsrq-Result-r16 | | | RSRQ-Range |

| | |
|---|---|
| OPTIONAL, | |
| resultsSSB-Indexes-r16 | ResultsPerSSB-IndexList-r16 |
| OPTIONAL | |
| }, | |
| ... | |
| } | |

| | |
|---|---|
| ResultsPerSSB-IndexList-r16 ::= | SEQUENCE (SIZE (1.. |

maxNrofIndexesToReport)) OF ResultsPerSSB-IndexIdle-r16

| ResultsPerSSB-IndexIdle-r16 ::= | SEQUENCE { | |
|---|---|---|
| ssb-Index-r16 | | SSB-Index, |
| ssb-Results-r16 | | SEQUENCE { |

| ssb-RSRP-Result-r16 | RSRP-Range |
|---|---|
| OPTIONAL, | |
| ssb-RSRQ-Result-r16 | RSRQ-Range |
| OPTIONAL | |
| } | |
| OPTIONAL | |
| } | |
| -- TAG-MEASRESULTIDLENR-STOP | |
| -- ASN1STOP | |

MeasResultIdleNR field descriptions

carrierFreq
Indicates the NR carrier frequency.
measIdleResultNR
Idle/inactive measurement results for an NR cell (optionally including beam level
measurements).
measResultServingCell
Measured results of the serving cell (i.e., PCell) from idle/inactive measurements.
measResultsPerCellListIdleNR
List of idle/inactive measured results for the maximum number of reported best cells for a
given NR carrier.
resultsSSB-Indexes
Beam level measurement results (indexes and optionally, beam measurements).

ReportConfigNR information element

-- ASN1START
-- TAG-REPORTCONFIGNR-START

| | |
|---|---|
| ReportConfigNR :: = | SEQUENCE { |

| | |
|---|---|
| reportType | CHOICE { |

| | |
|---|---|
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI- |

PeriodicalReportConfig-r16,

| | |
|---|---|
| cli-EventTriggered-r16 | CLI-EventTriggerConfig- |

r16,

| | |
|---|---|
| rxTxPeriodical-r17 | RxTxPeriodical-r17 |

}
}

| | |
|---|---|
| ReportCGI ::= | SEQUENCE { |

| | |
|---|---|
| cellForWhichToReportCGI | PhysCellId, |

```
    ...,
  [[
```

| | |
|---|---|
| useAutonomousGaps-r16 | ENUMERATED {setup} |

OPTIONAL -- Need R
]]
}

| | |
|---|---|
| ReportSFTD-NR ::= | SEQUENCE { |

| | |
|---|---|
| reportSFTD-Meas | BOOLEAN, |
| reportRSRP | BOOLEAN, |

```
  ...,
  [[
```

| | |
|---|---|
| reportSFTD-NeighMeas | ENUMERATED {true} |

OPTIONAL, -- Need R

| | |
|---|---|
| drx-SFTD-NeighMeas | ENUMERATED {true} |

OPTIONAL, -- Need R

| | |
|---|---|
| cellsForWhichToReportSFTD | SEQUENCE (SIZE (1..maxCellSFTD)) OF |

PhysCellId OPTIONAL -- Need R
]]
}

| | |
|---|---|
| CondTriggerConfig-r16 ::= | SEQUENCE { |

| | |
|---|---|
| condEventId | CHOICE { |

| | |
|---|---|
| condEventA3 | SEQUENCE { |

| | |
|---|---|
| a3-Offset | MeasTriggerQuantityOffset, |
| hysteresis | Hysteresis, |
| timeToTrigger | TimeToTrigger |

},

| | |
|---|---|
| condEventA5 | SEQUENCE { |

| | |
|---|---|
| a5-Threshold1 | MeasTriggerQuantity, |
| a5-Threshold2 | MeasTriggerQuantity, |
| hysteresis | Hysteresis, |
| timeToTrigger | TimeToTrigger |

```
    },
    ...,
```

| | |
|---|---|
| condEventA4-r17 | SEQUENCE { |

| | |
|---|---|
| a4-Threshold-r17 | MeasTriggerQuantity, |
| hysteresis-r17 | Hysteresis, |
| timeToTrigger-r17 | TimeToTrigger |

},

| | |
|---|---|
| condEventD1-r17 | SEQUENCE { |

| | |
|---|---|
| distanceThreshFromReference1-r17 | INTEGER(0.. 65525), |
| distanceThreshFromReference2-r17 | INTEGER(0.. 65525), |
| referenceLocation1-r17 | ReferenceLocation-r17, |
| referenceLocation2-r17 | ReferenceLocation-r17, |
| hysteresisLocation-r17 | HysteresisLocation-r17, |
| timeToTrigger-r17 | TimeToTrigger |

},

| | |
|---|---|
| condEventT1-r17 | SEQUENCE { |

| | |
|---|---|
| t1-Threshold-r17 | INTEGER (0..549755813887), |
| duration-r17 | INTEGER (1..6000) |

```
    }
  },
```

| | |
|---|---|
| rsType-r16 | NR-RS-Type, |

...
}

| | |
|---|---|
| EventTriggerConfig::= | SEQUENCE { |

| | |
|---|---|
| eventId | CHOICE { |

| | |
|---|---|
| eventA1 | SEQUENCE { |

a1-Threshold
MeasTriggerQuantity,

| | |
|---|---|
| reportOnLeave | BOOLEAN, |
| hysteresis | Hysteresis, |
| timeToTrigger | TimeToTrigger |

},

| | |
|---|---|
| eventA2 | SEQUENCE { |

a2-Threshold
MeasTriggerQuantity,

| | |
|---|---|
| reportOnLeave | BOOLEAN, |
| hysteresis | Hysteresis, |
| timeToTrigger | TimeToTrigger |

},

| | |
|---|---|
| eventA3 | SEQUENCE { |

a3-Offset
MeasTriggerQuantityOffset,

| | |
|---|---|
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |

a4-Threshold
MeasTriggerQuantity,

| | |
|---|---|
| reportOnLeave | BOOLEAN, |
| hysteresis | Hysteresis, |
| timeToTrigger | TimeToTrigger, |
| useAllowedCellList | BOOLEAN |

```
    },
    eventA5
      a5-Threshold1
MeasTriggerQuantity,
      a5-Threshold2
MeasTriggerQuantity,
```

| | |
|---|---|
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |

a6-Offset
MeasTriggerQuantityOffset,

| | |
|---|---|
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |

| | |
|---|---|
| x1-Threshold1-Relay-r17 | SL- |

MeasTriggerQuantity-r16,
x1-Threshold2-r17
MeasTriggerQuantity,

| | |
|---|---|
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |

| | |
|---|---|
| x2-Threshold-Relay-r17 | SL- |

MeasTriggerQuantity-r16,

| | |
|---|---|
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |

| | |
|---|---|
| distanceThreshFromReference1-r17 | INTEGER(1.. 65525), |
| distanceThreshFromReference2-r17 | INTEGER(1.. 65525), |
| referenceLocation1-r17 | ReferenceLocation- |

r17,

| | |
|---|---|
| referenceLocation2-r17 | ReferenceLocation- |

r17,

| | |
|---|---|
| reportOnLeave-r17 | BOOLEAN, |
| hysteresisLocation-r17 | HysteresisLocation- |

r17,

| | |
|---|---|
| timeToTrigger-r17 | TimeToTrigger |

```
    }
    ]]
  },
```

| | |
|---|---|
| rsType | NR-RS-Type, |
| reportInterval | ReportInterval, |
| reportAmount | ENUMERATED {r1, r2, r4, r8, |

r16, r32, r64, infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER |

| | |
|---|---|
| (1..maxNrofIndexesToReport) | OPTIONAL, -- Need |

R

| | |
|---|---|
| includeBeamMeasurements | BOOLEAN, |
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 | BOOLEAN |

OPTIONAL, -- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList- |

| | |
|---|---|
| r16} | OPTIONAL, -- Need M |

| | |
|---|---|
| includeWLAN-Meas-r16 | SetupRelease {WLAN- |

| | |
|---|---|
| NameList-r16} | OPTIONAL, -- Need M |

| | |
|---|---|
| includeSensor-Meas-r16 | SetupRelease {Sensor- |

| | |
|---|---|
| NameList-r16} | OPTIONAL -- Need M |

```
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]
}

| | |
|---|---|
| PeriodicalReportConfig ::= | SEQUENCE { |

| | |
|---|---|
| rsType | NR-RS-Type, |
| reportInterval | ReportInterval, |
| reportAmount | ENUMERATED {r1, r2, r4, r8, |

r16, r32, r64, infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL, -- Need R

| | |
|---|---|
| maxNrofRS-IndexesToReport | INTEGER |

| | |
|---|---|
| (1..maxNrofIndexesToReport) | OPTIONAL, -- Need |

R

| | |
|---|---|
| includeBeamMeasurements | BOOLEAN, |
| useAllowedCellList | BOOLEAN, |

```
  ...,
  [[
```

| | |
|---|---|
| measRSSI-ReportConfig-r16 | MeasRSSI-ReportConfig-r16 |

OPTIONAL, -- Need R

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList- |

| | |
|---|---|
| r16} | OPTIONAL, -- Need M |

| | |
|---|---|
| includeWLAN-Meas-r16 | SetupRelease {WLAN- |

| | |
|---|---|
| NameList-r16} | OPTIONAL, -- Need M |

| | |
|---|---|
| includeSensor-Meas-r16 | SetupRelease {Sensor- |

| | |
|---|---|
| NameList-r16} | OPTIONAL, -- Need M |

| | |
|---|---|
| ul-DelayValueConfig-r16 | SetupRelease { UL- |

| | |
|---|---|
| DelayValueConfig-r16 } | OPTIONAL, -- Need M |

| | |
|---|---|
| reportAddNeighMeas-r16 | ENUMERATED {setup} |

```
OPTIONAL -- Need R
  ]],
  [[
```

| | |
|---|---|
| ul-ExcessDelayConfig-r17 | SetupRelease { UL- |

| | |
|---|---|
| ExcessDelayConfig-r17 } | OPTIONAL, -- Need M |

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]
}

| | |
|---|---|
| NR-RS-Type ::= | ENUMERATED {ssb, csi-rs} |
| MeasTriggerQuantity ::= | CHOICE { |

| | |
|---|---|
| rsrp | RSRP-Range, |
| rsrq | RSRQ-Range, |
| sinr | SINR-Range |

}

| | |
|---|---|
| MeasTriggerQuantityOffset ::= | CHOICE { |

| | |
|---|---|
| rsrp | INTEGER (−30..30), |
| rsrq | INTEGER (−30..30), |
| sinr | INTEGER (−30..30) |

}

| | |
|---|---|
| MeasReportQuantity ::= | SEQUENCE { |

| | |
|---|---|
| rsrp | BOOLEAN, |
| rsrq | BOOLEAN, |
| sinr | BOOLEAN |

}

| | |
|---|---|
| MeasRSSI-ReportConfig-r16 ::= | SEQUENCE { |

| | |
|---|---|
| channelOccupancyThreshold-r16 | RSSI-Range-r16 |

OPTIONAL -- Need R
}

| | |
|---|---|
| CLI-EventTriggerConfig-r16 ::= | SEQUENCE { |

| | |
|---|---|
| eventID-r16 | CHOICE { |

| | |
|---|---|
| eventI1-r16 | SEQUENCE { |

i1-Threshold-r16
MeasTriggerQuantityCLI-r16,

| | |
|---|---|
| reportOnLeave-r16 | BOOLEAN, |
| hysteresis-r16 | Hysteresis, |
| timeToTrigger-r16 | TimeToTrigger |

```
    },
  ...
  },
```

| | |
|---|---|
| reportInterval-r16 | ReportInterval, |
| reportAmount-r16 | ENUMERATED {r1, r2, r4, r8, |

r16, r32, r64, infinity},

| | |
|---|---|
| maxReportCLI-r16 | INTEGER (1..maxCLI-Report- |

r16),
...
}

| CLI-PeriodicalReportConfig-r16 ::= | SEQUENCE { | |
|---|---|---|
| reportInterval-r16 | | ReportInterval, |
| reportAmount-r16 | | ENUMERATED {r1, r2, r4, r8, |
| r16, r32, r64, infinity}, | | |
| reportQuantityCLI-r16 | | MeasReportQuantityCLI-r16, |
| maxReportCLI-r16 | | INTEGER (1..maxCLI-Report- |
| r16), | | |
| ... | | |
| } | | |

| | |
|---|---|
| RsTxPeriodical-r17 ::= | SEQUENCE { |

| | |
|---|---|
| rxTxReportInterval-r17 | RxTxReportInterval-r17 |

OPTIONAL, -- Need R

| | |
|---|---|
| reportAmount-r17 | ENUMERATED {r1, infinity, |

spare6, spare5, spare4, spare3, spare2, spare1},
...
}
RxTxReportInterval-r17 ::= ENUMERATED
{ms80,ms120,ms160ms240,ms320,ms480,ms640,ms1024,ms1280,ms2048,ms2560,ms512
0,spare4,spare3,spare2,spare1}

| | |
|---|---|
| MeasTriggerQuantityCLI-r16 ::= | CHOICE { |

| | |
|---|---|
| srs-RSRP-r16 | SRS-RSRP-Range-r16, |
| cli-RSSI-r16 | CLI-RSSI-Range-r16 |

}

| | |
|---|---|
| MeasReportQuantityCLI-r16 ::= | ENUMERATED {srs-rsrp, cli-rssi} |

-- TAG-REPORTCONFIGNR-STOP
-- ASN1STOP

CondTriggerConfig field descriptions

a3-Offset
Offset value(s) to be used in NR conditional reconfiguration triggering condition for cond
event a3. The actual value is field value * 0.5 dB.
a4-Threshold
Threshold value associated to the selected trigger quantity (e.g. RSRP, RSRQ, SINR) per
RS Type (e.g. SS/PBCH block, CSI-RS) to be used in NR conditional reconfiguration
triggering condition for cond event a4.
a5-Threshold1/a5-Threshold2
Threshold value associated to the selected trigger quantity (e.g. RSRP, RSRQ, SINR) per
RS Type (e.g. SS/PBCH block, CSI-RS) to be used in NR conditional reconfiguration
triggering condition for cond event a5. In the same condeventA5, the network configures
the same quantity for the MeasTriggerQuantity of the a5-Threshold1 and for the
MeasTriggerQuantity of the a5-Threshold2.
condEventId
Choice of NR conditional reconfiguration event triggered criteria.
distanceThreshFromReference1, distanceThreshFromReference2
Distance from a reference location configured with referenceLocation1 or
referenceLocation2. Each step represents 50 m.
duration
This field is used for defining the leaving condition T1-2 for conditional HO event
condEventT1. Each step represents 100 ms.
referenceLocation1, referenceLocation2
Reference locations used for condEventD1. The referenceLocation1 is associated to
serving cell and referenceLocation2 is associated to candidate target cell.
t1-Threshold
The field counts the number of UTC seconds in 10 ms units since 00:00:00 on Gregorian
calendar date 1 Jan. 1900 (midnight between Sunday, Dec. 31, 1899 and
Monday, Jan. 1, 1900).
timeToTrigger
Time during which specific criteria for the event needs to be met in order to execute the
conditional reconfiguration evaluation.

ReportConfigNR field descriptions

reportType
Type of the configured measurement report. In MR-DC, network does not configure report
of type reportCGI using SRB3. The condTriggerConfig is used for CHO, CPA or CPC
configuration.

ReportCGI field descriptions

useAutonomousGaps
Indicates whether or not the UE is allowed to use autonomous gaps in acquiring system
information from the NR neighbour cell. When the field is included, the UE applies the
corresponding value for T321.

ReportConfigToAddModList information element

| | |
|---|---|
| -- ASN1START | |
| -- TAG-REPORTCONFIGTOADDMODLIST-START | |
| ReportConfigToAddModList ::= | SEQUENCE (SIZE (1..maxReportConfigId)) |
| OF ReportConfigToAddMod | |
| ReportConfigToAddMod ::= | SEQUENCE { |
| reportConfigId | ReportConfigId, |
| reportConfig | CHOICE { |
| reportConfigNR | ReportConfigNR, |
| ..., | |
| reportConfigInterRAT | ReportConfigInterRAT, |
| reportConfigNR-SL-r16 | ReportConfigNR-SL-r16 |
| } | |
| } | |
| -- TAG-REPORTCONFIGTOADDMODLIST-STOP | |
| -- ASN1STOP | |

ServingCellConfig information element

-- ASN1START
-- TAG-SERVINGCELLCONFIG-START

| | |
|---|---|
| ServingCellConfig ::= | SEQUENCE { |

| | |
|---|---|
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF |

| | |
|---|---|
| BWP-Id | OPTIONAL, -- Need N |

| | |
|---|---|
| downlinkBWP-ToAddModList | SEQUENCE (SIZE (1..maxNrofBWPs)) OF |

| | |
|---|---|
| BWP-Downlink | OPTIONAL, -- Need N |

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, ms5, |

ms6, ms8, ms10, ms20, ms30,

ms40,ms50, ms60,

ms80,ms100, ms200, ms300, ms500,

ms750, ms1280, ms1920,

ms2560, spare10, spare9, spare8,

spare7, spare6, spare5,

| | |
|---|---|
| spare4, spare3, spare2, spare1 } | OPTIONAL, -- Need R |

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease { PDCCH- |

| | |
|---|---|
| ServingCellConfig } | OPTIONAL, -- Need M |

| | |
|---|---|
| pdsch-ServingCellConfig | SetupRelease { PDSCH- |

| | |
|---|---|
| ServingCellConfig } | OPTIONAL, -- Need M |

| | |
|---|---|
| csi-MeasConfig | SetupRelease { CSI-MeasConfig } |

OPTIONAL, -- Need M

| | |
|---|---|
| sCellDeactivationTimer | ENUMERATED {ms20, ms40, ms80, |

ms160, ms200, ms240,

ms320, ms400, ms480,

ms520, ms640, ms720,

ms840, ms1280,

spare2, spare1} OPTIONAL, -- Cond ServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |
| dummy1 | ENUMERATED {enabled} |

OPTIONAL, -- Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

```
OPTIONAL, -- Cond MeasObject
  ...,
  [[
```

| | |
|---|---|
| lte-CRS-ToMatchAround | SetupRelease { RateMatchPatternLTE- |

| | |
|---|---|
| CRS } | OPTIONAL, -- Need M |

| | |
|---|---|
| rateMatchPatternToAddModList | SEQUENCE (SIZE |

(1..maxNrofRateMatchPatterns)) OF RateMatchPattern OPTIONAL, --
Need N

| | |
|---|---|
| rateMatchPatternToReleaseList | SEQUENCE (SIZE |

(1..maxNrofRateMatchPatterns)) OF RateMatchPatternId OPTIONAL, --
Need N

| | |
|---|---|
| downlinkChannelBW-PerSCS-List | SEQUENCE (SIZE (1..maxSCSs)) OF |
| SCS-SpecificCarrier | OPTIONAL -- Need S |

```
  ]],
  [[
```

| | |
|---|---|
| supplementaryUplinkRelease-r16 | ENUMERATED {true} |

OPTIONAL, -- Need N

| | |
|---|---|
| tdd-UL-DL-ConfigurationDedicated-IAB-MT-r16 | TDD-UL-DL- |
| ConfigDedicated-IAB-MT-r16 | OPTIONAL, -- Cond |

TDD_IAB

| | |
|---|---|
| dormantBWP-Config-r16 | SetupRelease { DormantBWP-Config- |

| | |
|---|---|
| r16 } | OPTIONAL, -- Need M |

| | |
|---|---|
| ca-SlotOffset-r16 | CHOICE { |

| | |
|---|---|
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

}
OPTIONAL, -- Cond AsyncCA

| | |
|---|---|
| dummy2 | SetupRelease { DummyJ } |

OPTIONAL, -- Need M

| | |
|---|---|
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWithDCI-r16 | ENUMERATED {enabled} |

OPTIONAL, -- Need R

| | |
|---|---|
| lte-CRS-PatternList1-r16 | SetupRelease { LTE-CRS-PatternList- |

| | |
|---|---|
| r16 } | OPTIONAL, -- Need M |

| | |
|---|---|
| lte-CRS-PatternList2-r16 | SetupRelease { LTE-CRS-PatternList- |

| | |
|---|---|
| r16 } | OPTIONAL, -- Need M |

| | |
|---|---|
| crs-RateMatch-PerCORESETPoolIndex-r16 | ENUMERATED {enabled} |

OPTIONAL, -- Need R

| | |
|---|---|
| enableTwoDefaultTCI-States-r16 | ENUMERATED {enabled} |

OPTIONAL, -- Need R
enableDefaultTCI-StatePerCoresetPoolIndex-r16 ENUMERATED {enabled}
OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

```
OPTIONAL -- Need R
  ]],
  [[
```

| | |
|---|---|
| directionalCollisionHandling-r16 | ENUMERATED {enabled} |

OPTIONAL, -- Need R

| | |
|---|---|
| channelAccessConfig-r16 | SetupRelease { ChannelAccessConfig- |

| | |
|---|---|
| r16 } | OPTIONAL -- Need M |

```
  ]],
  [[
```

| | |
|---|---|
| nr-dl-PRS-PDC-Info-r17 | SetupRelease {NR-DL-PRS-PDC- |
| Info-r17} | OPTIONAL, -- Need M |

| | |
|---|---|
| semiStaticChannelAccessConfigUE-r17 | SetupRelease |

| | |
|---|---|
| {SemiStaticChannelAccessConfigUE-r17} | OPTIONAL, -- Need |

M

| | |
|---|---|
| mimoParam-r17 | SetupRelease {MIMOParam-r17} |

OPTIONAL, -- Need M

| | |
|---|---|
| channelAccessMode2-r17 | ENUMERATED {enabled} |

OPTIONAL, -- Need R

| | |
|---|---|
| timeDomainHARQ-BundlingType1-r17 | ENUMERATED {enabled} |

OPTIONAL, -- Need R

| | |
|---|---|
| nrofHARQ-BundlingGroups-r17 | ENUMERATED {n1, n2, n4} |

OPTIONAL, -- Need R

| | |
|---|---|
| fdmed-ReceptionMulticast-r17 | ENUMERATED {true} |

OPTIONAL, -- Need R

| | |
|---|---|
| moreThanOneNackOnlyMode-r17 | ENUMERATED {mode2} |

OPTIONAL, - - Need S

| | |
|---|---|
| tci-ActivatedConfig-r17 | TCI-ActivatedConfig-r17 |

OPTIONAL, -- Cond TCI ActivatedConfig

| | |
|---|---|
| directionalCollisionHandling-DC-r17 | ENUMERATED {enabled} |

OPTIONAL, -- Need R
lte-NeighCellsCRS-AssistInfoList-r17 SetupRelease { LTE-NeighCellsCRS-

| | |
|---|---|
| AssistInfoList-r17 } | OPTIONAL -- Need M |

```
  ]],
  [[
```

| | |
|---|---|
| lte-NeighCellsCRS-Assumptions-r17 | ENUMERATED {false} |

OPTIONAL -- Need R
]]
}

| | |
|---|---|
| UplinkConfig ::= | SEQUENCE { |

| | |
|---|---|
| initialUplinkBWP | BWP-UplinkDedicated |

OPTIONAL, -- Need M

| | |
|---|---|
| uplinkBWP-ToReleaseList | SEQUENCE (SIZE (1..maxNrofBWPs)) OF |

| | |
|---|---|
| BWP-Id | OPTIONAL, -- Need N |

| | |
|---|---|
| uplinkBWP-ToAddModList | SEQUENCE (SIZE (1..maxNrofBWPs)) OF |

| | |
|---|---|
| BWP-Uplink | OPTIONAL, -- Need N |

| | |
|---|---|
| firstActiveUplinkBWP-Id | BWP-Id |

OPTIONAL, -- Cond SyncAndCellAdd

| | |
|---|---|
| pusch-ServingCellConfig | SetupRelease { PUSCH- |

| | |
|---|---|
| ServingCellConfig } | OPTIONAL, -- Need M |

| | |
|---|---|
| carrierSwitching | SetupRelease { SRS- |

| | |
|---|---|
| CarrierSwitching } | OPTIONAL, -- Need M |

```
  ...,
  [[
```

| | |
|---|---|
| powerBoostPi2BPSK | BOOLEAN |

OPTIONAL, -- Need M

| | |
|---|---|
| uplinkChannelBW-PerSCS-List | SEQUENCE (SIZE (1..maxSCSs)) OF |
| SCS-SpecificCarrier | OPTIONAL -- Need S |

```
  ]],
  [[
```

| | |
|---|---|
| enablePL-RS-UpdateForPUSCH-SRS-r16 | ENUMERATED {enabled} |

OPTIONAL, -- Need R

| | |
|---|---|
| enableDefaultBeamPL-ForPUSCH0-0-r16 | ENUMERATED {enabled} |

OPTIONAL, -- Need R

| | |
|---|---|
| enableDefaultBeamPL-ForPUCCH-r16 | ENUMERATED {enabled} |

OPTIONAL, -- Need R

| | |
|---|---|
| enableDefaultBeamPL-ForSRS-r16 | ENUMERATED {enabled} |

OPTIONAL, -- Need R

| | |
|---|---|
| uplinkTxSwitching-r16 | SetupRelease { UplinkTxSwitching- |

| | |
|---|---|
| r16 } | OPTIONAL, -- Need M |

| | |
|---|---|
| mpr-PowerBoost-FR2-r16 | ENUMERATED {true} |

OPTIONAL -- Need R
]]
}

| | |
|---|---|
| DummyJ ::= | SEQUENCE { |

| | |
|---|---|
| maxEnergyDetectionThreshold-r16 | INTEGER(−85..−52), |
| energyDetectionThresholdOffset-r16 | INTEGER (−20..−13), |
| ul-toDL-COT-SharingED-Threshold-r16 | INTEGER (−85..−52) |

OPTIONAL, -- Need R

| | |
|---|---|
| absenceOfAnyOtherTechnology-r16 | ENUMERATED {true} |

OPTIONAL -- Need R
}

| | |
|---|---|
| ChannelAccessConfig-r16 ::= | SEQUENCE { |

| | |
|---|---|
| energyDetectionConfig-r16 | CHOICE { |

| | |
|---|---|
| maxEnergyDetectionThreshold-r16 | INTEGER (−85..−52), |
| energyDetectionThresholdOffset-r16 | INTEGER (−13..20) |

}
OPTIONAL, -- Need R

| | |
|---|---|
| ul-toDL-COT-SharingED-Threshold-r16 | INTEGER (−85..−52) |

OPTIONAL, -- Need R

| | |
|---|---|
| absenceOfAnyOtherTechnology-r16 | ENUMERATED {true} |

OPTIONAL -- Need R
}

| | |
|---|---|
| IntraCellGuardBandsPerSCS-r16 ::= | SEQUENCE { |

| | |
|---|---|
| guardBandSCS-r16 | SubcarrierSpacing, |
| intraCellGuardBands-r16 | SEQUENCE (SIZE (1..4)) OF |

GuardBand-r16
}

| | |
|---|---|
| GuardBand-r16 ::= | SEQUENCE { |

| | |
|---|---|
| startCRB-r16 | INTEGER (0..274), |
| nrofCRBs-r16 | INTEGER (0..15) |

}

| | |
|---|---|
| DormancyGroupID-r16 ::= | INTEGER (0..4) |

| | |
|---|---|
| DormantBWP-Config-r16 ::= | SEQUENCE { |

| | |
|---|---|
| dormantBWP-Id-r16 | BWP-Id |

OPTIONAL, -- Need M

| | |
|---|---|
| withinActiveTimeConfig-r16 | SetupRelease |

| | |
|---|---|
| { WithinActiveTimeConfig-r16 } | OPTIONAL, -- Need M |

| | |
|---|---|
| outsideActiveTimeConfig-r16 | SetupRelease |

| | |
|---|---|
| { OutsideActiveTimeConfig-r16 } | OPTIONAL -- Need M |

}

| | |
|---|---|
| WithinActiveTimeConfig-r16 ::= | SEQUENCE { |

| | |
|---|---|
| firstWithinActiveTimeBWP-Id-r16 | BWP-Id |

OPTIONAL, -- Need M

| | |
|---|---|
| dormancyGroupWithinActiveTime-r16 | DormancyGroupID-r16 |

OPTIONAL -- Need R
}

| | |
|---|---|
| OutsideActiveTimeConfig-r16 ::= | SEQUENCE { |

| | |
|---|---|
| firstOutsideActiveTimeBWP-Id-r16 | BWP-Id |

OPTIONAL, -- Need M

| | |
|---|---|
| dormancyGroupOutsideActiveTime-r16 | DormancyGroupID-r16 |

OPTIONAL -- Need R
}

| | |
|---|---|
| UplinkTxSwitching-r16 ::= | SEQUENCE { |

| | |
|---|---|
| uplinkTxSwitchingPeriodLocation-r16 | BOOLEAN, |
| uplinkTxSwitchingCarrier-r16 | ENUMERATED {carrier1, carrier2} |

}
MIMOParam-r17 ::= SEQUENCE {

| | |
|---|---|
| additionalPCI-ToAddModList-r17 | SEQUENCE |

(SIZE (1..maxNrofAdditionalPCI-r17)) OF SSB-MTC-AdditionalPCI-r17 OPTIONAL,
-- Need N

| | |
|---|---|
| additionalPCI-ToReleaseList-r17 | SEQUENCE |

(SIZE (1..maxNrofAdditionalPCI-r17)) OF AdditionalPCIIndex-r17 OPTIONAL,
-- Need N

| | |
|---|---|
| unifiedTCI-StateType-r17 | ENUMERATED {separate, joint} |

OPTIONAL, -- Need R

| | |
|---|---|
| uplink-PowerControlToAddModList-r17 | SEQUENCE (SIZE (1..maxUL-TCI-r17)) |

OF Uplink-powerControl-r17 OPTIONAL, -- Need N

| | |
|---|---|
| uplink-PowerControlToReleaseList-r17 | SEQUENCE (SIZE (1..maxUL-TCI-r17)) |

OF Uplink-powerControlId-r17 OPTIONAL, -- Need N

| | |
|---|---|
| sfnSchemePDCCH-r17 | ENUMERATED {sfnSchemeA, sfnSchemeB} |

OPTIONAL, -- Need R

| | |
|---|---|
| sfnSchemePDSCH-r17 | ENUMERATED {sfnSchemeA, sfnSchemeB} |

OPTIONAL -- Need R
}
-- TAG-SERVINGCELLCONFIG-STOP
-- ASN1STOP

CSI-MeasConfig information element

-- ASN1START
-- TAG-CSI-MEASCONFIG-START

| | |
|---|---|
| CSI-MeasConfig ::= | SEQUENCE { |

| | |
|---|---|
| nzp-CSI-RS-ResourceToAddModList | SEQUENCE (SIZE (1..maxNrofNZP-CSI- |
| RS-Resources)) OF NZP-CSI-RS-Resource | OPTIONAL, -- Need N |
| nzp-CSI-RS-ResourceToReleaseList | SEQUENCE (SIZE (1..maxNrofNZP-CSI- |
| RS-Resources)) OF NZP-CSI-RS-ResourceId | OPTIONAL, -- Need N |
| nzp-CSI-RS-ResourceSetToAddModList | SEQUENCE (SIZE (1..maxNrofNZP-CSI- |

RS-ResourceSets)) OF NZP-CSI-RS-ResourceSet
OPTIONAL, -- Need N

| | |
|---|---|
| nzp-CSI-RS-ResourceSetToReleaseList | SEQUENCE (SIZE (1..maxNrofNZP-CSI- |

RS-ResourceSets)) OF NZP-CSI-RS-ResourceSetId
OPTIONAL, -- Need N

| | |
|---|---|
| csi-IM-ResourceToAddModList | SEQUENCE (SIZE (1..maxNrofCSI-IM- |
| Resources)) OF CSI-IM-Resource | OPTIONAL, -- Need N |
| csi-IM-ResourceToReleaseList | SEQUENCE (SIZE (1..maxNrofCSI-IM- |
| Resources)) OF CSI-IM-ResourceId | OPTIONAL, -- Need N |
| csi-IM-ResourceSetToAddModList | SEQUENCE (SIZE (1..maxNrofCSI-IM- |
| ResourceSets)) OF CSI-IM-ResourceSet | OPTIONAL, -- Need N |
| csi-IM-ResourceSetToReleaseList | SEQUENCE (SIZE (1..maxNrofCSI-IM- |
| ResourceSets)) OF CSI-IM-ResourceSetId | OPTIONAL, -- Need N |
| csi-SSB-ResourceSetToAddModList | SEQUENCE (SIZE (1..maxNrofCSI-SSB- |
| ResourceSets)) OF CSI-SSB-ResourceSet | OPTIONAL, -- Need N |
| csi-SSB-ResourceSetToReleaseList | SEQUENCE (SIZE (1.. maxNrofCSI-SSB- |
| ResourceSets)) OF CSI-SSB-ResourceSetId | OPTIONAL, -- Need N |
| csi-ResourceConfigToAddModList | SEQUENCE (SIZE (1..maxNrofCSI- |

ResourceConfigurations)) OF CSI-ResourceConfig
OPTIONAL, -- Need N

| | |
|---|---|
| csi-ResourceConfigToReleaseList | SEQUENCE (SIZE (1..maxNrofCSI- |

ResourceConfigurations)) OF CSI-ResourceConfigId
OPTIONAL, -- Need N

| | |
|---|---|
| csi-ReportConfigToAddModList | SEQUENCE (SIZE (1..maxNrofCSI- |

ReportConfigurations)) OF CSI-ReportConfig OPTIONAL, -- Need N

| | |
|---|---|
| csi-ReportConfigToReleaseList | SEQUENCE (SIZE (1..maxNrofCSI- |

ReportConfigurations)) OF CSI-ReportConfigId
OPTIONAL, -- Need N

| | |
|---|---|
| reportTriggerSize | INTEGER (0..6) |

OPTIONAL, -- Need M

| | |
|---|---|
| aperiodicTriggerStateList | SetupRelease { CSI- |

| | |
|---|---|
| AperiodicTriggerStateList } | OPTIONAL, -- Need M |

| | |
|---|---|
| semiPersistentOnPUSCH-TriggerStateList | SetupRelease { CSI- |

| | |
|---|---|
| SemiPersistentOnPUSCH-TriggerStateList } | OPTIONAL, -- Need M |

```
  ...,
  [[
```

| | |
|---|---|
| reportTriggerSizeDCI-0-2-r16 | INTEGER (0..6) |

```
OPTIONAL -- Need R
  ]],
  [[
```

| | |
|---|---|
| sCellActivationRS-ConfigToAddModList-r17 | SEQUENCE (SIZE |

| | |
|---|---|
| (1..maxNrofSCellActRS-r17)) OF SCellActivationRS-Config-r17 | OPTIONAL, -- |

Need N

| | |
|---|---|
| sCellActivationRS-ConfigToReleaseList-r17 | SEQUENCE (SIZE |

| | |
|---|---|
| (1..maxNrofSCellActRS-r17)) OF SCellActivationRS-ConfigId-r17 | OPTIONAL -- |

Need N
]]
}
-- TAG-CSI-MEASCONFIG-STOP
-- ASN1STOP

CSI-MeasConfig field descriptions

aperiodicTriggerStateList
Contains trigger states for dynamically selecting one or more aperiodic and semi-
persistent reporting configurations and/or triggering one or more aperiodic CSI-RS
resource sets for channel and/or interference measurement (see TS 38.214, clause 5.2.1).
csi-IM-ResourceSetToAddModList
Pool of CSI-IM-ResourceSet which can be referred to from CSI-ResourceConfig or from
MAC CEs.
csi-IM-ResourceToAddModList
Pool of CSI-IM-Resource which can be referred to from CSI-IM-ResourceSet.
csi-ReportConfigToAddModList
Configured CSI report settings as specified in TS 38.214 clause 5.2.1.1.
csi-ResourceConfigToAddModList
Configured CSI resource settings as specified in TS 38.214 clause 5.2.1.2.
csi-SSB-ResourceSetToAddModList
Pool of CSI-SSB-ResourceSet which can be referred to from CSI-ResourceConfig.
nzp-CSI-RS-ResourceSetToAddModList
Pool of NZP-CSI-RS-ResourceSet which can be referred to from CSI-ResourceConfig or
from MAC CEs.
nzp-CSI-RS-ResourceToAddModList
Pool of NZP-CSI-RS-Resource which can be referred to from NZP-CSI-RS-ResourceSet.
reportTriggerSize, reportTriggerSizeDCI-0-2
Size of CSI request field in DCI (bits) (see TS 38.214 [19], clause 5.2.1.5.1). The field
reportTriggerSize applies to DCI format 0_1 and the field reportTriggerSizeDCI-0-2
applies to DCI format 0_2 (see TS 38.214, clause 5.2.1.5.1).
scellActivationRS-ConfigToAddModList
Configured RS for fast SCell activation as specified in TS 38.214.

CSI-ReportConfig information element

-- ASN1START
-- TAG-CSI-REPORTCONFIG-START

| CSI-ReportConfig ::= | SEQUENCE { | | | |
|---|---|---|---|---|
| reportConfigId | | CSI-ReportConfigId, | | |
| carrier | | ServCellIndex | | |
| OPTIONAL, -- Need | | | | |
| resourcesForChannelMeasurement | | CSI-ResourceConfigId, | | |
| csi-IM-ResourcesForInterference | | CSI-ResourceConfigId | | |
| OPTIONAL, -- Need R | | | | |
| nzp-CSI-RS-ResourcesForInterference | | CSI-ResourceConfigId | | |
| OPTIONAL, -- Need R | | | | |
| reportConfigType | | CHOICE { | | |
| periodic | | | SEQUENCE { | |
| reportSlotConfig | | | | CSI- |
| ReportPeriodicityAndOffset, | | | | |
| pucch-CSI-ResourceList | | | | SEQUENCE (SIZE |
| (1..maxNrofBWPs)) OF PUCCH-CSI-Resource | | | | |
| }, | | | | |
| semiPersistentOnPUCCH | | | SEQUENCE { | |
| reportSlotConfig | | | | CSI- |
| ReportPeriodicityAndOffset, | | | | |
| pucch-CSI-ResourceList | | | | SEQUENCE (SIZE |
| (1..maxNrofBWPs)) OF PUCCH-CSI-Resource | | | | |
| }, | | | | |
| semiPersistentOnPUSCH | | | SEQUENCE { | |
| reportSlotConfig | | | | ENUMERATED {sl5, sl10, |
| sl20, sl40, sl80, sl160, sl320}, | | | | |
| reportSlotOffsetList | | | SEQUENCE (SIZE (1.. | |
| maxNrofUL-Allocations)) OF INTEGER(0..32), | | | | |
| p0alpha | | | | P0-PUSCH-AlphaSetId |
| }, | | | | |
| aperiodic | | | SEQUENCE { | |
| reportSlotOffsetList | | | SEQUENCE (SIZE | |
| (1..maxNrofUL-Allocations)) OF INTEGER(0..32) | | | | |
| } | | | | |
| }, | | | | |
| reportQuantity | | CHOICE { | | |
| none | | | NULL, | |
| cri-RI-PMI-CQI | | | NULL, | |
| cri-RI-i1 | | | NULL, | |
| cri-RI-i1-CQI | | | SEQUENCE { | |
| pdsch-BundleSizeForCSI | | | | ENUMERATED {n2, n4} |
| OPTIONAL -- Need S | | | | |
| }, | | | | |
| cri-RI-CQI | | | NULL, | |
| cri-RSRP | | | NULL, | |
| ssb-Index-RSRP | | | NULL, | |
| cri-RI-LI-PMI-CQI | | | NULL | |
| }, | | | | |
| reportFreqConfiguration | | SEQUENCE { | | |
| cqi-FormatIndicator | | | ENUMERATED { widebandCQI, | |
| subbandCQI } | OPTIONAL, -- Need R | | | |
| pmi-FormatIndicator | | | ENUMERATED { widebandPMI, | |
| subbandPMI } | OPTIONAL, -- Need R | | | |
| csi-ReportingBand | | | CHOICE { | |
| subbands3 | | | | BIT STRING(SIZE(3)), |
| subbands4 | | | | BIT STRING(SIZE(4)), |
| subbands5 | | | | BIT STRING(SIZE(5)), |
| subbands6 | | | | BIT STRING(SIZE(6)), |
| subbands7 | | | | BIT STRING(SIZE(7)), |
| subbands8 | | | | BIT STRING(SIZE(8)), |
| subbands9 | | | | BIT STRING(SIZE(9)), |
| subbands10 | | | | BIT STRING(SIZE(10)), |
| subbands11 | | | | BIT STRING(SIZE(11)), |
| subbands12 | | | | BIT STRING(SIZE(12)), |
| subbands13 | | | | BIT STRING(SIZE(13)), |
| subbands14 | | | | BIT STRING(SIZE(14)), |
| subbands15 | | | | BIT STRING(SIZE(15)), |
| subbands16 | | | | BIT STRING(SIZE(16)), |
| subbands17 | | | | BIT STRING(SIZE(17)), |
| subbands18 | | | | BIT STRING(SIZE(18)), |
| ..., | | | | |
| subbands19-v1530 | | | | BIT STRING(SIZE(19)) |
| } OPTIONAL -- Need S | | | | |
| } | | | | |
| OPTIONAL, -- Need R | | | | |
| timeRestrictionForChannelMeasurements | | | | ENUMERATED {configured, |
| notConfigured}, | | | | |
| timeRestrictionForInterferenceMeasurements | | | | ENUMERATED {configured, |
| notConfigured}, | | | | |
| codebookConfig | | | | CodebookConfig |
| OPTIONAL, -- Need R | | | | |
| dummy | | | | ENUMERATED {n1, n2} |
| OPTIONAL, -- Need R | | | | |
| groupBasedBeamReporting | | | CHOICE { | |
| enabled | | | | NULL, |
| disabled | | | | SEQUENCE { |
| nrofReportedRS | | | | ENUMERATED {n1, n2, n3, |
| n4} | OPTIONAL -- Need S | | | |
| } | | | | |
| }, | | | | |

| cqi-Table | ENUMERATED {table1, table2, table3, table4- | |
|---|---|---|
| r17} | | OPTIONAL, -- Need R |

| | |
|---|---|
| subbandSize | ENUMERATED {value1, value2}, |
| non-PMI-PortIndication | SEQUENCE (SIZE (1..maxNrofNZP-CSI-RS- |

ResourcesPerConfig)) OF PortIndexFor8Ranks OPTIONAL, -- Need R

| ..., | | | | |
|---|---|---|---|---|
| [[ | | | | |
| semiPersistentOnPUSCH-v1530 | | SEQUENCE { | | |
| reportSlotConfig-v1530 | | | ENUMERATED {sl4, sl8, sl16} | |
| } | | | | |
| OPTIONAL -- Need R | | | | |
| ]], | | | | |
| [[ | | | | |
| semiPersistentOnPUSCH-v1610 | | SEQUENCE { | | |
| reportSlotOffsetListDCI-0-2-r16 | | | SEQUENCE (SIZE (1.. maxNrofUL- | |
| Allocations-r16)) OF INTEGER(0..32) | OPTIONAL, -- Need R | | | |
| reportSlotOffsetListDCI-0-1-r16 | | | SEQUENCE (SIZE (1.. maxNrofUL- | |
| Allocations-r16)) OF INTEGER(0..32) | OPTIONAL -- Need R | | | |
| } | | | | |
| OPTIONAL, -- Need R | | | | |
| aperiodic-v1610 | | SEQUENCE { | | |
| reportSlotOffsetListDCI-0-2-116 | | | SEQUENCE (SIZE (1.. maxNrofUL- | |
| Allocations-r16)) OF INTEGER(0..32) | OPTIONAL, -- Need R | | | |
| reportSlotOffsetListDCI-0-1-r16 | | | SEQUENCE (SIZE (1.. maxNrofUL- | |
| Allocations-r16)) OF INTEGER(0..32) | OPTIONAL -- Need R | | | |
| } | | | | |
| OPTIONAL, -- Need R | | | | |
| reportQuantity-r16 | | CHOICE { | | |
| cri-SINR-r16 | | | NULL, | |
| ssb-Index-SINR-r16 | | | NULL | |
| } | | | | |
| OPTIONAL, -- Need R | | | | |
| codebookConfig-r16 | | | | CodebookConfig-r16 |
| OPTIONAL -- Need R | | | | |
| ]], | | | | |
| [[ | | | | |
| cqi-BitsPerSubband-r17 | | ENUMERATED {bits4} | | |
| OPTIONAL, -- Need R | | | | |
| groupBasedBeamReporting-v1710 | | SEQUENCE { | | |
| nrofReportedGroups-r17 | | | ENUMERATED {n1, n2, n3, n4] | |
| } | | | | |
| OPTIONAL, -- Need R | | | | |
| codebookConfig-r17 | | CodebookConfig-r17 | | |
| OPTIONAL, -- Need R | | | | |
| sharedCMR-r17 | | ENUMERATED {enable} | | |
| OPTIONAL, -- Need R | | | | |
| csi-ReportMode-r17 | | ENUMERATED {mode1, mode2} | | |
| OPTIONAL, -- Need R | | | | |
| numberOfSingleTRP-CSI-Model-r17 | | ENUMERATED {n0, n1, n2} | | |
| OPTIONAL, -- Need R | | | | |
| reportQuantity-r17 | | CHOICE { | | |
| cri-RSRP-Index-r17 | | | NULL, | |
| ssb-Index-RSRP-Index-r17 | | | NULL, | |
| cri-SINR-Index-r17 | | | NULL, | |
| ssb-Index-SINR-Index-r17 | | | NULL | |
| } | | | | |
| OPTIONAL -- Need R | | | | |
| ]], | | | | |
| [[ | | | | |

| semiPersistentOnPUSCH-v1720 | SEQUENCE { | |
|---|---|---|
| reportSlotOffsetList-r17 | | SEQUENCE (SIZE (1.. maxNrofUL- |

Allocations-r16)) OF INTEGER(0..128) OPTIONAL, -- Need R

| | |
|---|---|
| reportSlotOffsetListDCI-0-2-r17 | SEQUENCE (SIZE (1.. maxNrofUL- |

Allocations-r16)) OF INTEGER(0..128) OPTIONAL, -- Need R

| | |
|---|---|
| reportSlotOffsetListDCI-0-1-r17 | SEQUENCE (SIZE (1..maxNrofUL- |

Allocations-r16)) OF INTEGER(0..128) OPTIONAL -- Need R

}
OPTIONAL, -- Need R

| aperiodic-v1720 | SEQUENCE { | |
|---|---|---|
| reportSlotOffsetList-r17 | | SEQUENCE (SIZE (1.. maxNrofUL- |

Allocations-r16)) OF INTEGER(0..128) OPTIONAL, -- Need R

| | |
|---|---|
| reportSlotOffsetListDCI-0-2-r17 | SEQUENCE (SIZE (1.. maxNrofUL- |

Allocations-r16)) OF INTEGER(0..128) OPTIONAL, -- Need R

| | |
|---|---|
| reportSlotOffsetListDCI-0-1-r17 | SEQUENCE (SIZE (1.. maxNrofUL- |

Allocations-r16)) OF INTEGER(0..128) OPTIONAL -- Need R

| } | | | |
|---|---|---|---|
| OPTIONAL -- Need R | | | |
| ]] | | | |
| } | | | |
| CSI-ReportPeriodicityAndOffset ::= | CHOICE { | | |
| slots4 | | INTEGER(0..3), | |
| slots5 | | INTEGER(0..4), | |
| slots8 | | INTEGER(0..7), | |
| slots10 | | INTEGER(0..9), | |
| slots16 | | INTEGER(0..15), | |
| slots20 | | INTEGER(0..19), | |
| slots40 | | INTEGER(0..39), | |
| slots80 | | INTEGER(0..79), | |
| slots160 | | INTEGER(0..159), | |
| slots320 | | INTEGER(0..319) | |
| } | | | |
| PUCCH-CSI-Resource ::= | SEQUENCE { | | |
| uplinkBandwidthPartId | | BWP-Id, | |
| pucch-Resource | | PUCCH-ResourceId | |
| } | | | |
| PortIndexFor8Ranks ::= | CHOICE { | | |
| portIndex8 | | SEQUENCE{ | |
| rank1-8 | | | PortIndex8 |
| OPTIONAL, -- Need R | | | |
| rank2-8 | | | SEQUENCE(SIZE(2)) OF PortIndex8 |
| OPTIONAL, -- Need R | | | |
| rank3-8 | | | SEQUENCE(SIZE(3)) OF PortIndex8 |
| OPTIONAL, -- Need R | | | |
| rank4-8 | | | SEQUENCE(SIZE(4)) OF PortIndex8 |
| OPTIONAL, -- Need R | | | |
| rank5-8 | | | SEQUENCE(SIZE(5)) OF PortIndex8 |
| OPTIONAL, -- Need R | | | |
| rank6-8 | | | SEQUENCE(SIZE(6)) OF PortIndex8 |
| OPTIONAL, -- Need R | | | |
| rank7-8 | | | SEQUENCE(SIZE(7)) OF PortIndex8 |
| OPTIONAL, -- Need R | | | |
| rank8-8 | | | SEQUENCE(SIZE(8)) OF PortIndex8 |
| OPTIONAL -- Need R | | | |
| }, | | | |
| portIndex4 | | SEQUENCE{ | |
| rank1-4 | | | PortIndex4 |
| OPTIONAL, -- Need R | | | |
| rank2-4 | | | SEQUENCE(SIZE(2)) OF PortIndex4 |
| OPTIONAL, -- Need R | | | |
| rank3-4 | | | SEQUENCE(SIZE(3)) OF PortIndex4 |
| OPTIONAL, -- Need R | | | |
| rank4-4 | | | SEQUENCE(SIZE(4)) OF PortIndex4 |
| OPTIONAL -- Need R | | | |
| }, | | | |
| portIndex2 | | SEQUENCE{ | |
| rank1-2 | | | PortIndex2 |
| OPTIONAL, -- Need R | | | |
| rank2-2 | | | SEQUENCE(SIZE(2)) OF PortIndex2 |
| OPTIONAL -- Need R | | | |
| }, | | | |
| portIndex1 | | NULL | |
| } | | | |
| PortIndex8::= | INTEGER (0..7) | | |
| PortIndex4::= | INTEGER (0..3) | | |
| PortIndex2::= | INTEGER (0..1) | | |
| -- TAG-CSI-REPORTCONFIG-STOP | | | |
| -- ASN1STOP | | | |

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a user equipment (UE) for supporting artificial intelligence/machine learning (AI/ML) functionality in a wireless communication system, the method comprising:
establishing a first radio resource control (RRC) connection between the UE and a base station (BS) by using a first signalling radio bearer (SRB);
receiving, from the BS, via the first SRB, a configuration message comprising bearer configuration information;
establishing a second radio resource control (RRC) connection between the UE and the BS, by using a second SRB; and
receiving, from the BS, at least one RRC message including data related to the AI/ML functionality based on the second RRC connection,
wherein the second SRB is configured based on the bearer configuration information.

2. The method of claim 1, wherein the AI/ML functionality is provided by at least one AI/ML model, and the method further comprises:
receiving, from the BS, measurement configuration information for configuring the UE to obtain and report measurement data for the at least one AI/ML model,
wherein the measurement configuration information comprises a reporting configuration defining at least one reporting criterion which triggers the UE to transmit a report to the BS.

3. The method of claim 1, the method further comprising:
receiving, from the BS, prioritization configuration information for defining a lower level of priority for the at least one RRC message including data related to the AI/ML functionality than for other messages between the UE to the BS.

4. The method of claim 3, the method further comprising:
activating access stratum security before establishing the second RRC connection;
receiving, from the BS, security configuration information for applying at least one of integrity protection or ciphering to messages between the UE and the BS; and
applying both integrity protection and ciphering to the at least one RRC message including data related to the AI/ML functionality before transmitting the at least one RRC message.

5. A user equipment (UE) for supporting artificial intelligence/machine learning (AI/ML) functionality in a wireless communication system, the UE comprising:
at least one transceiver;
a controller connected to the at least one transceiver and configured to:
establish a first radio resource control (RRC) connection between the UE and a base station (BS) by using a first signalling radio bearer (SRB);
receive, from the BS, via the first SRB, a configuration message comprising bearer configuration information;
establish a second radio resource control (RRC) connection between the UE and the BS, by using a second SRB; and
receive, from the BS, at least one RRC message including data related to the AI/ML functionality based on the second RRC connection, wherein the second SRB is configured based on the bearer configuration information.

6. The UE of claim 5, wherein the AI/ML functionality is provided by at least one AI/ML model, and the controller is further configured to:
receive, from the BS, measurement configuration information for configuring the UE to obtain and report measurement data for the at least one AI/ML model,
wherein the measurement configuration information comprises a reporting configuration defining at least one reporting criterion which triggers the UE to transmit a report to the BS.

7. The UE of claim 5, wherein the controller is further configured to receive, from the BS, prioritization configuration information for defining a lower level of priority for the at least one RRC message including data related to the AI/ML functionality than for other messages between the UE to the BS.

8. The UE of claim 7, wherein the controller is further configured to:
activate access stratum security before establishing the second RRC connection;
receive, from the BS, security configuration information for applying at least one of integrity protection or ciphering to messages between the UE and the BS; and
apply both integrity protection and ciphering to the at least one RRC message including data related to the AI/ML functionality before transmitting the at least one RRC message.

9. A method performed by a base station (BS) for supporting artificial in-telligence/machine learning (AI/ML) functionality in a wireless communication system, the method comprising:
establishing a first radio resource control (RRC) connection between a user equipment (UE) and the BS by using a first signalling radio bearer (SRB);
transmitting, to the UE, via the first SRB, a configuration message comprising bearer configuration information;
establishing a second radio resource control (RRC) connection between the UE and the BS, by using a second SRB; and
transmitting, to the UE, at least one RRC message including data related to the AI/ML functionality based on the second RRC connection,
wherein the second SRB is configured based on the bearer configuration information.

10. The method of claim 9, wherein the AI/ML functionality is provided by at least one AI/ML model, and the method further comprises:
transmitting, to the UE, measurement configuration information for configuring the UE to obtain and report measurement data for the at least one AI/ML model,
wherein the measurement configuration information comprises a reporting configuration defining at least one reporting criterion which triggers the UE to transmit a report to the BS.

11. The method of claim 9, the method further comprising:
transmit, to the UE, prioritization configuration information for defining a lower level of priority for the at least one RRC message including data related to the AI/ML functionality than for other messages between the UE to the BS.

12. A base station (BS) for supporting artificial intelligence/machine learning (AI/ML) functionality in a wireless communication system, the BS comprising:
at least one transceiver;
a controller connected to the at least one transceiver and configured to:
establish a first radio resource control (RRC) connection between a user equipment (UE) and the BS by using a first signalling radio bearer (SRB);
transmit, to the UE, via the first SRB, a configuration message comprising bearer configuration information;
establish a second radio resource control (RRC) connection between the UE and the BS, by using a second SRB; and
transmit, to the UE, at least one RRC message including data related to the AI/ML functionality based on the second RRC connection,
wherein the second SRB is configured based on the bearer configuration information.

13. The BS of claim 12, wherein the AI/ML functionality is provided by at least one AI/ML model, and the controller is further configured to:
transmit, to the UE, measurement configuration information for configuring the UE to obtain and report measurement data for the at least one AI/ML model,
wherein the measurement configuration information comprises a reporting configuration defining at least one reporting criterion which triggers the UE to transmit a report to the BS.

14. The BS of claim 12, wherein the controller is further configured to transmit, to the UE, prioritization configuration information for defining a lower level of priority for the at least one RRC message including data related to the AI/ML functionality than for other messages between the UE to the BS.

15. The BS of claim 14, wherein the controller is further configured to:
activate access stratum security before establishing the second RRC connection;
transmit, to the US, security configuration information for applying at least one of integrity protection or ciphering to messages between the UE and the BS; and
apply both integrity protection and ciphering to the at least one RRC message including data related to the AI/ML functionality before transmitting the at least one RRC message.
